(19) United States
(12) Patent Application Publication
(10) Pub. No.: US 2022/0042186 A1
(43) Pub. Date: Feb. 10, 2022

(54) NANOCOMPOSITE MATERIALS AND METHODS FOR PRODUCING AND USING NANOCOMPOSITE MATERIALS

(71) Applicants: Xinyu ZHANG, Auburn, AL (US); Andrew ADAMCZYK, Auburn, AL (US); Shatila SARWAR, Auburn, AL (US); Ashraf ALI, Auburn, AL (US)

(72) Inventors: Xinyu ZHANG, Auburn, AL (US); Andrew ADAMCZYK, Auburn, AL (US); Shatila SARWAR, Auburn, AL (US); Ashraf ALI, Auburn, AL (US)

(21) Appl. No.: 17/388,991

(22) Filed: Jul. 29, 2021

Related U.S. Application Data
(60) Provisional application No. 63/058,166, filed on Jul. 29, 2020.
(60) Provisional application No. 63/070,444, filed on Aug. 26, 2020.

(51) Int. Cl. C25B 11/054; C25B 1/04; C25B 11/065; C25B 11/075

(52) U.S. Cl. CPC C25B 11/054; C25B 11/075; C25B 11/065; C25B 1/04

(57) ABSTRACT

Nanocomposite materials include a nanosheet containing a metal chalcogenide having a formula MXₐY_{b}Z_{c} and a carbonaceous substrate supporting the nanosheet. Methods for producing and using the nanocomposite materials are described.

### RELATED APPLICATIONS

This claims the benefit of U.S. Provisional Application No. 63/058,166, filed Jul. 29, 2020, and U.S. Provisional Application No. 63/070,444, filed Aug. 26, 2020. The entire contents of both of these priority documents are incorporated herein by reference, except that in the event of any inconsistent disclosure or definition from the present specification, the disclosure or definition herein shall be deemed to prevail.

### TECHNICAL FIELD

The present teachings relate generally to nanocomposite materials, methods for their production, and methods for their use. In some embodiments, the nanocomposite materials described herein may be used to catalyze a hydrogen evolution reaction (HER).

### BACKGROUND

To mitigate the world energy crisis and reduce environmental pollution, traditional fossil fuels may be replaced by reproducible and clean energy resources. In this regard, hydrogen (H₂) is a promising green energy carrier. The generation of H₂ through water electrolysis is a green approach that may be achieved by a photochemical, photoelectrochemical, or electrochemical method. In the water electrolysis process, a hydrogen evolution reaction (2H⁺+2 e⁻→H₂) requires an electrocatalyst material as the cathode. To date, platinum (Pt)-based materials exhibit the best catalytic activities providing higher current densities at low overpotentials in an acidic medium. However, the high cost and scarcity of these precious noble metal materials severely limit their commercial applications.

### SUMMARY

The scope of the present invention is defined solely by the appended claims, and is not affected to any degree by the statements within this summary.

By way of introduction, a first nanocomposite material in accordance with the present teachings includes (a) a nanosheet containing a metal chalcogenide having a formula MXₐY_{b}Z_{c}; and (b) a carbonaceous substrate supporting the nanosheet. In the formula, M is a transition metal having (a) an oxidation state ranging from +2 to +4, (b) a body-centered cubic (BCC) crystal structure, a face-centered cubic (FCC) crystal structure, or a hexagonal close packed (HCP) crystal structure, or (c) both an oxidation state ranging from +2 to +4 and a BCC, FCC, or HCP crystal structure. In the formula, X is a first chalcogen element, Y is an optional second chalcogen element, and Z is an optional third chalcogen element. In the formula, a is an integer or a non-integer greater than 0 and less than or equal to 2; b is an integer or a non-integer ranging from 0 to 2, and c is an integer or a non-integer ranging from 0 to 2.

A second nanocomposite material in accordance with the present teachings includes (a) a nanosheet containing a metal chalcogenide having a formula MXₐY_{b}Z_{c}; and (b) a carbonaceous substrate supporting the nanosheet. In the formula, M is a transition metal selected from the group consisting of tungsten, molybdenum, nickel, cobalt, copper, and iron. In the formula, a is an integer or a non-integer greater than 0 and less than or equal to 2, b is an integer or a non-integer ranging from 0 to 2, and c is an integer or a non-integer ranging from 0 to 2. The carbonaceous material is selected from the group consisting of graphene and reduced graphene oxide (r-GO). In the formula, X and each of Y, and Z, if present, are individually selected from the group consisting of sulfur, selenium, and tellurium.

A first method for producing a nanocomposite material in accordance with the present teachings includes: (a) combining a transition metal, a chalcogen, and a carbonaceous substrate to form a reagent mixture; and (b) irradiating the reagent mixture with microwave radiation.

A second method for producing a nanocomposite material in accordance with the present teachings includes: (a) combining (i) a transition metal, (ii) a chalcogen selected from the group consisting of sulfur, selenium, tellurium, and a combination thereof, and (iii) graphene to form a reagent mixture; (b) mixing the reagent mixture to form a substantially homogeneous reagent mixture; and (c) irradiating the substantially homogeneous reagent mixture with microwave radiation.

A method for catalyzing a hydrogen evolution reaction (HER) in accordance with the present teachings includes using a nanocomposite material of a type described herein to catalyze a portion of a water electrolysis reaction that produces hydrogen gas with an overpotential ranging from about 8 mV to about 300 mV.

### BRIEF DESCRIPTION OF THE DRAWINGS

FIG. 1 shows a schematic illustration of a microwave-initiated synthesis of a MoTe₂/graphene composite, which may be employed as an electrocatalyst for hydrogen evolution reaction.

FIG. 2 shows SEM and TEM results: (a, b) SEM images of MoTe₂/graphene nanocomposite; (c) TEM and (d) HR-TEM images of MoTe₂/graphene nanocomposite; (e, f) Interlayer spacings of MoTe₂ and graphene nanosheets.

FIG. 3 shows electrochemical performance of the HER catalysts in 0.5 M H₂SO₄: (a) LSVs at a scan rate of 1 mV s⁻¹ for bare GCE, pure graphene, MoOₓ/graphene, MoTe₂/graphene, and Pt catalyst; (b) Corresponding Tafel plots; (c) Double layer capacitance measurements; (d) Nyquist plots showing the EIS responses of MoTe₂/graphene at various overpotentials (100-300 mV) [Inset: equivalent electrical circuit]; (e) LSVs of MoTe₂/graphene catalyst at a temperature range of 30−90° C., at a scan rate of 1 mV s⁻¹; (f) Corresponding Arrhenius plot for MoTe₂/graphene.

FIG. 4. shows stability tests and material characterizations: (a) 4000 cycles of MoTe₂/graphene from 0 to −350 mV vs. RHE at a scan rate of 50 mV s⁻¹ in 0.5 M H₂SO₄; (b) Change in overpotentials (q) with cycles; (c) Time dependence of cathodic current density during electrolysis for 90 hours at a constant overpotential of 150 mV; (d) Double layer capacitance measurements after 4000 cycles; (e) HR-TEM images of MoTe₂/graphene nanocomposite; (f, g) Interlayer spacings of MoTe₂ and graphene nanosheets after stability tests; (h) Ex-situ XRD patterns for MoTe₂/graphene.

FIG. 5 shows adsorption energies of different Mo₉Te₁₈ nanoparticle sites: The calculated binding free energy (ΔG_{adsorption}) and binding electronic energy (ΔE_{adsorption}) values at different adsorption sites of MoTe₂/graphene composite. The adsorption site indexing is as follows: (1) Mo corner, (2) Mo edge, (3) Te top surface, (4) Te corner, (5) Te edge, (6) Mo edge-Te edge, and (7) Mo corner-Te edge.

FIG. 6 shows a free energy diagram and Volcano plot: (a) Hydrogen adsorption free energy (ΔG_{adsorption}) diagrams at equilibrium (U=0 V); (b) Volcano plot of experimentally measured exchange current density (i₀) as a function of the DFT-calculated Gibbs free energy of atomic hydrogen adsorption (ΔG_{adsorption}). Literature data for different metals and MoS₂-catalyst have been adapted from Nørskov et al. (J. Electrochem. Soc. 152, 23-26 (2005)) and Jaramillo et al. (Science. 317, 100-102 (2007)), respectively. MoTe₂/graphene^{site 1} and MoTe₂/graphene^{site 6} represent Mo corner and Mo edge-Te edge adsorption sites from the current study, respectively.

FIG. 7 shows molecular structure of MoTe₂/graphene composite from DFT calculation: (a) Top and (b) side views of the Mo₉Te₁₈ nanoparticle taken from a structurally optimized MoTe₂ crystal; (c) Top and (d) side views of the Mo₉Te₁₈ nanoparticle over 7×7×1 graphene supercell with optimized geometries. Dashed lines in (a) highlight the edge sites and dashed rectangles in (b) denote the corner sites.

FIG. 8 shows energy dispersive X-ray spectroscopy (EDS) analysis: (a) EDS pattern of MoTe₂/graphene nanocomposite (inset table shows wt % and atomic % of carbon (C), molybdenum (Mo), and tellurium (Te) elements; (b) EDS elemental mapping of MoTe₂/graphene. The (c) violet, (d) pink, and (e) yellow color represents carbon (C), molybdenum (Mo), and tellurium (Te), respectively.

FIG. 9 shows X-ray diffraction and Raman analyses: (a) XRD pattern of MoTe₂/graphene composite; and Raman spectra of (b) pure graphene, and (c) MoTe₂/graphene composite; (d) Raman spectra within the range of 120-1100 cm⁻¹ to focus on MoTe₂ and MoOₓ peaks.

FIG. 10 shows X-ray photoelectron spectroscopy analysis: (a) XPS survey spectrum of MoTe₂/graphene composite; (b) XPS elemental composition; High-resolution XPS spectra of (c) Mo 3d, and (d) Te 3d regions of MoTe₂/graphene.

FIG. 11 shows exchange current density measurements: Exchange current densities for platinum (Pt) and MoTe₂/graphene composite from corresponding Tafel plots by extrapolation method.

FIG. 12 shows ECSA calculation: Cyclic voltammograms of (a, b) MoTe₂/graphene, (c, d) MoOₓ/graphene and (e, f) pure graphene in a potential window (0.3-0.4 V) without faradaic reaction to measure the electrochemically active surface area (ECSA), before and after 4000 CV cycles, respectively at a scan rate of 10-100 mVs⁻¹.

FIG. 13 shows EIS measurements: (a) Decrease in charge transfer resistance (R_{ct}) with increase in overpotentials (q) for MoTe₂/graphene; (b) Nyquist plots of pure graphene, MoOₓ/graphene and MoTe₂/graphene at 150 mV vs. RHE.

FIG. 14 shows exchange current density measurement: Tafel plots for MoTe₂/graphene-catalyst in 0.5 M H₂SO₄ at a temperature range of 30−90° C. to measure the corresponding exchange current densities.

FIG. 15 shows cyclic stability tests: 4000 cycles of (a) MoOₓ/graphene and (b) pure graphene from 0 to −350 mV vs. RHE at a scan rate of 50 mV s⁻¹ in 0.5 M H₂SO₄.

FIG. 16 shows material characterizations after stability tests: (a) EDS pattern of MoTe₂/graphene nanocomposite (inset table shows wt % and atomic % of carbon (C), molybdenum (Mo), and tellurium (Te) elements; (b) EDS elemental mapping of MoTe₂/graphene. The (c) red, (d) orange, and (e) cyan colors represent carbon (C), molybdenum (Mo), and tellurium (Te), respectively.

FIG. 17 shows top and side views of Mo corner adsorption site.

FIG. 18 shows top and side views of Mo edge adsorption site.

FIG. 19 shows top and side views of Te top surface adsorption site.

FIG. 20 shows top and side views of Te corner adsorption site.

FIG. 21 shows top and side views of Te edge adsorption site.

FIG. 22 shows top and side views of Mo edge-Te edge adsorption site.

FIG. 23 shows top and side views of Mo corner-Te edge adsorption site.

FIG. 24 shows a schematic illustration of the microwave-initiated synthesis of MoS₂/graphene composite, employing as an electrocatalyst for hydrogen evolution reaction.

FIG. 25 shows SEM images of (a, b) graphene flakes and (c, d) layered MoS₂ embedded on graphene, at low and high magnifications; (e) HRTEM image of MoS₂/graphene; (f) High-magnification HRTEM image of MoS₂ nanosheets and graphene. The interlayer distance of MoS₂ nanosheets is around 6.4 Å. (g) Low-magnification TEM image of MoS₂/graphene nanocomposite. (h) SAED pattern of MoS₂ nanosheets.

FIG. 26 shows (a) EDS pattern of MoS₂/graphene nanocomposite (inset table: wt % and atomic % of carbon (C), Sulfur (S), and Molybdenum (Mo) elements). Raman spectra of (b) pure graphene and (c) MoS₂/graphene composite (inset: MoS₂ peaks).

FIG. 27 shows (a) XRD pattern, and (b) XPS spectrum of MoS₂/graphene composite. High-resolution XPS spectra of (c) Mo 3d, and (d) S 2p regions of MoS₂/graphene.

FIG. 28 shows electrochemical performance of the HER catalysts in 0.5 M H₂SO₄ with a catalyst load of ˜5 mg/cm²: (a) Linear sweep voltammograms at a scan rate of 1 mV/s for bare GCE, pure MoS₂, pure graphene, MoS₂+graphene mixture, MoS₂/graphene composite, and Pt catalyst; (b) Corresponding Tafel plots, showing the Tafel slopes and Electrochemical capacitance measurements; (c) Cyclic voltammograms of MoS₂/graphene in a potential window without faradaic reaction; (d) Average capacitive current densities at different scan rates for MoS₂/graphene composite, MoS₂+graphene mixture and pure MoS₂.

FIG. 29 shows EIS tests: (a) Equivalent electrical circuit used to model the HER process on all catalyst samples; (b) Electrochemical impedance spectra of pure MoS₂, physical mixture of MoS₂+graphene, and MoS₂/graphene nanocomposite at an overpotential of 180 mV; (c) Nyquist plots showing the EIS responses of MoS₂/graphene at different overpotentials (50-300 mV) in 0.5 M H₂SO₄; (d) Charge transfer resistance (R_{ct}) as a function of HER overpotentials for MoS₂/graphene catalyst.

FIG. 30 shows stability tests with a catalyst load of ˜5 mg cm⁻²: (a) Cycling stability of MoS₂/graphene from 0 to −350 mV vs. RHE at a scan rate of 50 mV s⁻¹ in 0.5 M H₂SO₄, wherein the polarization curves from 1 to 4000 cycles are displayed; (b) Time dependence of cathodic current density on pure MoS₂, graphene, MoS₂+graphene mixture, and MoS₂/graphene composite during electrolysis over 90 hours at a constant overpotential of 180 mV; (c) Cyclic voltammograms in a potential window without faradaic processes after the 4000 cycles of CV; (d) Double layer capacitance measurements for MoS₂/graphene composite, before and after 4000 cycles of CV.

FIG. 31 shows (a) LSVs of MoS₂/graphene composite at a temperature range of 30-120° C. in 0.5 M H₂SO₄, at a scan rate of 1 mV s⁻¹; (b) Corresponding Arrhenius plot for MoS₂/graphene.

FIG. 32 shows gradual change in overpotentials of MoS₂/graphene-catalyst during cycling stability test for 4000 cycles in 0.5 M H₂SO₄.

FIG. 33 shows Tafel plots for MoS₂/graphene composite at a temperature range of 30-120° C.

FIG. 34 shows (a) Nitrogen adsorption isotherms and (b) BET surface area plots of pure MoS₂ and MoS₂/graphene composite.

FIG. 35 shows exchange current density measurements of Pt, MoS₂/graphene composite and MoS₂+graphene physical mixture from corresponding Tafel plots.

FIG. 36 shows cyclic voltammograms of pure MoS₂ in a potential window (0.3-0.4 V) without faradaic reaction to measure the electrochemically active surface area (ECSA).

FIG. 37 shows cyclic voltammograms of a physical mixture of MoS₂ and graphene mixture in a potential window (0.3-0.4 V) without faradaic reaction to measure the ECSA.

FIG. 38 shows cyclic voltammograms of MoS₂/graphene composite in a potential window (0.3-0.4 V) without faradaic reaction to measure the ECSA.

FIG. 39 shows optimized geometries of molybdenum sulfotelluride/graphene nanocomposite structures from periodic plane-wave DFT calculations.

FIG. 40 shows a schematic illustration of the microwave-assisted synthesis of MoSₓTe_{y}/Gr hybrid, employing as an electrocatalyst for hydrogen evolution reaction (HER) in acidic medium.

FIG. 41 shows (a) LSVs at a scan rate of 2 mV s⁻¹ for samples MST-1 to MST-6; (b) Corresponding overpotentials to reach the current density of 10 mA cm⁻²; (c) LSVs of bare GCE, graphene, MoS₂/Gr, MoTe₂/Gr, MoS_{0.46}Te_{0.58}/Gr and Pt/C catalysts at a scan rate of 2 mV s⁻¹; (d) Corresponding overpotentials at the cathodic current density of 10 mA cm⁻²; (e) Tafel slopes; and (f) Nyquist plots of catalyst samples.

FIG. 42 shows (a) Observations during microwave irradiation for 60 seconds; (b) XPS survey spectrum of MST-2 sample; (c-e) High-resolution XPS spectra of Mo 3d, S 2p, and Te 3d regions, respectively; (f) EDS mapping of carbon (C), molybdenum (Mo), sulfur (S), and tellurium (Te) species; (g) SEM; (h) TEM; (i) HRTEM images; and (j) XRD pattern of MoS_{0.46}Te_{0.58}/Gr hybrid (MST-2).

FIG. 43 shows EDS patterns of MoSₓTe_{y}/Gr samples; (a) MST-1; (b) MST-2; (c) MST-3; (d) MST-4. [inset tables display the wt. % and at. % of carbon (C), molybdenum (Mo), sulfur (S), tellurium (Te) and oxygen (O)].

FIG. 44 shows (a) Nyquist plots of MoS_{0.46}Te_{0.58}/Gr at various η of 50-200 mV; (b) Turnover frequency (TOF) estimations for catalyst samples at the η of 10-200 mV; (c) The LSVs of MoS_{0.46}Te_{0.58}/Gr within a temperature range of 30° C. to 100° C.; (d) Corresponding Tafel plots [Inset: Arrhenius plot to determine the activation energy].

FIG. 45 shows CV curves in phosphate buffer solution (pH=7) for the catalyst samples of (a) MoS_{0.46}Te_{0.58}/Gr, (b) MoS₂/Gr, (c) MoTe₂/Gr and (d) 10 wt. % Pt/C.

FIG. 46 shows (a) Cycling stability of MoS_{0.46}Te_{0.58}/Gr at a scan rate of 50 mV s⁻¹ (LSV curves from 1 to 5000 cycles are displayed); (b) Chronoamperometric curve during the electrolysis over 90 hours at a constant overpotential of 150 mV; (c) CVs of MoS_{0.46}Te_{0.58}/Gr in a non-faradaic potential window before 5000 cycles; (d) Measured EDLCs for MoS₂/Gr, MoTe₂/Gr and MoS_{0.46}Te_{0.58}/Gr; (e) CVs of MoS_{0.46}Te_{0.58}/Gr in a non-faradaic potential window after 5000 cycles; (f) Measured EDLCs for MoS_{0.46}Te_{0.58}/Gr before and after 5000 cycles.

FIG. 47 shows CVs of MoS₂/Gr and MoTe₂/Gr in a non-faradaic potential window of 0.3-0.4 V vs. RHE at scan rates of 10 to 100 mV s⁻¹.

FIG. 48 shows (a) EDS analysis, (b) XRD pattern, and (c) EDS mapping of MoS_{0.46}Te_{0.58}/Gr nanocomposite after cycling stability test for 5000 CV cycles.

FIG. 49 shows calculated free energy of binding (ΔG: denoted with red circles) and binding electronic energy (ΔE: denoted with black squares) values at different binding sites of the Mo₉S₈Te₁₀/Gr nanocomposite structure. The binding site indexing is as follows: (1) Chalcogen edge, (2) Mo corner, (3) Mo edge-Te edge, (4) Mo edge-S edge, (5) Chalcogen top (S and Te), (6) Chalcogen top (only S), and (7) Chalcogen corner.

FIG. 50 shows calculated free energy of binding (ΔG: denoted with red circles) and binding electronic energy (ΔE: denoted with black squares) values at different binding sites of Mo₉S₆Te₇/Gr nanocomposite structure. The binding site indexing is as follows: (1) Mo corner, (2) Mo edge 1, (3) Mo edge 2, (4) Mo corner-Mo edge, and (5) tail-side Mo corner.

FIG. 51 shows calculated free energy of binding (ΔG: denoted with red circles) and binding electronic energy (ΔE: denoted with black squares) values at different binding sites for both types of Mo₉S₄Te₅/Gr nanocomposite (Type-1 and Type-2) structures. The binding site indexing is as follow; for Type-1 (purple boxes): (1) Mo corner, (2) Mo corner-Mo edge 1, (3) Mo corner-Mo edge 2, (4) tail-side Mo corner-Mo edge, and for Type-2 (green boxes): (5) Mo corner, (6) Mo corner-Mo edge 1, and (7) Mo corner-Mo edge 2.

FIG. 52 shows free energy diagram for effective hydrogen atom binding at equilibrium (η=0 V). Values of the binding free energy of Pt and Pd are taken from the literature.

FIG. 53 shows volcano plot of experimentally measured current density (i₀) vs. DFT calculated Gibbs free energy of hydrogen binding (ΔG_{binding}). With the exception of the MoS_{0.46}Te_{0.58}/Gr system, all presented data values are from literature sources. The computationally derived ΔG_{binding} value for the MoS_{0.46}Te_{0.58}/Gr composite is from the Mo₉S₄Te₅/Gr system with the most similar empirical formula.

FIG. 54 shows (a, d, g) XPS spectra of MoS₂/Gr, MoSe₂/Gr, and MoTe₂/Gr nanocomposites. High-resolution XPS spectra of (b, e, h) Mo 3d, (c) S 2p, (f) Se 3d, and (i) Te 3d regions.

FIG. 55 shows (a) XPS survey spectrum of MoSSe/Gr nanocomposite. High-resolution XPS spectra of (b) Mo 3d, (c) S 2p, and (d) Se 3d regions.

FIG. 56 shows (a) XPS survey spectrum of MoSeTe/Gr nanocomposite. High-resolution XPS spectra of (b) Mo 3d, (c) Se 3d, and (d) Te 3d regions.

FIG. 57 shows (a) XPS survey spectrum of MoSTe/Gr nanocomposite. High-resolution XPS spectra of (b) Mo 3d, (c) S 2p, and (d) Te 3d regions.

FIG. 58 shows (a) XPS survey spectrum of Mo(SSeTe)_{0.67}/Gr nanocomposite.

High-resolution XPS spectra of (b) Mo 3d, (c) S 2p, (d) Se 3d, and (e) Te 3d regions.

FIG. 59 shows (a) XRD patterns of molybdenum dichalcogenides with graphene nanocomposites (i.e., MoS₂/Gr, MoSe₂/Gr, and MoTe₂/Gr); (b) XRD patterns of hybrid nanocomposites (i.e., MoSSe/Gr, MoSeTe/Gr, MoSTe/Gr, and Mo(SSeTe)_{0.67}/Gr).

FIG. 60 shows (a) LSVs at a scan rate of 2 mV s⁻¹ for MoS₂/Gr, MoSe₂/Gr, MoTe₂/Gr, and 10 wt. % Pt/C catalysts; (b) Corresponding overpotential values; (c) Corresponding Tafel plots; (d) Constant potential stability tests for 96 hours at 250 mV vs. RHE.

FIG. 61 shows (a) LSVs at a scan rate of 2 mV s⁻¹ for MoSSe/Gr, MoSeTe/Gr, MoSTe/Gr, and Mo(SSeTe)_{0.67}/Gr catalysts; (b) Corresponding overpotential values; (c) Corresponding Tafel plots; (d) Constant potential stability tests for 96 hours at 250 mV vs. RHE.

FIG. 62 shows measurements of exchange current densities for all different MC-based catalysts and for the 10 wt. % Pt/C catalyst.

FIG. 63 shows bar graphs displaying the three major parameters (overpotential, Tafel slope, and exchange current density) of MC-based HER catalysts.

FIG. 64 shows generalized molecular structure of Mo₉Ch₁₈/graphene: (a) Top and (b) side views of a generalized Mo₉Ch₁₈ nanoparticle; (c) Top and (d) side views of the Mo₉Ch₁₈ nanoparticle over 7×7×1 graphene supercell with optimized geometries. Dashed rectangles in (b) denote the corner sites.

FIG. 65 shows calculated free energy of binding (ΔG_{b}: denoted with red circles) and binding electronic energy (ΔE_{b}: denoted with black squares) values at different binding sites of the Mo₉S₈Te₁₀/Gr nanocomposite structure. The binding site indexing is as follows: (1) Sulfur edge (vicinal), (2) Mo corner, (3) S top, (4) Mo edge-S edge, (5) Mo Corner-S Edge, (6) S corner, and (7) S edge (geminal), (8) Mo edge, and (9) Mo corner and edge.

FIG. 66 shows calculated free energy of binding (ΔG_{b}: denoted with red circles) and binding electronic energy (ΔE_{b}: denoted with black squares) values at different binding sites of the Mo₉Se₁₈/Gr nanocomposite structure. The binding site indexing is as follows: (1) Se edge (vicinal), (2) Mo corner, (3) Se top, (4) Mo edge-Se edge, (5) Mo Corner-Se Edge, (6) S corner, and (7) Se edge (geminal), (8) Mo edge, and (9) Mo corner and edge.

FIG. 67 shows calculated free energy of binding (ΔG_{b}: denoted with red circles) and binding electronic energy (ΔE_{b}: denoted with black squares) values at different binding sites of the Mo₉Te₁₈/Gr nanocomposite structure. The binding site indexing is as follows: (1) Te edge (vicinal), (2) Mo corner, (3) Te top, (4) Mo edge-Te edge, (5) Mo Corner-Te Edge, (6) S corner, and (7) Te edge (geminal), (8) Mo edge, and (9) Mo corner and edge.

FIG. 68 shows calculated free energy of binding (ΔG_{b}: denoted with red circles) and binding electronic energy (ΔE_{b}: denoted with black squares) values at different binding sites of the Mo₉S₉Se₉/Gr nanocomposite structure. The binding site indexing is as follows: (1) chalcogen edge (vicinal 1), (2) chalcogen edge (vicinal 2), (3) Mo corner, (4) chalcogen top 1 (only Se), (5) chalcogen top 2 (S and Se), (6) Mo edge-Se edge, (7) Mo edge-S edge, (8) Mo Corner-T Edge, (9) chalcogen corner, and (10) chalcogen edge (germinal 1), (11) chalcogen edge (germinal 2), (12) Mo edge 1, (13) Mo edge 2, and (14) Mo corner and edge.

FIG. 69 shows calculated free energy of binding (ΔG_{b}: denoted with red circles) and binding electronic energy (ΔE_{b}: denoted with black squares) values at different binding sites of the Mo₉S₉Se₉/Gr nanocomposite structure. The binding site indexing is as follows: (1) chalcogen edge (vicinal 1), (2) chalcogen edge (vicinal 2), (3) Mo corner, (4) chalcogen top 1 (only Te), (5) chalcogen top 2 (S and Te), (6) Mo edge-S edge, (7) Mo edge-Te edge, (8) Mo Corner-Te Edge, (9) chalcogen corner, and (10) chalcogen edge (germinal 1), (11) chalcogen edge (germinal 2), (12) Mo edge 1, (13) Mo edge 2, and (14) Mo corner and edge.

FIG. 70 shows calculated free energy of binding (ΔG_{b}: denoted with red circles) and binding electronic energy (ΔE_{b}: denoted with black squares) values at different binding sites of the Mo₉S₉Se₉/Gr nanocomposite structure. The binding site indexing is as follows: (1) chalcogen edge (vicinal 1), (2) chalcogen edge (vicinal 2), (3) Mo corner, (4) chalcogen top 1 (only Te), (5) chalcogen top 2 (Se and Te), (6) Mo edge-Se edge, (7) Mo edge-Te edge, (8) Mo Corner-Te Edge, (9) chalcogen corner, and (10) chalcogen edge (germinal 1), (11) chalcogen edge (germinal 2), (12) Mo edge 1, (13) Mo edge 2, and (14) Mo corner and edge.

FIG. 71 shows calculated free energy of binding (ΔG_{b}: denoted with red circles) and binding electronic energy (ΔE_{b}: denoted with black squares) values at different binding sites of the Mo₉S₉Se₉/Gr nanocomposite structure. The binding site indexing is as follows: (1) chalcogen edge (vicinal 1: Se and Te), (2) chalcogen edge (vicinal 2: Te and Se), (3) Mo corner, (4) chalcogen top 1 (S and Te), (5) chalcogen top 2 (S and Se), (6) Mo edge-Te edge, (7) Mo edge-Se edge, (8) Mo Corner-S Edge, (9) chalcogen corner (S and Se), and (10) chalcogen edge (germinal 1: Te and Se), (11) chalcogen edge (germinal 2: Se and S), (12) Mo edge 1, (13) Mo edge 2, and (14) Mo corner and edge.

FIG. 72 shows free energy diagram for effective hydrogen atom binding at equilibrium (η=0 V). Values of the binding free energy of Pt and Pd are taken from the literature.

### DETAILED DESCRIPTION

Nanocomposite materials for use in catalyzing the hydrogen evolution reaction (HER) have been discovered and are described herein. The nanocomposite materials in accordance with the present teachings include a nanosheet containing a metal chalcogenide and a carbonaceous substrate supporting the nanosheet, and may be prepared rapidly using a microwave-initiated approach. In some embodiments, as further described below, the nanocomposite materials in accordance with the present teachings are highly active and durable for the HER with small overpotentials and little loss of activity. Moreover, in some embodiments, as further described below, the metal chalcogenide of the nanocomposite materials contains a non-noble metal, thus providing a cost-effective alternative to the precious noble metal catalysts (e.g., platinum-based catalysts) that have been used heretofore to catalyze the HER.

In this work, the molybdenum dichalcogenides (MoX₂, X═S, Se, Te) and their hybrid nanocomposites (MoSSe, MoSeTe, MoSTe, and Mo(SSeTe)_{0.67}) were constructed on a graphene network through a microwave-assisted heating approach. The as-synthesized materials were employed as working electrodes in a standard three-electrode setup to investigate their electrocatalytic properties for the hydrogen evolution reaction (HER). The electrochemical measurements revealed that all the materials are highly active and durable for HER with small overpotentials (e.g., in some embodiments, in the range of 127-217 mV) and negligible activity loss (e.g., in some embodiments, for 96 hours of constant potential tests). Among all different molybdenum chalcogenide/graphene-nanocomposites, the materials containing tellurium (Te) exhibited better HER activities, which could be due to the presence of metallic phase of MoTe₂ in the catalyst structures. Hybrid nanocomposites, only except Mo(SSeTe)_{0.67} on graphene, exhibited improved performance in comparison to the MoX₂ compounds. While neither desiring to be bound by any particular theory nor intending to limit in any measure the scope of the appended claims or their equivalents, it is presently believed that such improvements reflect the higher intrinsic activity of alloyed catalysts with the hydrogen adsorption free energy closer to thermoneutral.

Throughout this description and in the appended claims, the following definitions are to be understood:

The phrase “hydrogen evolution reaction” and its acronym, “HER,” refer to the production of hydrogen (H₂) through the electrolysis of water in the chemical equation 2H₂O (l)→2H₂ (g)+O₂ (g). More specifically, the phrase “hydrogen evolution reaction” and its acronym, “HER,” refer to the half-equation that takes place at the cathode in an electrochemical water splitting reaction (2H⁺+2 e⁻→H₂).

The term “nanocomposite” refers to a composite structure that contains two or more different materials, at least one of which has one, two, or three of its dimensions less than about 100 nm. In some embodiments, a nanocomposite material in accordance with the present teachings includes a metal chalcogenide compound and an electrically conductive support material.

The term “nanosheet” refers to a two-dimensional nanostructure having a thickness ranging from about 1 nm to about 100 nm.

The phrase “metal chalcogenide” refers to a compound that contains at least one “transition metal” and at least one “chalcogen.” As used herein, the phrase “metal chalcogenide” encompasses compounds that contain only a single type of chalcogen atom (e.g., MXₐ, where M is a transition metal, X is a chalcogen element, and a is a stoichiometric or non-stoichiometric amount of X) as well as compounds that contain two or more different types of chalcogen atoms (e.g., MXₐY_{b}, where M is a transition metal, X is a first chalcogen element, Y is a second chalcogen element, a is a stoichiometric or non-stoichiometric amount of X, and b is a stoichiometric or non-stoichiometric amount of Y; MXₐY_{b}Z_{c}, where M is a transition metal, X is a first chalcogen element, Y is a second chalcogen element, Z is a third chalcogen element, a is a stoichiometric or non-stoichiometric amount of X, b is a stoichiometric or non-stoichiometric amount of Y, and c is a stoichiometric or non-stoichiometric amount of Z).

The phrase “transition metal” refers to any element in the d-block of the Periodic Table.

The term “chalcogen” refers to any element in Group 16 of the Periodic Table (e.g., oxygen, sulfur, selenium, tellurium, polonium).

The term “carbonaceous” refers to a material that contains carbon, including but not limited to all known and as-yet-to-be-identified allotropes of carbon.

The term “integer” refers to the set of positive whole numbers {1, 2, 3, . . . }, negative whole numbers {−1, −2, −3, . . . }, and zero {0}.

The term “non-integer” refers to a number that is not a positive whole number, a negative whole number, or zero. The term “non-integer” includes real numbers that are not integers, including but not limited to decimals.

The phrase “stoichiometric compound” refers to a compound having an elemental composition whose proportions can be represented by a ratio of natural numbers (i.e., positive integers).

The phrase “non-stoichiometric compound” refers to a compound having an elemental composition whose proportions cannot be represented by a ratio of natural numbers (i.e., positive integers) but can be represented by a ratio of non-integers (e.g., decimals).

It is to be understood that elements and features of the various representative embodiments described below may be combined in different ways to produce new embodiments that likewise fall within the scope of the present teachings.

By way of general introduction, a first nanocomposite material in accordance with the present teachings—which, in some embodiments, may be used to catalyze a hydrogen evolution reaction (HER)—includes (a) a nanosheet containing a metal chalcogenide having a formula MXₐY_{b}Z_{c}; and (b) a carbonaceous substrate supporting the nanosheet. In the formula, M is a transition metal having (a) an oxidation state ranging from +2 to +4, (b) a body-centered cubic (BCC) crystal structure, a face-centered cubic (FCC) crystal structure, or a hexagonal close packed (HCP) crystal structure, or (c) both an oxidation state ranging from +2 to +4 and a BCC, FCC, or HCP crystal structure. In the formula, X is a first chalcogen element, Y is an optional second chalcogen element, and Z is an optional third chalcogen element. In the formula, a is an integer or a non-integer greater than 0 and less than or equal to 2; b is an integer or a non-integer ranging from 0 to 2, and c is an integer or a non-integer ranging from 0 to 2.

In some embodiments, the metal chalcogenide forms a nanosheet on the carbonaceous substrate.

The carbonaceous substrates for use in accordance with the present teachings include all manner of carbon-containing materials configured to provide an electrically conductive support. By way of illustration, representative carbonaceous substrates include but are not limited to diamond, graphite (e.g., graphene, graphenylene, AA′-graphite, diamine), carbon black, amorphous carbon, nanocarbons (e.g., Buckminsterfullerenes, carbon nanotubes, carbon nanobuds, schwarzites), glassy carbon, atomic and diatomic carbon, carbon nanofoam, carbide-derived carbon, lonsdaleite (hexagonal diamond), linear acetylenic carbon, cyclocarbons, and the like, and combinations thereof. In some embodiments, the carbonaceous substrate includes a conducting polymer, carbon black, graphene, reduced graphene oxide (r-GO), carbon nanotubes (CNTs), or a combination thereof. In some embodiments, the carbonaceous substrate includes graphene. In other embodiments, the carbonaceous substrate includes reduced graphene oxide (r-GO).

The transition metals for use in accordance with the present teachings include any d-block element of the Periodic Table. Representative transition metals include but are not limited to any d-block element having (a) an oxidation state ranging from +2 to +4, (b) a body-centered cubic (BCC) crystal structure, a face-centered cubic (FCC) crystal structure, or a hexagonal close packed (HCP) crystal structure, or (c) both an oxidation state ranging from +2 to +4 and a BCC, FCC, or HCP crystal structure. In some embodiments, representative transition metals include but are not limited to any d-block element having (a) an oxidation state ranging from +2 to +4 (e.g., +2, +3, +4), (b) a body-centered cubic (BCC) crystal structure, or (c) both an oxidation state ranging from +2 to +4 and a BCC crystal structure. In some embodiments, the transition metal is a so-called non-noble metal (e.g., any transition metal except for gold, silver, platinum, rhodium, iridium, ruthenium, osmium, or palladium). In other embodiments, the transition metal is selected from the group consisting of tungsten, molybdenum, nickel, cobalt, copper, and iron. In some embodiments, the transition metal is tungsten. In other embodiments, the transition metal is molybdenum.

The chalcogens for use in accordance with the present teachings include elemental forms of any element in Group 16 of the Periodic Table as well as any chalcogen-containing molecular sources of such elements. Representative chalcogens include but are not limited to oxygen, sulfur, selenium, tellurium, and combinations thereof. In some embodiments, each of the first chalcogen element, the optional second chalcogen element, and the optional third chalcogen element is independently selected from the group consisting of sulfur, selenium, and tellurium. In some embodiments, each of the first chalcogen element, the optional second chalcogen element, and the optional third chalcogen element is independently selected from the group consisting of selenium, tellurium, and a combination thereof. Although oxygen may be used as a chalcogen (e.g., a nanocomposite material containing a metal oxide nanosheet), it is believed that a HER that uses such a material as catalyst will benefit from a basic pH (e.g., greater than 7.0) rather than an acidic pH because metal oxides are susceptible to damage in acidic media.

A metal chalcogenide in accordance with the present teachings may be either a stoichiometric compound or a non-stoichiometric compound. In some embodiments, the metal chalcogenide MXₐY_{b}Z_{c} is a stoichiometric compound. In some embodiments, the metal chalcogenide is a stoichiometric compound, wherein b is zero, wherein c is zero, and

wherein a is 2. In some embodiments, the metal chalcogenide is a stoichiometric compound, wherein b is zero, wherein c is zero, wherein a is 2, and wherein X is sulfur, selenium, or tellurium. In some embodiments, the metal chalcogenide is a stoichiometric compound, wherein b is zero, wherein c is zero, wherein a is 2, and wherein X is selenium, or tellurium. In some embodiments, the metal chalcogenide is a stoichiometric compound, wherein b is zero, wherein c is zero, wherein a is 2, and wherein X is selenium. In some embodiments, the metal chalcogenide is a stoichiometric compound, wherein b is zero, wherein c is zero, wherein a is 2, and wherein X is tellurium. In some embodiments, the metal chalcogenide is a stoichiometric compound, wherein b is zero, wherein c is zero, wherein a is 2, wherein M is molybdenum, and wherein X is sulfur, selenium, or tellurium. In some embodiments, the metal chalcogenide is a stoichiometric compound, wherein b is zero, wherein c is zero, wherein a is 2, wherein M is molybdenum, and wherein X is selenium or tellurium. In some embodiments, the metal chalcogenide is a stoichiometric compound, wherein b is zero, wherein c is zero, wherein a is 2, wherein M is molybdenum, and wherein X is selenium. In some embodiments, the metal chalcogenide is a stoichiometric compound, wherein b is zero, wherein c is zero, wherein a is 2, wherein M is molybdenum, and wherein X is tellurium. In some embodiments, the metal chalcogenide is a stoichiometric compound, wherein b is zero, wherein c is zero, wherein a is 2, wherein M is molybdenum, wherein X is sulfur, selenium, or tellurium, and wherein the carbonaceous material is graphene or reduced graphene oxide (r-GO). In some embodiments, the metal chalcogenide is a stoichiometric compound, wherein b is zero, wherein c is zero, wherein a is 2, wherein M is molybdenum, wherein X is selenium or tellurium, and wherein the carbonaceous material is graphene or reduced graphene oxide (r-GO). In some embodiments, the metal chalcogenide is a stoichiometric compound, wherein b is zero, wherein c is zero, wherein a is 2, wherein M is molybdenum, wherein X is selenium, and wherein the carbonaceous material is graphene or reduced graphene oxide (r-GO). In some embodiments, the metal chalcogenide is a stoichiometric compound, wherein b is zero, wherein c is zero, wherein a is 2, wherein M is molybdenum, wherein X is tellurium, and wherein the carbonaceous material is graphene or reduced graphene oxide (r-GO).

In some embodiments, the metal chalcogenide MXₐY_{b}Z_{c} is a non-stoichiometric compound. In some embodiments, the metal chalcogenide is a non-stoichiometric compound, wherein c is zero, wherein X is sulfur, and wherein Y is selenium. In some embodiments, the metal chalcogenide is a non-stoichiometric compound, wherein M is molybdenum, wherein c is zero, wherein X is sulfur, and wherein Y is selenium. In some embodiments, the metal chalcogenide is a non-stoichiometric compound, wherein M is molybdenum, wherein c is zero, wherein X is sulfur, wherein Y is selenium, and wherein the carbonaceous material is graphene or reduced graphene oxide (r-GO). In some embodiments, the metal chalcogenide is a non-stoichiometric compound, wherein c is zero, wherein X is selenium, and wherein Y is tellurium. In some embodiments, the metal chalcogenide is a non-stoichiometric compound, wherein M is molybdenum, wherein c is zero, wherein X is selenium, and wherein Y is tellurium. In some embodiments, the metal chalcogenide is a non-stoichiometric compound, wherein M is molybdenum, wherein c is zero, wherein X is selenium, wherein Y is tellurium, and wherein the carbonaceous material is graphene or reduced graphene oxide (r-GO). In some embodiments, the metal chalcogenide is a non-stoichiometric compound, wherein M is molybdenum, wherein c is zero, wherein X is selenium, wherein Y is tellurium, and wherein the carbonaceous material is graphene or reduced graphene oxide (r-GO). In some embodiments, the metal chalcogenide is a non-stoichiometric compound, wherein M is molybdenum, wherein c is zero, wherein X is selenium, wherein a is 0.46, wherein Y is tellurium, and wherein b is 0.58. In some embodiments, the metal chalcogenide is a non-stoichiometric compound, wherein X is sulfur, wherein Y is selenium, and wherein Z is tellurium. In some embodiments, the metal chalcogenide is a non-stoichiometric compound, wherein M is molybdenum, wherein X is sulfur, wherein Y is selenium, and wherein Z is tellurium. In some embodiments, the metal chalcogenide is a non-stoichiometric compound, wherein M is molybdenum, wherein X is sulfur, wherein Y is selenium, wherein Z is tellurium, and wherein the carbonaceous material is graphene or reduced graphene oxide (r-GO). In some embodiments, the metal chalcogenide is a non-stoichiometric compound having a formula Mo(SSeTe)_{0.67}.

A nanocomposite material in accordance with the present teachings may be single-layer or multi-layer. In some embodiments, the nanocomposite material has a monolayer structure. In other embodiments, the nanocomposite material has a multi-layer structure that includes a plurality of nanosheets (e.g., two or more) and/or a plurality of carbonaceous substrates (e.g., two or more).

A second nanocomposite material in accordance with the present teachings—which, in some embodiments, may be used to catalyze a hydrogen evolution reaction (HER)—includes (a) a nanosheet containing a metal chalcogenide having a formula MXₐY_{b}Z_{c}; and (b) a carbonaceous substrate supporting the nanosheet. In the formula, M is a transition metal selected from the group consisting of tungsten, molybdenum, nickel, cobalt, copper, and iron. In the formula, a is an integer or a non-integer greater than 0 and less than or equal to 2, b is an integer or a non-integer ranging from 0 to 2, and c is an integer or a non-integer ranging from 0 to 2. The carbonaceous material is selected from the group consisting of graphene and reduced graphene oxide (r-GO). In the formula, X and each of Y, and Z, if present, are individually selected from the group consisting of sulfur, selenium, and tellurium.

A first method for producing a nanocomposite material in accordance with the present teachings includes: (a) combining a transition metal, a chalcogen, and a carbonaceous substrate to form a reagent mixture; and (b) irradiating the reagent mixture with microwave radiation.

In some embodiments, the method for producing a nanocomposite material in accordance with the present teachings further includes mixing the transition metal, the chalcogen, and the carbonaceous substrate prior to the irradiating. In some embodiments, the mixing is performed at ambient temperature and pressure. In some embodiments, the mixing provides a substantially homogeneous reagent mixture (e.g., one in which the reagent mixture has, on average, a substantially uniform composition throughout its volume—whether it contains only solids, a homogenous liquid solution, or a heterogeneous solid-liquid combination, such as a slurry). The type of mixing used in accordance with the present teachings is not restricted. In some embodiments, the mixing includes high-speed mixing. In some embodiments, the mixing includes high-speed mixing of greater than or equal to about 500 revolutions per minute (rpm), in some embodiments greater than or equal to about 600 rpm, in some embodiments greater than or equal to about 700 rpm, in some embodiments greater than or equal to about 800 rpm, in some embodiments greater than or equal to about 900 rpm, in some embodiments greater than or equal to about 1000 rpm, in some embodiments greater than or equal to about 1100 rpm, in some embodiments greater than or equal to about 1200 rpm, in some embodiments greater than or equal to about 1300 rpm, in some embodiments greater than or equal to about 1400 rpm, in some embodiments greater than or equal to about 1500 rpm, in some embodiments greater than or equal to about 1600 rpm, in some embodiments greater than or equal to about 1700 rpm, in some embodiments greater than or equal to about 1800 rpm, in some embodiments greater than or equal to about 1900 rpm, in some embodiments greater than or equal to about 2000 rpm.

The source of microwave irradiation used to irradiate the reagent mixture in accordance with the present teachings is not restricted and may be readily determined by one of ordinary skill in the art based on convenience and/or availability. In some embodiments, an industrial microwave source may be used. In other embodiments, a domestic microwave oven may be used. In some embodiments, the irradiating is achieved with a microwave source having a frequency of at least 300 MHz, in some embodiments a frequency ranging from about 300 MHz to about 100 GHz, in other embodiments from about 500 MHz to about 100 GHz, in other embodiments from about 1 GHz to about 100 GHz, in other embodiments from about 1 GHz to about 35 GHz, in other embodiments from about 1 GHz to about 25 GHz, in other embodiments from about 1 GHz to about 15 GHz, in other embodiments from about 1 GHz to about 10 GHz, in other embodiments from about 1 GHz to about 5 GHz, and in other embodiments from about 2 GHz to about 3 GHz. In some embodiments, the frequency is about 2.45 GHz. In some embodiments, the irradiating is achieved with a microwave source having a power of at least 500 W, in some embodiments a power ranging from about 500 W to about 3000 W, in other embodiments from about 800 W to about 2500 W, in other embodiments from about 850 W to about 2000 W, in other embodiments from about 900 W to about 1800 W, and in other embodiments from about 1000 W to about 1500 W. In some embodiments, the power is about 1250 W. The duration of time in which the reagent mixture is irradiated with microwave radiation is likewise not restricted, and may be readily determined by one of ordinary skill in the art based on the desired properties and/or performance characteristics of the resultant nanocomposite material. In some embodiments, a duration of the irradiating is between about 30 seconds and about 120 seconds, in other embodiments between about 45 seconds and about 100 seconds, and in further embodiments between about 55 seconds and about 95 seconds. In some embodiments, the duration of the irradiating is at least about 10 seconds, in other embodiments at least about 25 seconds, in other embodiments at least about 30 seconds, in other embodiments at least about 45 seconds, and in other embodiments at least about 60 seconds. In some embodiments, the duration of the irradiating is less than or equal to about 120 seconds, in other embodiments less than or equal to about 100 seconds, and in other embodiments less than or equal to about 90 seconds.

The source of the transition metal used to form a metal chalcogenide in accordance with the present teachings is not limited. In some embodiments, the transition metal is provided in elemental form. In other embodiments, the transition metal is derived from a molecular source. In some embodiments, the transition metal is provided in the form of a transition metal carbonyl compound. In some embodiments, the transition metal is molybdenum. In some embodiments, the transition metal is molybdenum, and the molybdenum is introduced into the reagent mixture as molybdenum hexacarbonyl. In other embodiments, the transition metal is molybdenum, and the molybdenum is introduced into the reagent mixture as ammonium tetrathiomolybdate (ATTM). In other embodiments, the transition metal is molybdenum, and the molybdenum is introduced into the reagent mixture as MoS₂.

The source of the chalcogen used to form a metal chalcogenide in accordance with the present teachings is not limited. In some embodiments, the chalcogen is provided in elemental form. In other embodiments, the chalcogen is derived from a molecular source. In some embodiments, the chalcogen comprises two or more different chalcogen elements. In some embodiments, the chalcogen is introduced into the reagent mixture as an elemental powder. In some embodiments, the chalcogen is tellurium, and the tellurium is introduced into the reagent mixture as tellurium powder. In some embodiments, the chalcogen is selenium, and the selenium is introduced into the reagent mixture as selenium powder. In some embodiments, the chalcogen is sulfur, and wherein the sulfur is introduced into the reagent mixture as carbon disulfide. In some embodiments, the chalcogen includes both sulfur and selenium. In some embodiments, the chalcogen includes both sulfur and tellurium. In some embodiments, the chalcogen includes both selenium and tellurium. In some embodiments, the chalcogen includes all three of sulfur, selenium, and tellurium.

A second method for producing a nanocomposite material in accordance with the present teachings includes: (a) combining (i) a transition metal, (ii) a chalcogen selected from the group consisting of sulfur, selenium, tellurium, and a combination thereof, and (iii) graphene to form a reagent mixture; (b) mixing the reagent mixture to form a substantially homogeneous reagent mixture; and (c) irradiating the substantially homogeneous reagent mixture with microwave radiation.

A method for catalyzing a hydrogen evolution reaction (HER) in accordance with the present teachings includes using a nanocomposite material of a type described herein to catalyze a portion of a water electrolysis reaction that produces hydrogen gas.

In some embodiments, the portion of the water electrolysis reaction that produces the hydrogen gas takes place at a cathode. In some embodiments, the method for catalyzing a hydrogen evolution reaction (HER) in accordance with the present teachings further includes applying the nanocomposite material to a surface of a glassy carbon electrode (GCE) to form a working electrode. In some embodiments, the method for catalyzing a hydrogen evolution reaction (HER) in accordance with the present teachings further includes polishing the surface, rinsing the surface with deionized water, and vacuum drying the surface prior to the applying of the nanocomposite material. In some embodiments, the method for catalyzing a hydrogen evolution reaction (HER) in accordance with the present teachings further includes mixing the nanocomposite material with poly-vinylidene fluoride (PVDF) powder and N,N-dimethylformamide (DMF) to form a homogeneous slurry, and drop-coating the homogeneous slurry onto a clean surface of the GCE.

Additional detailed description will now be provided in turn to illustrate each of the following aspects of the present teachings: (i) thermoneutral hydrogen evolution reaction using noble metal-free MoTe₂/Graphene nanocomposites; (ii) microwave-initiated synthesis of MoS₂/Graphene catalyst for enhanced hydrogen evolution reaction; (iii) enhancement of hydrogen evolution reaction activity using metal-rich Molybdenum Sulfotelluride with Graphene support; (iv) HER activities of Molybdenum Chalcogenide/Graphene and their hybrid nanocomposites; and (v) hybrid and non-hybrid Molybdenum Chalcogenides as electrocatalysts for cathodic hydrogen generation. Additional aspects of MoTe₂/Graphene nanocomposite in accordance with the present teachings are described in Journal of Colloid and Interface Science, 2021, 581, Part B, 847-859 and the references cited therein. Additional aspects of MoS₂/Graphene nanocomposites are described Science China Materials, 2020, 63, No. 1, 62-74 and the references cited therein.

Thermoneutral Hydrogen Evolution Reaction Using Noble Metal-Free MoTe₂/Graphene Nanocomposites

The development of efficient electrocatalysts for hydrogen generation my prove beneficial in meeting future energy demand. In recent years, molybdenum ditelluride (MoTe₂) has been investigated due to intrinsic nontrivial band gap with promising semi-metallic behaviors. In this work, 2D MoTe₂ nanosheets have been synthesized uniformly on graphene substrate through an ultra-fast microwave-initiated approach that shows a superior hydrogen evolution in acidic medium with low overpotential, large cathodic current, and low activation energy. Interestingly, MoTe₂/graphene enhances the catalytic ability during the long cycling test, achieving a very low overpotential of only 8.2 mV. Moreover, the results from periodic plane-wave density functional theory (DFT) indicate that the best active sites are the corner of a Mo-atom and a critical bifunctional site comprised of adjacent Mo and Te edge atoms. Furthermore, the corresponding volcano plot reveals the near thermoneutral catalytic activity of MoTe₂/graphene for hydrogen generation.

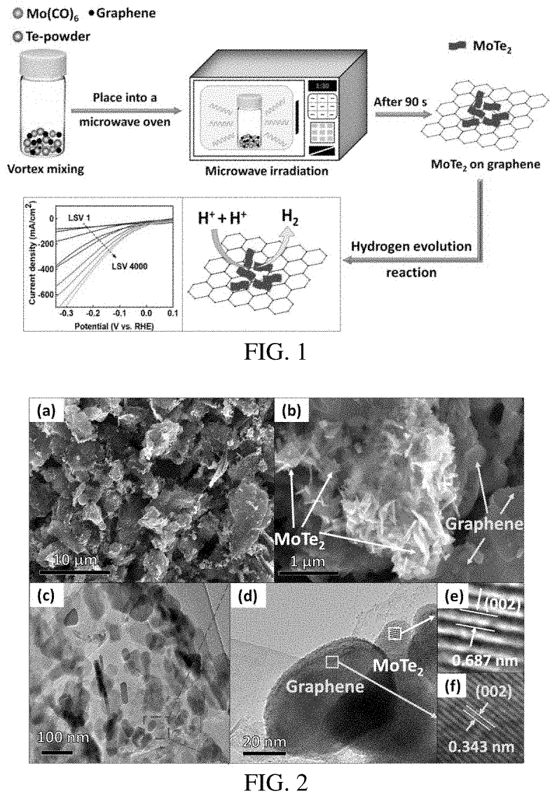

Transition metal dichalcogenides (TMDs) are considered as promising catalysts for hydrogen evolution in acidic media. Among them, MoS₂ and MoSe₂ have emerged with remarkable HER catalytic activities, whereas very few reports have emerged on MoTe₂ as electrocatalyst, even though they have higher electronic conductivity, better electrical properties along with semi-metallic nature. However, the controlled high-yield production of MoTe₂ nanosheets is more challenging than MoS₂ or MoSe₂ because of a small electronegativity difference between Mo and Te (0.3 eV) atoms. To date, several synthesis methods, such as chemical vapor deposition (CVD), top-down exfoliation method, and annealing technology have been proposed for the preparation of MoTe₂. These approaches generally require high-temperature, high-pressure, heat-treatment, high-energy, and long reaction time. In present work, we have synthesized MoTe₂ nanosheets on graphene substrate through microwave-irradiation, which is a facile, ultra-fast, energy-efficient and scalable approach. A similar method was applied to develop MoS₂/graphene-catalyst. During this process, graphene plays an important role that absorbs the microwave energy to convert it to heat energy, along with improving the electrical and mechanical properties of as-produced MoTe₂/graphene composite. A brief overview of this study is shown in schematic form in FIG. 1.

In parallel with the experimental strategy, atomistic simulations have been carried out with periodic plane-wave DFT to probe the surface-electrochemistry of hydrogen adsorption (more specifically chemisorption, also known as binding). Major descriptors to evaluate the catalytic performance, adsorption and free energies, for which experimental measurement is not very accessible, have been calculated with DFT and generally with statistical thermodynamics. Theoretically calculated adsorption free energies indicate Mo edge and Mo corner as the most favorable sites of MoTe₂/graphene composite for HER catalysis. The most prominent graphical representation of Sabatier's Principle is the volcano plot, which reveals the position of MoTe₂/graphene nanocomposite near the peak, almost with similar height of Pt, and considerably above MoS₂. The combination of active MoTe₂-catalyst with extremely strong and conductive graphene support enhances the properties of the individual components and thereby exhibits higher performance for HER, which illustrates the future potential commercialization of MoTe₂/graphene for practical applications.

The surface morphology and microstructures of MoTe₂/graphene were investigated by scanning electron microscopy (SEM) and transmission electron microscopy (TEM) analyses. FIGS. 2a and 2b exhibit the growth of MoTe₂ nanosheets embedded with graphene flakes, that reveals the coalescing or overlapping of graphene sheets forming an interconnected conducting network, which is very important for the less-conducting MoTe₂ to facilitate the rapid electronic transport and to provide enough mechanical strength. As shown in FIG. 2c, MoTe₂ nanosheets demonstrate corrugated layers in the low-magnification TEM image, while high-magnification HR-TEM image (FIG. 2d) prominently displays the difference between graphene and MoTe₂ nanosheets by their well-resolved lattice fringes with separate interplanar spacings. FIG. 2e shows the few-layered structure of MoTe₂ with an interlayer distance of 6.87 Å, where the graphene displays distinctive interlayer spacing of 3.43 Å (FIG. 2f). Other material characterizations (e.g., EDS, XRD, Raman and XPS studies) have also been performed (FIGS. 8-10), that indicate the successful synthesis of MoTe₂ nanosheets on graphene substrate. These results also indicate a chance of MoOₓ (mixture of MoO₂ and MoO₃) existence in as-produced MoTe₂/graphene composite. Therefore, MoOₓ/graphene sample has been prepared by microwave synthesis approach to investigate its electrochemical properties as well.

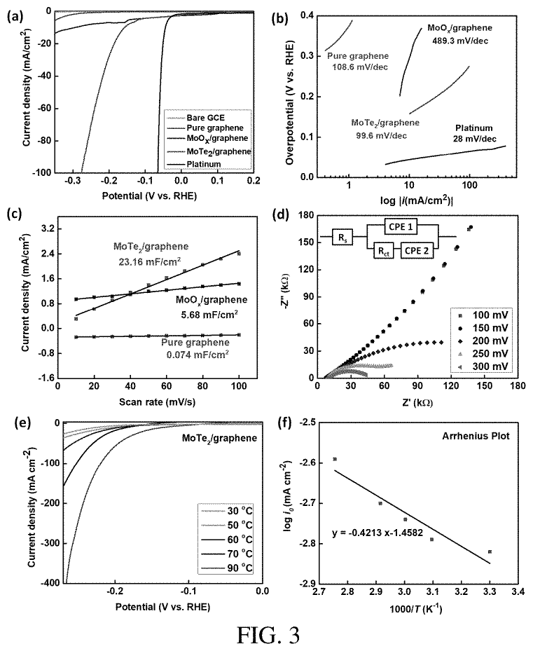

The electrocatalytic HER activities of MoTe₂/graphene in 0.5 M H₂SO₄ solution have been investigated by linear sweep voltammetry (LSV) at room temperature, with a scan rate of 1 mV s⁻¹ using a typical three-electrode setup. Bare GCE, pure graphene, MoOₓ/graphene, and commercial Pt catalyst were also studied under the same conditions for comparison (FIG. 3a). All the major electrochemical parameters are shown in Table 1, where the overpotentials (η) for Pt and MoTe₂/graphene to reach the current density of 10 mA cm⁻² are 53 and 150 mV, respectively. In contrast, MoOₓ/graphene displays trivial HER catalytic activities, while bare GCE and graphene have no catalytic activity (FIG. 3a). The LSV of MoOₓ/graphene exhibits capacitive current (the offset from 0 mA cm⁻²) due to the reduction of oxide layers. A similar trend can be observed for MoTe₂/graphene catalyst, since there was a small amount of MoOₓ present in MoTe₂/graphene composite. To further demonstrate the HER activities, Tafel plots were derived from LSVs by fitting the linear regions to Tafel equation (η=b log i+a; where η is the overpotential, b is the Tafel slope, i is the current density and a is a constant). Theoretically, HER mechanism consists of three principal steps (Volmer, Heyrovsky, and Tafel), which can elucidate electron transfer kinetics of the catalysts. The overall HER reaction proceeds through a discharge step with a Tafel slope around 120 mV/decade, followed by either a desorption step or recombination step, with the Tafel slopes around 40 mV/decade and 30 mV/decade, respectively. In this study, MoTe₂/graphene exhibits the Tafel slope of 99.6 mV per decade (FIG. 3b), indicating that the Volmer-Heyrovsky reaction mechanism dominates in the HER process of MoTe₂/graphene catalyst. In addition, the exchange current density (i₀) is proportional to the active surface area of catalyst materials, which can be attained by an extrapolation method (FIG. 11) from Tafel plots. As shown in Table 1, the i₀ of MoTe₂/graphene catalyst is 1.585 mA cm⁻², which is very close to the i₀ of commercial Pt (3.162 mA cm⁻²).

TABLE 1
Electrochemical parameters of MoTe₂/graphene nanocomposite,
comparing with commercial platinum (Pt), as-produced MoOₓ/
graphene, and pure graphene samples.

| | Onset | Over | | Exchange |
|---|---|---|---|---|
| | potential, η₀ | potential, η₁₀ | Tafel slope | current |
| | [mV vs. | [mV vs. | [mV/ | density, |
| Samples | RHE] | RHE] | decade] | i₀ (mA cm⁻²) |
| Platinum | 45 | 53 | 28 | 3.162 |
| MoTe₂/graphene | 100 | 150 | 99.6 | 1.585 |
| MoOₓ/graphene | 201 | 365 | 489.3 | — |
| Pure graphene | 204 | 374 | 108.6 | — |

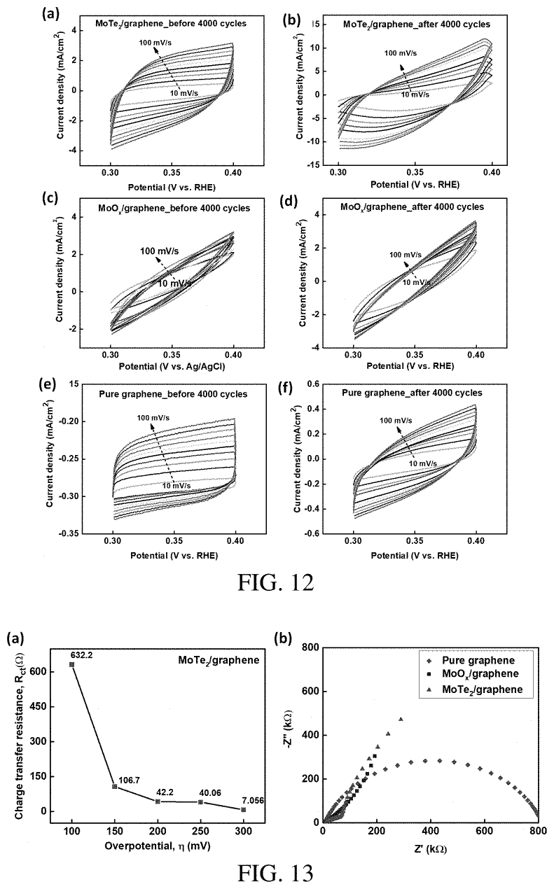

These results indicate the presence of higher active sites inside MoTe₂/graphene-catalyst, enhancing the HER activities. This speculation was further confirmed by the measuring the electrochemical double-layer capacitance (C_{d1}) at solid-liquid interface of electrode and electrolyte, another approach to estimate the electrochemically active surface area (ECSA) that gives an estimation of active reaction sites. To determine C_{d1} values, CV measurements were conducted for MoTe₂/graphene, MoOₓ/graphene and pure graphene within a potential range (0.3-0.4 V vs. RHE) with no apparent faradaic reaction taking place (FIG. 12), where the currents are mainly attributed to the charging of the double layer. The double-layer charging current (i_{c}) can be calculated by the equation: i_{c}=νC_{d1}, where ν is the scan rate. FIG. 3c shows the capacitance of MoTe₂/graphene is 23.16 mF cm⁻², whereas those of MoOₓ/graphene and pure graphene are 5.68 and 0.074 mF cm⁻², respectively. This higher value of C_{d1} of MoTe₂/graphene further facilitates high catalytic performance.

A comparison of previously reported onset potentials (η₀) and Tafel slopes of molybdenum (Mo—) based compounds with MoTe₂/graphene composite is shown in Table 2. In contrast with facile, ultra-fast (90 sec) microwave-initiated synthesis performed in this study, previously reported Mo-compounds were synthesized by different complex approaches.

TABLE 2
Comparison of electrochemical activities of microwave-synthesized
MoTe₂/graphene with previously reported similar Mo-based compounds.

| | | | Onset | | |
|---|---|---|---|---|---|
| | Synthesis | | potential | Tafel slope | |
| Materials | approach | Electrolyte | [mV vs. RHE] | [mV per decade] | References |
| MoTe₂- | solvothermal, | 0.5M PBS | 200 | 128 | Electrochim. |
| RGO/PI/Mo | electrochemical- | | | | Acta, 2017, |
| | deposition | | | | 229, 121-128 |
| 1T′-MoTe₂ | annealing | 1M H₂SO₄ | 300 | 78 | Energy Technol., |
| | | | | | 2018, 6, 345-350 |
| MoS₂/RGO | solvothermal | 0.5M | 100 | 41 | J. Am. Chem. Soc., |
| | | H₂SO₄ | | | 2011, 133, |
| | | | | | 7296-7299 |
| Porous MoSe₂ | liquid | 0.5M | 75 | 80 | Phys. Chem. |
| | exfoliation | H₂SO₄ | | | Chem. Phys., |
| | | | | | 2016, 18, 70-74 |
| MoTe₂/10%- | liquid | 0.5M | ~250 | ~86 | Nanoscale, |
| SWNT | exfoliation | H₂SO₄ | | | 2016, 8, |
| | | | | | 5737-5749 |
| MoS₂/graphene | microwave | 0.5M | 100 | 43.3 | Sci. CHINA |
| | irradiation | H₂SO₄ | | | Mater., 2019, 1-13 |
| | | | | | (previous study |
| | | | | | of our group) |
| MoTe₂/graphene | microwave | 0.5M | 100 | 99.6 | present |
| | irradiation | H₂SO₄ | | | study |

Moreover, it is clear that the present material exhibits low onset potential and a small Tafel slope that are comparable with other similar compounds. While neither desiring to be bound by any particular theory nor intending to limit in any measure the scope of the appended claims or their equivalents, it is presently believed that the improved electrocatalytic activity of MoTe₂/graphene may be attributed to strong chemical and electronic coupling between MoTe₂ nanosheets and graphene network, resulting in fast electronic kinetics between the catalyst and electrode surface. This hypothesis was further confirmed by electrochemical impedance spectroscopy (EIS) measurements in 0.5 M H₂SO₄. FIG. 3d represents the Nyquist plots of MoTe₂/graphene catalyst at various overpotentials of 50-300 mV. In the high frequency zone, the MoTe₂/graphene exhibits one capacitive semicircle, indicating that the reaction is kinetically controlled. In this system, R_{ct} decreases significantly with increasing overpotentials, from 632.2Ω at 100 mV to only 7.056Ω at 300 mV (FIG. 13-a). Lower charge-transfer resistance (R_{ct}) demonstrates the superior electrocatalytic activity at higher overpotential. The electrical equivalent circuit diagram shown in the inset of FIG. 3d was used to model the solid liquid interface. Here, the constant phase element, CPE 1 is associated to electrical double layer formed at electrode/electrolyte interface of MoTe₂/graphene catalyst and CPE 2 is corresponded to pseudocapacitance behavior. Though the solution resistance (Rₛ) for all the samples are close to 7Ω, but MoTe₂/graphene shows lower charge transfer resistance (R_{ct}) of 106.7Ω than the values of MoOₓ/graphene and pure graphene samples (FIG. 13b). Hence, much faster electron transfer between the catalytic edge sites of MoTe₂/graphene and the electrode surface is one of the key factors contributing to the superior HER kinetics. All the important EIS parameters obtained after z-fit analysis are shown in Table 4.

TABLE 3
Impedance parameters derived by fitting the EIS responses of
MoTe₂/graphene, MoOₓ/graphene and pure graphene
samples at an overpotential of 150 mV in 0.5M H₂SO₄.

| Samples | Rₛ (ohm) | R_{ct} (ohm) | CPE 1 (F s⁻¹) | CPE 2 (F s⁻¹) |
|---|---|---|---|---|
| MoTe₂/graphene | 6.94 | 106.7 | 1.836 × 10⁻³ | 1.939 × 10⁻³ |
| MoOₓ/graphene | 7.02 | 266.6 | 1.08 × 10⁻² | 1.51 × 10⁻³ |
| Pure graphene | 6.96 | 806.7 | 1.48 × 10⁶ | 3.76 × 10⁻⁵ |

TABLE 4
HER parameters of MoTe₂/graphene-
catalyst at a temperature range of 30-90° C.

| | | Exchange current | Activation |
|---|---|---|---|
| Temperature, | Onset potential, | density, | energy, |
| T (° C.) | η₀ (mV vs RHE) | i₀ (mA cm⁻²) | Ea (kJ mol⁻¹) |
| 30 | 98.2 | 1.51356 | 8.067 |
| 50 | 96.4 | 1.62181 | |
| 60 | 85.5 | 1.8197 | |
| 70 | 82.9 | 1.99526 | |
| 90 | 80.1 | 2.5704 | |

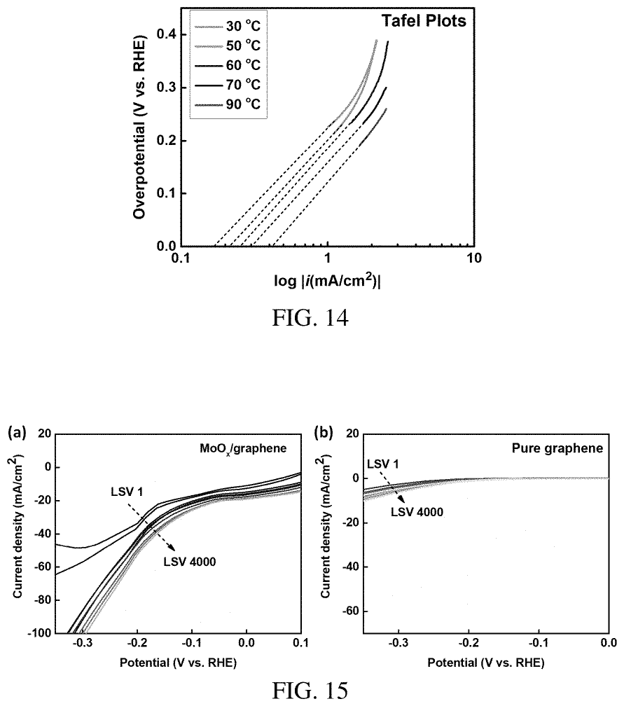

Furthermore, HER activity of as-produced MoTe₂/graphene catalyst was measured by obtaining the LSVs at a temperature range from 30° C. to 90° C. (FIG. 3e). In addition, exchange current densities (i₀) were measured from corresponding Tafel slopes, which is shown in FIG. 14 and the electrochemical parameters (η₀ and i₀) are tabulated in Table 4. The improvement in HER activities are clearly observed with the increase in temperature by decreasing the onset potentials and increasing exchange current densities. Based on the Arrhenius equation

$$( k = A {e}^{\frac{- {E}_{a}}{R T}} ) ,$$

activation energy (Eₐ) can be calculated by using the equation:

$$log ( {i}_{0} ) = log ( A ) - \frac{{E}_{a}}{2.3 RT} .$$

Where, A is the pre-exponential factor, R is universal gas constant (8.314 J/mol·K) and T is absolute temperature (K). Plot of the log i₀ as a function of

$$\frac{1000}{T}$$

is shown in FIG. 3f. From the slope of the Arrhenius plot, Eₐ was calculated to be 8.067 kJ mol⁻¹ for MoTe₂/graphene-catalyst. This lower activation energy is better than the Pt catalyst (20-40 kJ mol⁻¹), which may lead towards the higher catalytic activity of MoTe₂/graphene.

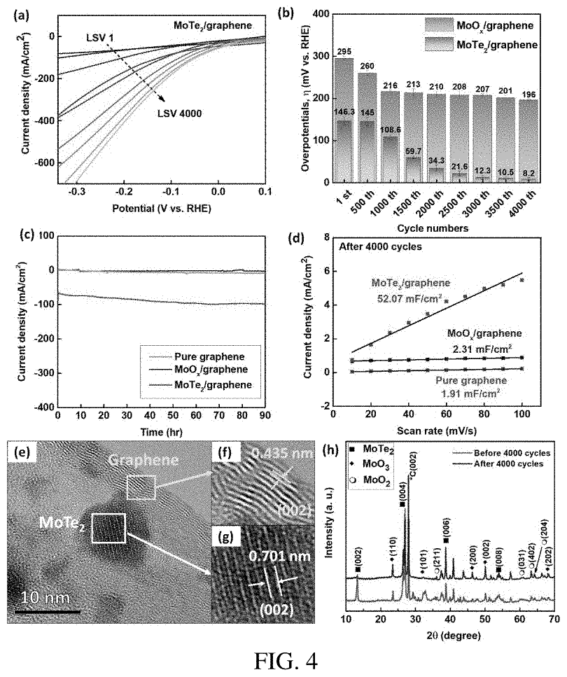

Besides high catalytic activities, another key parameter is the good stability of materials towards HER for practical applications. To investigate the durability in an acidic environment, long-term stability of MoTe₂/graphene was tested using the cyclic voltammetry (CV) technique from 0 to −350 mV vs. RHE scanning for 4000 cycles at a scan rate of 50 mV s⁻¹ (FIG. 4a). Remarkably, the catalytic performance of MoTe₂/graphene nanocomposite enhances with the potential cycling by reaching the overpotential value of only 8.2 mV after 4000 cycles (FIG. 4b), which is even better than the overpotential (53 mV) of Pt catalyst. To avoid the confusion in presence of capacitive currents, the overpotentials were measured at the current density of −50 mA cm⁻². Similar improvement in the catalytic performance of metal dichalcogenides by electrochemical cycling had been reported in some previous works, as well for our work on MoS₂/graphene catalyst. While neither desiring to be bound by any particular theory nor intending to limit in any measure the scope of the appended claims or their equivalents, it is presently believed that this improved catalytic performance during the potential cycling is due to catalytic activation by proton intercalation in MoTe₂-layers and graphene layers. Another reason could be the self-optimizing morphological changes by perforation of H₂ bubbles, generating thinner and more porous catalyst materials. Cycling stability tests were also ran for MoOₓ/graphene and pure graphene (FIG. 15). FIG. 4b clearly shows that the MoTe₂/graphene achieves the best catalytic behavior from cycling stability tests. Furthermore, the practical operation of as-obtained MoTe₂/graphene catalyst was observed by electrolysis at constant potential of 150 mV vs. RHE for 90 hours (FIG. 4c), where the MoTe₂/graphene catalyst shows a stable increase in current density from −65 to −100 mA cm⁻². This increase supports the hypothesis of catalytic activation detected during the cycling stability.

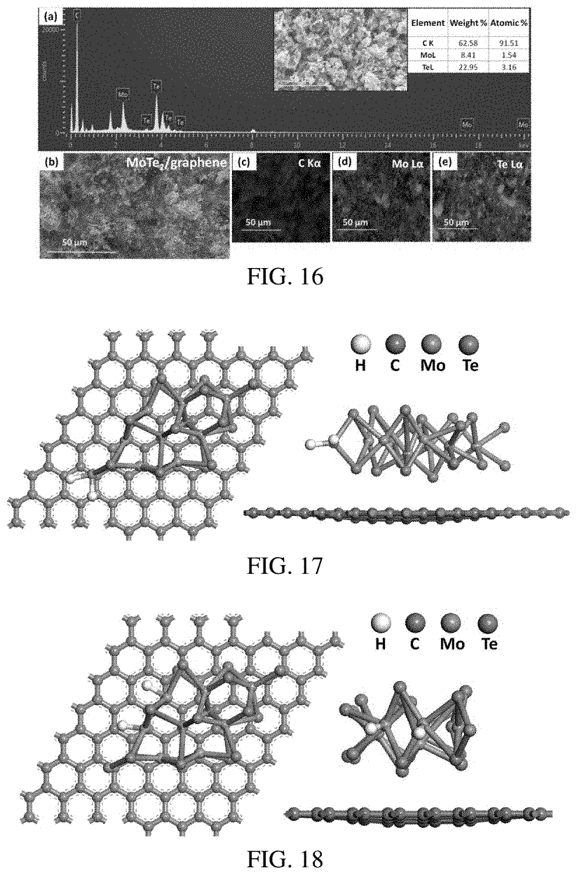

Moreover, the G_{d1} measurements (FIG. 4d) after 4000 cycles show an increase from 23.16 to 52.07 mF cm⁻² for MoTe₂/graphene, substantiating the increase in ECSA during the cycling activation process. In comparison, while pure graphene shows slight increase in G_{d1} from 0.074 to 1.91 mF cm⁻², MoOₓ/graphene displays a decrease in G_{d1} from 5.68 to 2.31 mF cm⁻². Furthermore, the change in elemental compositions and morphologies of MoTe₂/graphene composite after 4000 CV cycles was examined by SEM, TEM and EDS analyses. FIG. 16 clearly shows an insignificant degradation of active material even after 4000 cycles, maintaining the similar atomic ratio of Mo:Te 1:2. As displayed in FIG. 4e, the nanosheet structures are well preserved because of the MoTe₂ nanosheets uniformly enfolded with graphene layers. Therefore, the presence of a large amount of graphene substrate sharply enhances the structural stability of MoTe₂ nanosheets during the HER. Moreover, from HR-TEM images (FIGS. 4f and 4g), there is an increase shown in interlayer spacing of MoTe₂ and graphene nanosheets, from 6.87 Å to 7.01 Å and 3.43 Å to 4.35 Å, respectively. Moreover, from ex-situ XRD analysis after 4000 cycles (FIG. 4h), the disappearance of MoTe₂ diffraction peak (002) confirms the hydrogen ion insertion in between MoTe₂ layers. These phenomena strongly support the hypothesis of H⁺ intercalation taking place during the cycling stability test, resulting a slight expansion between lattice fringes, therefore, subsequently improving the catalytic activity by providing more active sites in MoTe₂/graphene composite.

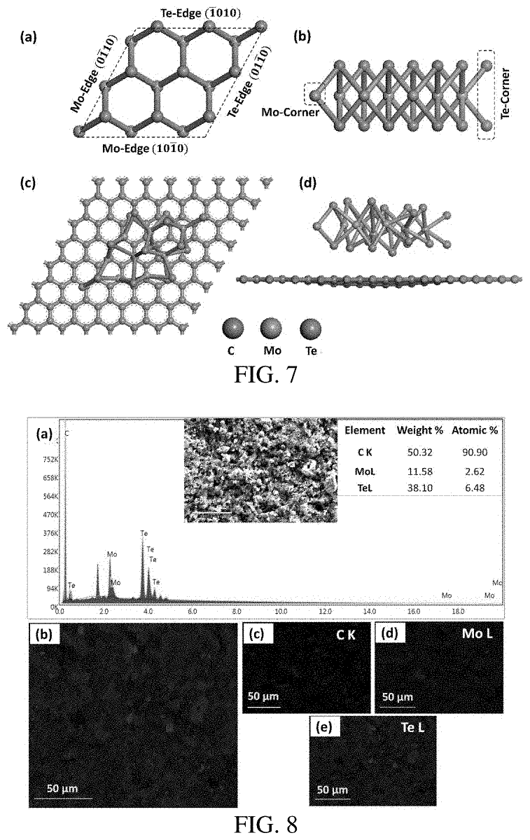

For the computational study, multiple hydrogen adsorption sites on the Mo₉Te₁₈ nanoparticle were investigated for the hydrogen adsorption process (FIGS. 7 and 17-23). For each of these sites, adsorption energy has been calculated for the Tafel reaction (Table 5). The adsorption energy of a single H atom on the graphene supported Mo₉Te₁₈ nanoparticle was calculated using the equation: ΔE_{adsorption}=½(E_{2H*+MoTe}_{₂}_{/graphene}−E_{MoTe}_{₂}_{/graphene}−E_{H}_{₂}). Here, E_{2H*+MoTe}_{₂}_{/graphene} is the total electronic energy of the two hydrogen atoms bound to the Mo₉Te₁₈ nanoparticle-graphene composite, E_{MoTe}_{₂}_{/graphene} is the total electronic energy of Mo₉Te₁₈ nanoparticle-graphene composite, and E_{H}_{₂} is the electronic energy of hydrogen molecule placed in a 17.2 Å×17.2 Å×20.0 Å vacuum hexagonal unit cell. These adsorption energies were calculated to determine the best active catalytic sites on the MoTe₂/graphene nanocomposite catalyst responsible for HER activity.

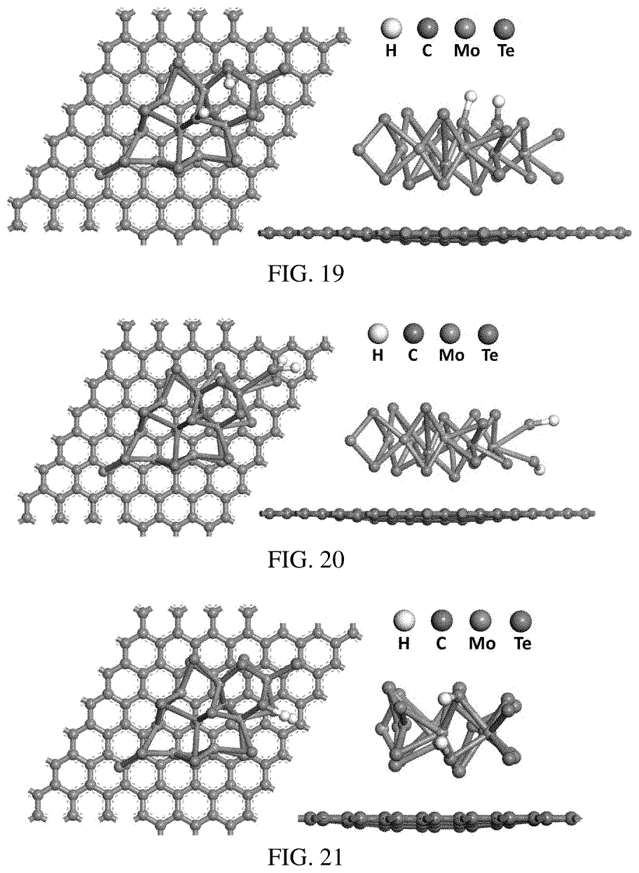

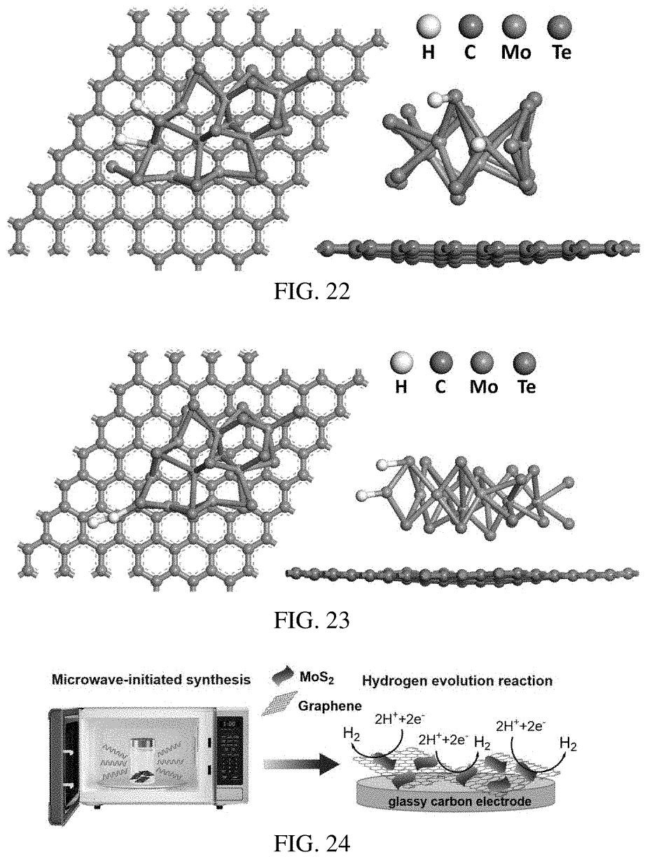

TABLE 5
Adsorption energies (ΔE_{adsorption} and ΔG_{adsorption}) of hydrogen atoms on
a number of adsorption sites of MoTe₂/graphene composite.

| | Adsorption sites | ΔE_{adsorption} (eV) | ΔG_{adsorption} (eV) |
|---|---|---|---|
| 1 | Mo corner (FIG. 17) | −0.50734 | −0.26734 |
| 2 | Mo edge (FIG. 18) | 0.186131 | 0.426131 |
| 3 | Te top surface (0001) | 1.082631 | 1.322631 |
| | (FIG. 19) | | |
| 4 | Te corner (FIG. 20) | 0.818231 | 1.058231 |
| 5 | Te edge (FIG. 21) | 0.583431 | 0.823431 |
| 6 | Mo edge-Te edge (FIG. 22) | −0.14282 | 0.097181 |
| 7 | Mo corner-Te edge (FIG. 23) | 0.140281 | 0.380281 |

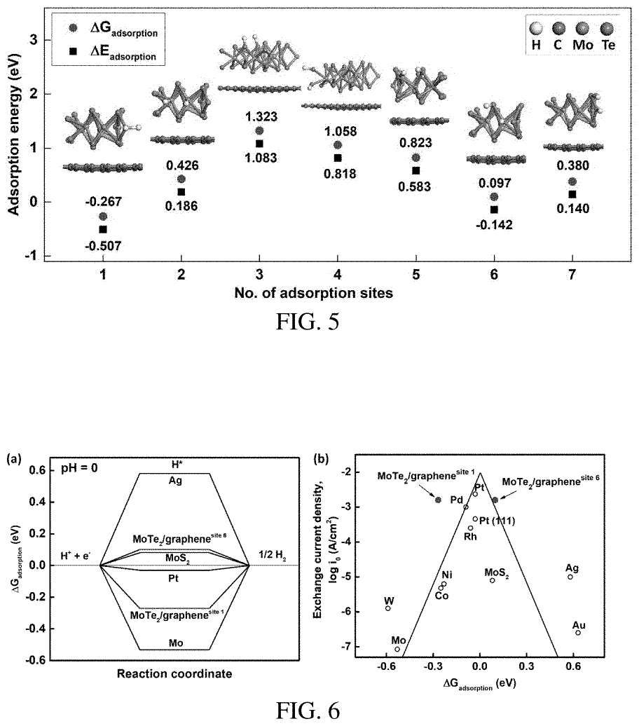

To illustrate the Sabatier's principle as applied to HER activity, a more suitable descriptor to represent activity on a volcano plot for the Tafel reaction is the binding free energy (ΔG_{adsorption}) instead of binding electronic energy alone (ΔE_{adsorption}). Binding free energy has been calculated using the generalized expression for HER catalysis developed by Nørskov and co-workers in the following equation: ΔG_{adsorption}=ΔE_{adsorption}+0.24 eV. As shown in FIG. 5, among the hydrogen adsorption sites considered, the exposed Mo corner (site 1) and the Mo edge adjacent to Te edge (site 6) on Mo₉Te₁₈ nanoparticle exhibited the lowest ΔE_{adsorption} values, −0.507 and −0.142 eV, respectively. These results suggest the sites on the representative Mo edge (101̅0) (FIG. 7-a) likely contribute to the high reaction rates observed for HER catalysis. The absolute free energy values, |ΔG_{adsorption}| of 0.267 and 0.097 eV also indicate the same conclusion. Thus, the optimal catalytic active site for hydrogen evolution is the bridge site between the Mo and Te atoms on the representative Mo edge (101̅0). The ΔG_{adsorption} values were illustrated in an energy diagram (FIG. 6a) to compare the results of the catalytically active MoTe₂/graphene composite sites (namely, site 1 and site 6) with other HER catalysts. Moreover, using the calculated binding free energy (ΔG_{adsorption}) for these sites and the experimental value of exchange current density (i₀), the points for the MoTe₂/graphene nanocomposite on the volcano plot (FIG. 6b) were found nearly thermoneutral, approaching towards the high-performing metals such as Pt.

In summary, MoTe₂ nanosheets uniformly dispersed on graphene substrate have been synthesized by microwave-initiated heating method and their practical application in hydrogen evolution reactions, along with theoretical studies to identify the most active sites of resultant MoTe₂/graphene nanocomposite, have been explored. The physicochemical characterizations (e.g., SEM, EDS, XRD, etc.) verified that the as-produced MoTe₂ nanosheets were well anchored on graphene substrate, revealing the effectiveness of our ultra-fast (90 sec) synthesis method. Along with being the microwave absorber, graphene facilitates both electronic and ionic transports as well as improving the mechanical strength, further accelerating the electrocatalytic reaction. The resultant MoTe₂/graphene catalyst showed excellent electrocatalytic performance toward HER, with a small onset potential of 100 mV, large cathodic currents, and a Tafel slope of 99.6 mV per decade. More importantly, the hybrid composite demonstrated a significantly enhanced cycling performance, exhibiting better catalytic activity after 4000 cycles with an overpotential of only 8.2 mV. In addition, the MoTe₂/graphene composite showed remarkable stability even at high operating temperatures up to 90° C. with a very low activation energy of 8.067 kJ mol⁻¹. The computational results clearly demonstrated the correlation between the hydrogen chemisorption free energies and the exchange current densities for HER, identifying most active sites on the synthesized catalyst structures. The volcano plot indicated that graphene supported MoTe₂ is a promising electrocatalyst as compared to other metals, because the hydrogen evolution reaction is near thermoneutral on MoTe₂/graphene and, similar to Pt at the equilibrium potential.

### Microwave-Initiated Synthesis of MoS₂/Graphene-Catalyst for Enhanced Hydrogen Evolution Reaction

Intensive research on two-dimensional molybdenum disulfides (MoS₂) have been conducted due to their remarkable catalytic properties. However, most of the existing synthesis approaches are time-consuming, complicated, and inefficient. The present work successfully demonstrates the production of MoS₂/graphene catalyst through an ultra-fast (60 seconds) microwave-initiated approach. During the synthesis process, graphene plays a vital role by absorbing microwave energy and converting it to heat energy, which facilitates the precursors to react vigorously. Moreover, high specific surface area and conductivity of graphene delivers a favorable conductive network for the growth of MoS₂ nanosheets, along with rapid charge transfer kinetics. As produced, MoS₂/graphene nanocomposite exhibits superior electrocatalytic activity for the HER in acidic medium, with a low onset potential of only 100 mV, large cathodic currents and a Tafel slope of 43.3 mV per decade, suggesting the Volmer-Heyrovsky mechanism of hydrogen evolution. Beyond excellent catalytic activity, MoS₂/graphene reveals an unusual ability to enhance the accessible active sites during the HER proceeds. This leads to a long cycling stability with a very high cathodic current density of around 1000 mA cm⁻² at an overpotential of 250 mV, providing the opportunity of practical application for scalable processing.

Because of present climate issues and the deterioration of existing natural resources, the energy dependency on fossil fuels is becoming problematic. To resolve this energy crisis, hydrogen is considered to be a promising energy carrier for clean and sustainable energy technologies, especially for the intermittent renewable resources such as solar, hydro or wind energy. Though water electrolysis is solely the green approach to generate hydrogen energy, large-scale hydrogen production through photo/electrolysis is still very challenging due to the lack of energy-efficient and cost-effective techniques. The electrolysis process requires advanced electrocatalyst to reduce the overpotential and to accelerate the kinetically rate-limiting steps involved within reductive half reaction of water splitting, known as the hydrogen evolution reaction (HER, i.e., 2H⁺+2e⁻→H₂). To date, platinum (Pt) and its composites are known to be the most effective HER electrocatalysts in acidic media. However, the high cost and low earth abundance of these materials severely hinder their use for commercial applications. Nonprecious catalysts, which are made from earth-abundant elements, are therefore desirable for a large-scale implementation as HER catalysts. To develop cost-effective alternatives to Pt, intense research is being conducted for hydrogen production through photo/electrocatalytic method. Such alternatives typically include nickel or nickel-based materials, which operate in alkaline electrolytes. Nevertheless, HER generally requires acidic conditions and the long-term stability of low-cost catalysts needs to be improved in acidic electrolytes.

Inspired by the HER mechanisms of natural catalysts, such as hydrogenase and nitrogenase enzymes, metal chalcogenides (MCs) containing non-noble metals (e.g., Mo, W or Co) have been designed to catalyze the electrochemical production of hydrogen. Among all the MCs, molybdenum disulfide (MoS₂) and its compounds have recently emerged as a very promising class of nonprecious, earth-abundant HER catalyst with high catalytic activity and good stability in acidic electrolytes. In comparison to bulk MoS₂, nanocrystallized MoS₂ has been identified as a promising catalyst due to exposing more active edges in nanostructured forms. Recently, extensive effort has been devoted to improve the HER catalytic activity of MoS₂ by identifying and exposing active sites, as well as by enhancing electron transport through nanostructuring, shape controlling, phase engineering, doping, intercalation, hybridization, and so on. Besides morphology, the electrical conductivity is another key factor that influence electrocatalytic efficiency of HER catalysts. Taking these factors into account, carbon materials such as conducting polymers, graphene, reduced graphene oxide (r-GO), carbon nanotubes (CNTs), etc. are considered as ideal supports to improve the electrocatalytic activity because of their unique properties. The honeycomb graphene structure, which consists of extended two-dimensional sheets of sp²-bonded carbon atoms, shows superior properties such as fast mobility of charge carriers, high electrical conductivity and exceptionally large specific surface area. Therefore, various forms of graphene have been investigated as a potential conducting support for MoS₂ catalyst to demonstrate high HER electrocatalytic activity.

To synthesize these hybrid materials, most of the approaches require complex equipment setups, long processing time, high-energy consumption, along with safety, scalability and cost issues which could limit the range of potential applications. Several examples involve the use of toxic gases along with calcination under H₂/Ar atmosphere, long-time heating of precursor materials, complex lyophilization dehydration process, cumbersome electro-deposition which requires advanced care, and so on. In this regard, microwave-initiated manufacturing can become a promising approach to develop efficient MoS₂/graphene-catalyst for HER. The application of microwave approach in synthetic chemistry is a fast-growing research area due to its potential advantages including rapid volumetric heating, higher reaction rate, high selectivity, reduced reaction time, and/or increased yields of products compared to conventional heating methods. Successful synthesis of MCs by a microwave-initiated approach may be used for the highly efficient production of different hybrid compounds.

In this work, the direct growth of a nanocomposite of MoS₂ on graphene substrate via a facile, scalable and efficient microwave-initiated approach was demonstrated (FIG. 24) in follow up to our earlier work to synthesize MCs on polypyrrole nanofiber substrate. This technique represents a clean, ultrafast (e.g., 60 seconds) synthetic approach using microwave heating without any inert gas protection or use of intense facilities. More importantly, graphene exhibits a strong interaction with microwaves making it an efficient susceptor to achieve microwave heating rapidly and uniformly. During the reaction, the strong interaction between substrate material and microwave-irradiation takes place to achieve fast thermal decomposition of molybdenum-containing precursor to synthesize uniformly dispersed MoS₂/graphene nanocomposites. Benefiting from the synergistic effects of MoS₂ catalyst and graphene, this MoS₂/graphene nanocomposite has been demonstrated to be an active non-precious metal-based catalyst for electrochemical hydrogen evolution reaction. As-produced MoS₂/graphene-catalyst exhibited low overpotential, small Tafel slope with a very high cathodic current density, along with fascinating cycling activation behavior and high stability under acidic condition, even at high operating temperatures (30-120° C.).

As-produced MoS₂/graphene composite was analyzed by physical characterizations to confirm the successful synthesis of MoS₂ nanosheets on graphene substrate, as well as for morphologies and microstructural analyses. Furthermore, several electrochemical characterizations were performed to obtain the enhanced catalytic activities of MoS₂/graphene toward HER.

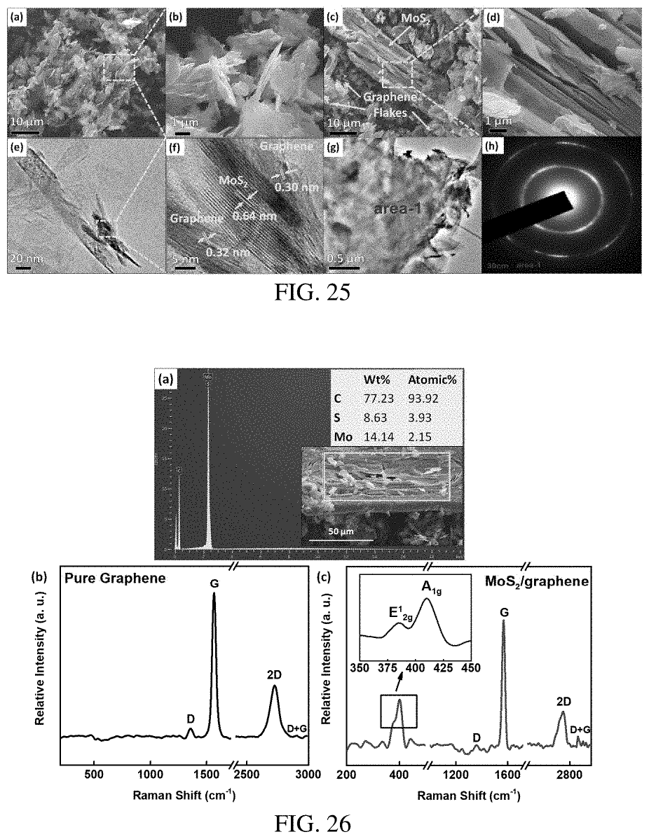

The surface morphologies of pure graphene and MoS₂/graphene were investigated by SEM analysis. As shown in FIGS. 25a and 25b, thick flake-like structures were observed for graphene. Whereas after microwave-initiated synthesis, the growth of MoS₂ layers (FIGS. 25c and 25d) was exhibited embedding with graphene flakes, substantiating the successful synthesis of MoS₂/graphene nanocomposite. High-resolution transmission electron microscopy (HRTEM) imaging was performed to examine the microstructure and crystallinity of MoS₂/graphene nanocomposite. FIG. 25e exhibited the HRTEM image of MoS₂/graphene, while high-magnification HRTEM image (FIG. 25f) prominently displayed the difference between graphene and MoS₂ nanosheets. The MoS₂ exhibited the few-layered structure with an interlayer distance of 6.4 Å, where the edge of the layers of 2D nanosheets were shown in white lines. MoS₂ nanosheets demonstrated the corrugated layers in the low-magnification TEM image, as shown in FIG. 25g. In addition, the SAED patterns of corresponding area (marked as “area 1” in FIGS. 25g and 25h) displayed broad and hazy diffraction rings, which indicates low crystallization of MoS₂ on crystal graphene surface.

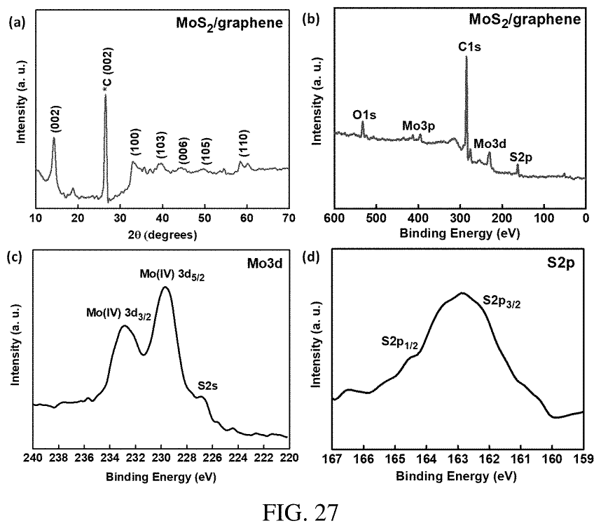

The EDS results revealed (FIG. 26a) that the nanosheets were primarily composed of molybdenum (Mo) and sulfur (S). Additionally, a huge amount (˜80 wt %) of carbon (C) content was found due to the presence of graphene substrate. The atomic ratio of Mo and S components was very close to 1:2, which satisfied the formula of MoS₂ (S—Mo—S), confirming the formation of MoS₂ in as-produced nanocomposites. Furthermore, Raman spectra of pure graphene and MoS₂/graphene were shown in FIGS. 26b and 26c. The characteristic Raman peaks for graphene (D, G and 2D bands) were clearly observed and from the MoS₂/graphene peaks it was revealed that the composite was crystalline 2H—MoS₂, which was confirmed by the Raman peaks located at 384.9 cm⁻¹ (in-plane E¹_{2g} mode) and 409.3 cm⁻¹ (out-of-plane Δ_{1g} mode). Previously, it has been reported that the energy difference between two Raman peaks (A) can be used to detect the number of MoS₂ layers. In this work, A is about 24.4 cm⁻¹, indicating the existence of the five to six layered MoS₂ nanosheets.

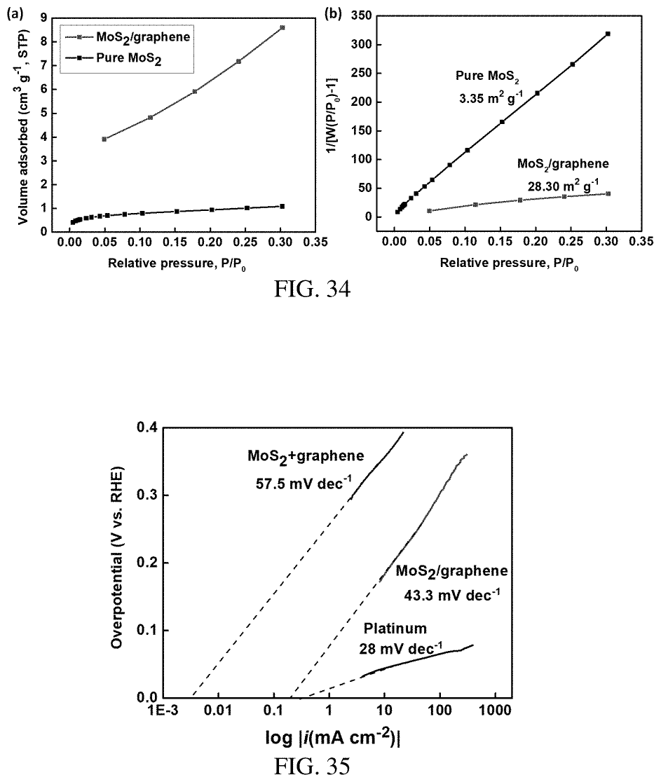

Furthermore, X-ray diffraction (XRD) and X-ray photoelectron spectroscopy (XPS) analyses were performed to identify the formation of crystalline MoS₂ nanosheets. The XRD pattern of the MoS₂ (FIG. 27a) displayed diffraction peaks in the range from 10° to 70°. The peaks appeared at 14.2°, 33.5°, 39.8°, 43.1°, 49.1° and 59.3° were corresponding to (002), (100), (103), (006), (105) and (110) planes, respectively. The patterns can be indexed to the standard hexagonal 2H—MoS₂ structure (JPCDS no. 37-1492), indicating that after reacting under microwave irradiation Mo-precursor with CS₂ solution completely reduced to MoS₂. Since, graphene possessed almost 80 wt. % in MoS₂/graphene composite, it displayed a peak at ˜26° with high intensity as a reflection from carbon layers (002). X-ray photoelectron spectroscopy (XPS) was analyzed to further confirm the microwave reduction of Mo(VI) in (NH₄)₂MoS₄ precursor to Mo(IV) in MoS₂. The survey spectrum was represented in FIG. 27b for MoS₂/graphene, and the peaks for C, Mo, S, and O elements were observed, indicating the presence of MoS₂ and graphene in the hybrid nanocomposite. The high-resolution XPS spectrum for Mo 3d (FIG. 27c) showed the binding energies of Mo 3d5/2 and Mo 3d3/2 peaks at 229.4 and 232.7 eV, respectively, which were matched with typical values for Mo (IV) in MoS₂. The peaks at 162.1 eV and 164.2 eV in FIG. 27d were attributed to 2p1/2 and 2p2/3 of S²⁻. The binding energies observed from this study were close to the previously reported values for MoS₂, which further signified the formation of MoS₂ in as-produced nanocomposite. In addition, the Brunauer-Emmett-Teller (BET) analyses were performed to measure the specific surface areas of pure MoS₂, and MoS₂/graphene nanocomposite, which were found 3.35 and 28.30 m² g⁻¹ (FIGS. 34a and 34b), respectively. Comparing the BET values of pure MoS₂ and MoS₂/graphene nanocomposite, it was shown that graphene support clearly increased the surface area in nanocomposite form. Moreover, to get the better catalytic activities for hydrogen evolution reaction (HER), higher surface areas are preferred which can maximize the number of possible reaction sites while minimizing the total volume of the catalyst.

HER Activities of MoS₂/Graphene Nanocomposite

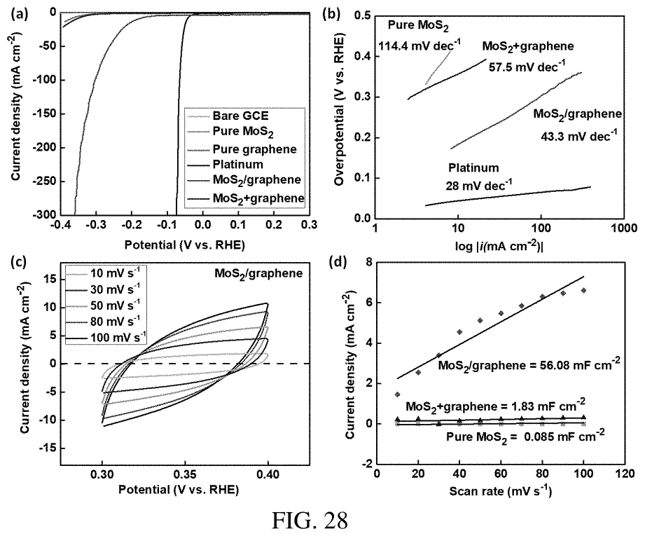

The electrocatalytic HER activities of MoS₂/graphene were investigated in 0.5 M H₂SO₄ solution by linear sweep voltammetry (LSV) at room temperature, with a scan rate of 1 mV s⁻¹ using a typical three-electrode setup. The pure MoS₂ particles, pure graphene, a physical mixture of MoS₂ and graphene (MoS₂+graphene), commercial Pt catalyst and bare GCE were also studied under the same conditions for comparison. The GCE was coated with catalyst loading of around 5 mg cm⁻² for each of the electrochemical test. The LSVs (iR corrected) recorded on MoS₂/graphene showed a small onset potential (η₀) of 100 mV (FIG. 28a), beyond which the cathodic current increased abruptly when the potential turns more negative. All the major electrochemical parameters were shown in Table 6, which showed the overpotentials (q) for Pt and MoS₂/graphene to reach the current density of 10 mA cm⁻² were 53 and 183 mV, respectively. In contrast, pure MoS₂ and MoS₂+graphene mixture displayed trivial HER catalytic activities, while bare GCE and graphene showed no catalytic activity with the absence of MoS₂ catalyst (FIG. 28a). To further demonstrate the HER activities, Tafel plots were derived from LSVs by fitting the linear regions to Tafel equation (η=b log i+a; where η is the overpotential, b is the Tafel slope, i is the current density and a is a constant). Tafel slope is an inherent property of the catalyst, related to the electrocatalytic reaction mechanism. Theoretically, there are three principal steps for HER in acidic electrolytes, which can elucidate electron transfer kinetics of the catalysts. Three possible reactions are given in equations (1)-(3):

Volmer reaction: H₃O⁺(aq)+e⁻+ [symbol] H*+H₂O(l) (1)

Heyrovsky reaction: H*+H₃O⁺(aq)+e⁻ [symbol] H₂(g)+H₂O(l)+* (2)

Tafel reaction: H*+H* [symbol] H₂(g)+2* (3)

In above equations, * indicates an empty active site and H* is a hydrogen atom bound to an active site of catalyst material. The overall HER reaction proceeds through a discharge step (Volmer reaction, equation 1) with a Tafel slope around 120 mV per decade, followed by either a desorption step (Heyrovsky reaction, equation 2) or recombination step (Tafel reaction, equation 3), with the Tafel slopes around 40 and 30 mV per decade, respectively. In this study, MoS₂/graphene exhibited the Tafel slope of 43.3 mV per decade (FIG. 28b), indicating that the Volmer-Heyrovsky reaction mechanism dominates in the HER process of MoS₂/graphene catalyst and the electrochemical desorption is the rate determining step. This high performance of MoS₂/graphene demonstrates the advantage of synergistic effect between MoS₂ nanosheets and graphene, which generates more active sites for hydrogen evolution. Previous reports showed that the exchange current density (i₀) is proportional to the active surface area of catalyst materials, which can be obtained by an extrapolation method (FIG. 35) based on the Tafel equation. The i₀ of MoS₂/graphene catalyst was calculated to be 2.512 mA cm⁻², which is very close to the i₀ of commercial Pt (3.981 mA cm⁻²) (Table 6).

TABLE 6
Electrochemical parameters of MoS₂/graphene nanocomposite, comparing with
commercial Pt, MoS₂ + graphene mixture, pure MoS₂, and pure graphene samples.

| | | | | Ex. current |
|---|---|---|---|---|
| | Onset potential, η₀ | Over potential, η | Tafel slope | density, i₀ |
| Samples | [mV vs. RHE] | [V vs. RHE] | [mV per decade] | [mA cm⁻²] |
| Platinum | 45 | 53 | 28 | 3.981 |
| MoS₂/graphene | 100 | 183 | 43.3 | 2.512 |
| MoS₂ + graphene | 201 | 365 | 57.5 | 1.007 |
| Pure MoS₂ | 293 | >400 | 114.4 | — |
| Pure graphene | 204 | 374 | — | — |

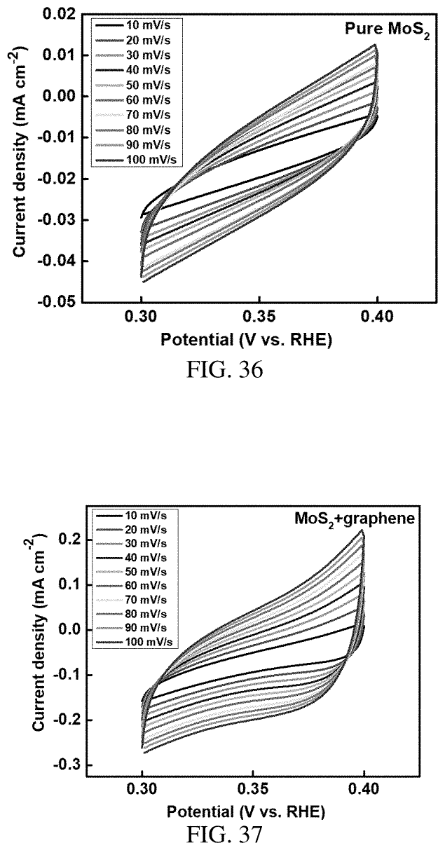

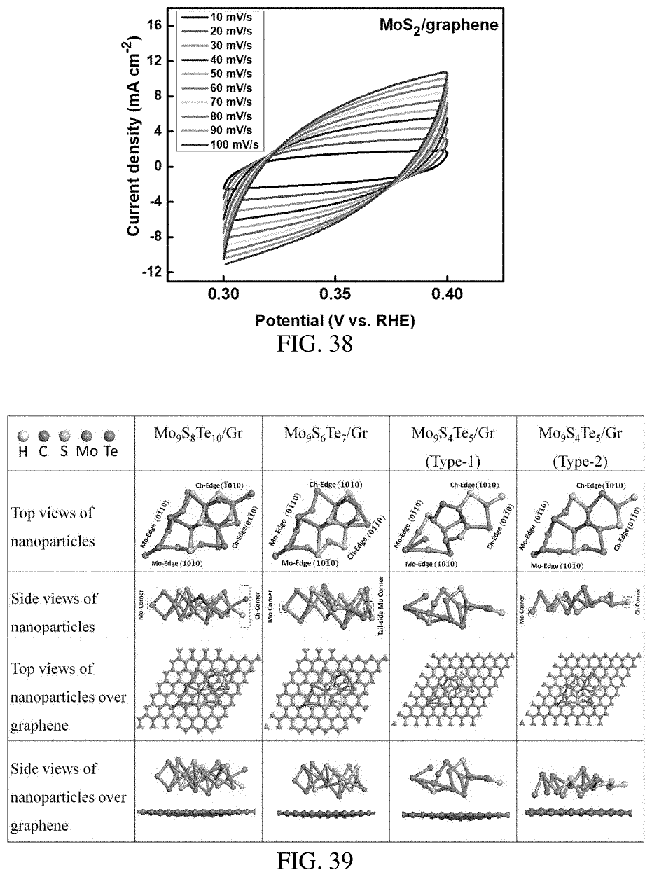

This speculation was further confirmed by the measurement of electrochemical double-layer capacitance (C_{d1}) at solid-liquid interface, another approach to estimate the electrochemically active surface area (ECSA). The ECSA gives an estimation of active reaction sites, which is proportional to C_{d1}. To determine C_{d1} values, CV measurements were conducted for MoS₂/graphene catalyst within a potential range (0.3-0.4 V vs. RHE) with no apparent faradaic process (FIG. 28c), where the currents were mainly attributed to the charging of the double layer. The double-layer charging current (i_{c}) is equal to the product of the scan rate (ν) and double-layer capacitance (C_{d1}), which can be shown in the equation: charging current, i_{c}=ν C_{d1}. From this equation, C_{d1} can be measured from the slope by plotting a straight line of i_{c} vs. ν. Representative plots for the determination of active surface areas of MoS₂/graphene, MoS₂+graphene, and pure MoS₂ catalysts were shown in FIG. 28d and FIGS. 36, 37, 38. The capacitance of MoS₂/graphene was calculated to be 56.08 mF cm⁻², whereas those of MoS₂+graphene and MoS₂ were only 1.83 and 0.085 mF cm⁻², respectively. The measured capacitance (C_{d1}) of MoS₂/graphene composite is higher than the previously reported values for MoS₂ compounds, further resulting in high catalytic performance.

Previously reported onset potentials (no) and Tafel slopes of molybdenum (Mo—) compounds were compared with the present data of MoS₂/graphene composite in Table 7.

TABLE 7
Comparison of electrochemical activities of microwave-synthesized
MoS₂/graphene with previously reported MoS₂-graphene compounds.

| | | Tafel slope | | |
|---|---|---|---|---|
| | Onset potential | [mV per | Synthesis | |
| Material | [mV vs. RHE] | decade] | approach | Reference |
| GA-MoS₂ | 100 | 41 | hydrothermal | Chem. - A |
| | | | | Eur. J. 2015, |
| | | | | 21, 15908 |
| MoS₂/MGF | 100 | 42 | solvothermal | Adv. Funct. |
| | | | | Mater. 2013, |
| | | | | 23, 5326 |
| MoS₂/RGO | 100 | 41 | solvothermal | J. Am. |
| | | | | Chem. Soc. |
| | | | | 2011, 133, |
| | | | | 7296 |
| MoS₂/ | 35 | 38 | wet-chemical | Nano Res. |
| GO-CNT | | | strategy | 2016, 9, 837 |
| MoS₂/RGO₂ | 140 | 41 | solvothermal | Chem. |
| | | | | Mater. 2014, |
| | | | | 26, 2344 |
| MoS₂/ | 100 | 43.3 | microwave | Present |
| graphene | | | irradiation | study |

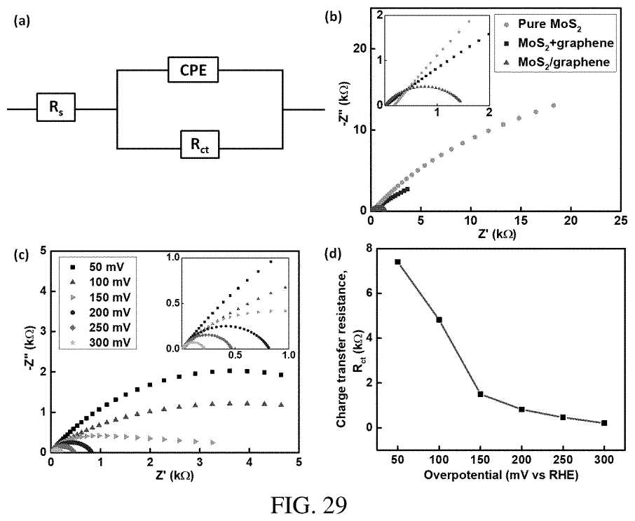

In contrast with ultrafast, facile microwave-initiated synthesis performed in this study, previously reported Mo-compounds were synthesized by different complex approaches. Moreover, it is clear that the present material exhibits low onset potential and a small Tafel slope that are comparable with other similar compounds. While neither desiring to be bound by any particular theory nor intending to limit in any measure the scope of the appended claims or their equivalents, it is presently believed that the improved electrocatalytic activity of MoS₂/graphene may be attributed to strong chemical and electronic coupling between MoS₂ nanosheets and graphene, resulting fast electronic kinetics between the catalyst and electrode surface. This hypothesis was further confirmed by electrochemical impedance spectroscopy (EIS) measurements in 0.5 M H₂SO₄. The electrical equivalent circuit diagram in FIG. 29a was used to model the solid liquid interface, where the constant phase element (CPE) was associated to electrical double layer formed at electrode/electrolyte interface of MoS₂/graphene catalyst.

As shown in FIG. 29b, the MoS₂/graphene displayed much lower impedance than pure MoS₂ particles and MoS₂+graphene mixture. The charge transfer resistance R_{ct} is related to the kinetics of electrocatalysis and a lower value resembles to a faster reaction rate. Because of the highly conductive surface and strong hydrogen adsorption capacity, MoS₂/graphene catalyst showed the R_{ct} of 1.50 MI at overpotential of 180 mV, while pure MoS₂ and MoS₂+graphene mixture presented very large R_{ct} of 37.7 and 246.4 MI, respectively (FIG. 29b). The solution resistance (Rₛ) for MoS₂/graphene was 5Ω, while pure MoS₂ and MoS₂+graphene showed higher values of 234.1 and 11.84Ω, respectively. Hence, much faster electron transfer between the catalytic edge sites of MoS₂/graphene and the electrode surface is believed to be a key factor contributing to the superior HER kinetics in acidic electrolyte. Additionally, FIG. 29c represented the Nyquist plots of MoS₂/graphene catalyst at various overpotentials of 50-300 mV. In the high frequency zone, the MoS₂/graphene exhibited one capacitive semicircle, indicating that the reaction was kinetically controlled. In this system, R_{ct} decreased significantly with increasing overpotentials, from 7.4 MI at 50 mV to only 204.5Ω at 300 mV (FIG. 29d). Lower charge-transfer resistance (R_{ct}) illustrated the superior electrocatalytic activity at higher overpotential.

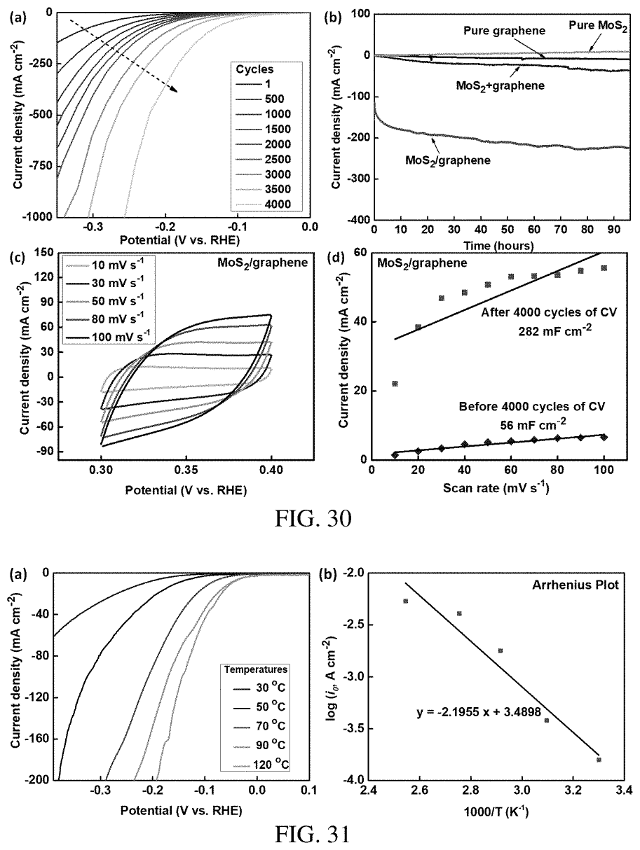

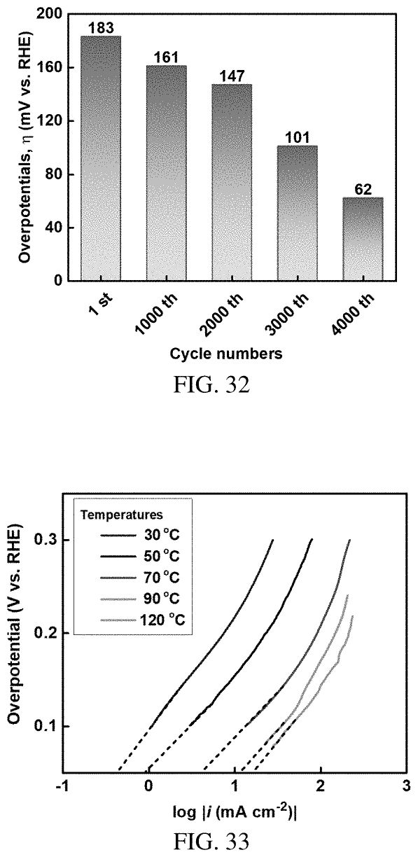

Besides high catalytic activities, good stability towards HER is also a key parameter for practical applications. To investigate the durability in an acidic environment, long-term stability of MoS₂/graphene was tested using the cyclic voltammetry (CV) technique from 0 to −350 mV vs. RHE scanning for 4000 cycles at a scan rate of 50 mV s⁻¹ (FIG. 30a). Very interestingly, the catalytic performance of MoS₂/graphene nanocomposite enhanced with the potential cycling by reaching the overpotential value of only 62 mV after 4000 cycles (FIG. 32), which is very close to the overpotential (53 mV) of Pt catalyst. Similar improvement in the catalytic performance of MoS₂ by electrochemical cycling had been previously reported. While neither desiring to be bound by any particular theory nor intending to limit in any measure the scope of the appended claims or their equivalents, it is presently believed that the improved catalytic performance during the potential cycling was due to catalytic activation by proton intercalation in MoS₂-layers. Another reason could be the self-optimizing morphological changes by perforation of H₂ bubbles, generating thinner and more porous catalyst materials. Besides cycling stability, the practical operation of as-produced MoS₂/graphene catalyst was examined by electrolysis at constant potential over extended periods. As shown in FIG. 30b, the MoS₂/graphene catalyst showed a stable increase in cathodic current density from 140 to 210 mA cm⁻² for electrolysis over 90 hours at a constant overpotential of 180 mV. The increase in current density supports the hypothesis of catalytic activation observed during the cycling stability. Furthermore, the double layer capacitance (G_{d1}) was calculated for MoS₂/graphene based on CV measurements (FIG. 30c) after 4000 cycles. A remarkable increase was found in Cal, from 56.08 to 556 mF cm⁻² (FIG. 30d), substantiating the increase in electrocatalytic active surface area of hybrid catalyst during the cycling activation process.

In practical applications, water electrolysis cells may operate at relatively high temperatures about 50-70° C. Therefore, the stability of as-produced MoS₂/graphene composite was measured by obtaining the LSVs at a temperature range from 30° C. to 120° C. (FIG. 31a). In addition, exchange current densities (i₀) were measured from corresponding Tafel slopes, which was shown in FIG. 33 and the electrochemical parameters (η₀ and i₀) were tabulated in Table 8. The improvement in HER activities were clearly observed with the increase in temperature by decreasing the onset potentials and increasing in exchange current densities. Even at high temperature of 120° C., MoS₂/graphene showed good stability exhibiting a very low onset potential of 57.2 mV with a high current density.

TABLE 8
Electrochemical parameters of MoS₂/graphene composite at a
temperature range of 30-120° C., based on LSV data and Tafel plots.

| | Onset potential | Ex. current density, i₀ |
|---|---|---|
| Temperature [° C.] | [mV vs RHE] | [mA cm⁻²] |
| 30 | 100.2 | 0.158 |
| 50 | 85.4 | 0.380 |
| 70 | 73.2 | 1.778 |
| 90 | 68.7 | 4.074 |
| 120 | 57.2 | 5.370 |

Moreover, activation energy (Eₐ) is another important parameter to measure the electrocatalytic performance of the HER catalyst. Based on the Arrhenius equation

$$( k = {Ae}^{\frac{- {E}_{a}}{R T}} ) ,$$

Eₐ can be calculated by using the following equation 4:

$$log ( {i}_{0} ) = log ( A ) - \frac{{E}_{a}}{2.3 RT} \qquad ( 4 )$$

Where, A is the pre-exponential factor, R is universal gas constant and Tis absolute temperature (in K). Plot of the log (i₀) as a function of

$$\frac{1000}{T}$$

was shown in FIG. 31b. From the slope of the Arrhenius plot, Eₐ was calculated to be 36.51 kJ mol⁻¹ for MoS₂/graphene-catalyst. This lower activation energy can be comparable to Pt catalyst, which displays the Eₐ value in a range of 20-40 kJ mol⁻¹. This enhanced catalytic activity and durability indicate that microwave-synthesized MoS₂/graphene nanocomposite is an efficient HER catalyst in acidic medium, even at the higher operating temperatures.

In conclusion, a highly active electrocatalyst of MoS₂ nanosheets dispersed over graphene has been synthesized by a fast, facile, energy efficient, environmentally friendly route involving reduction of Mo-precursor with the presence of CS₂ and graphene under microwave irradiation. Along with being the microwave susceptor, graphene provides a stable conducting network and the large specific surface area for the growth of MoS₂ catalysts, facilitating both the electronic and ion transports between MoS₂/graphene compound and acidic electrolyte, further accelerating the catalytic reaction. As-produced MoS₂/graphene nanocomposite exhibited the enhanced HER activity with a low overpotential and large cathodic current. A small Tafel slope of 43.3 mV per decade suggested a Volmer-Heyrovsky mechanism for the HER. In addition, the catalyst material showed high cycling stability and a continuous hydrogen generation for 90 hours at constant potential operation. This non-noble, highly active and stable HER catalyst material is a promising candidate that could accelerate the efforts towards establishing a clean hydrogen-based energy economy. Even though the overpotential (η₁₀) for MoS₂/graphene is higher by 130 mV, it is substantially more preferred for commercial applications than the platinum material since MoS₂ is an earth abundant material and hence much cheaper than Pt. Above all, the microwave-initiated synthesis of MoS₂/graphene nanocomposite via an environmentally benign and simple method, capable for extending to large scale, economic production makes it an attractive catalyst for efficient hydrogen generation through water-electrolysis.

Enhancement of Hydrogen Evolution Reaction Activity Using Metal-Rich Molybdenum Sulfotelluride with Graphene Support: A Combined Experimental and Computational Study

The present work demonstrates a facile, ultrafast (e.g., 60 sec) microwave-assisted synthesis approach to develop an electrocatalyst of molybdenum sulfotelluride on graphene support, which is denoted as MoSₓTe_{y}/Gr. The abundant interfaces in hybrid nanostructure of MoSₓTe_{y}/Gr enable more exposed active sites for electrochemical reaction, facilitating the ion and charge transport activities. Among the resultant nanocomposites with different elemental ratios of Mo, S and Te, the MoS_{0.46}Te_{0.58}/Gr exhibits the best hydrogen evolution property with a lower overpotential of 62.2 mV at 10 mA cm⁻², a small Tafel slope of 61.1 mV dec⁻¹, and long-term stability in 0.5 M H₂SO₄ electrolyte. Moreover, using the tool of periodic plane-wave density functional theory (DFT) has been used to elucidate hydrogen-binding energetics on various molybdenum sulfotelluride (stoichiometric and non-stoichiometric molybdenum-rich) and graphene nanocomposite systems. According to the computational results, high performing catalytically active sites are found to be comprised of primarily exposed Mo atoms, thus showing Mo enrichment as a potential method for electrocatalyst engineering. Furthermore, in a volcano plot constructed with both computational and experimental values, the position of the MoS_{0.46}Te_{0.58}/Gr nanocomposite is found to be close to the apex with near thermoneutral catalytic activity.

Hydrogen is an excellent storage solution for the intermittent renewable energy resources. One of the effective strategies is to utilize the electricity from renewable sources to split water into hydrogen and oxygen. Thus, the extra electricity generated from renewables can be stored as a form of useful hydrogen energy and while required this hydrogen can be used in fuel cell or in chemical industries. During this water electrolysis, the negative electrode (also known as cathode) undergoes the hydrogen evolution reaction (HER). However, the efficiency of the water-splitting reaction is very low, mainly due to the high overpotential (the difference between theoretical potential and actual potential of an electrochemical reaction). In this regard, the electrocatalysts are important as cathode materials to promote the HER kinetics and make the process energy-efficient by reducing overpotential. Conventionally, platinum (Pt) and Pt-group metals are well recognized as highly efficient HER catalysts. Nevertheless, their high cost and lack of resource prevent their widespread industrial applications. To establish a cost-effective production of green hydrogen, there is no alternative other than replacing the expensive Pt-electrodes.

As a result, noble-metal-free HER electrocatalysts, including transition-metal chalcogenides (TMCs), phosphides, carbides, etc., have been investigated in view of their unique properties of driving good electrocatalytic performance with low cost and natural abundance. Numerous techniques have been developed, such as increasing the number of active sites by generating different nanostructured morphologies, by hybridizing with highly conductive materials such as graphene, reduced graphene oxide (rGO), carbon nanotubes (CNTs), or conducting polymers (polypyrrole, polyaniline, etc.), and by introducing dopants, defects, strains and vacancies through various surface modifications. In addition, the HER activity of metal chalcogenides can be tuned by partially substituting one chalcogen (S, Se, or Te) with another chalcogen (S, Se or Te), leading to a new type of material with broken symmetry along the Z direction, thus improving the electrocatalytic performances in HER. For instance, J. Zhang et al. has observed significantly improved HER performance in a single-layer SeMoS Janus structure compared to both MoS₂ and MoSe₂ (ACS Nano 2017, 11 (8), 8192-8198). Similarly, in another study, T. Kosmala has demonstrated better HER results from molybdenum selenotellurides than MoSe₂ and MoTe₂ (Adv. Energy Mater. 2018, 8 (20), 1-8). Therefore, the doping at anion (chalcogen) sites of TMC compounds has good potential for developing new materials with enhanced electrocatalytic properties.

Although the coupling of metal chalcogenides with conducting supports (such as graphene, rGO, CNT, etc.) may be important for preventing the easy aggregation of TMC-layers, only a few Janus-type Mo—S—Se compounds have been hybridized with conducting supports. It is believed that there has been no prior demonstration of the electrocatalytic properties of a molybdenum sulfotelluride compound for HER. In addition, hydrothermal, solvothermal, and chemical vapor deposition (CVD) are the common methods applied to effectively prepare the TMC nanohybrids. However, these methods require complex synthesis approaches with high cost and high-energy consumption indisputably restricting their large-scale applications. Therefore, it is still a great challenge to develop a simple and efficient method to prepare the TMC-based composites with improved HER performance

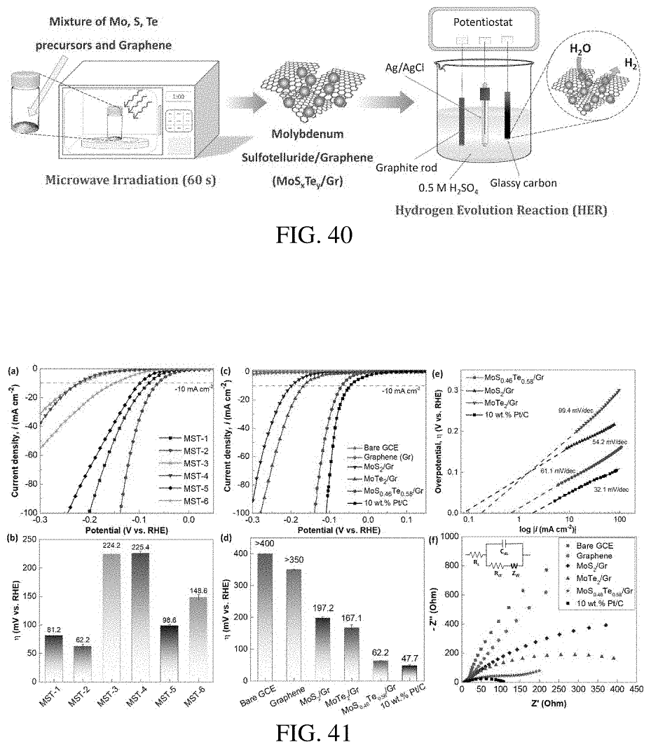

Herein, for the first time, a simple solid-state synthesis of molybdenum sulfotelluride compounds with graphene support (MoSₓTe_{y}/Gr) via a scalable, ultrafast (e.g., 60 sec) and efficient microwave-assisted heating approach is described, as is the use of these composites as HER electrocatalysts in acidic medium. The research scheme is shown in schematic form in FIG. 40. Compared to conventional heating methods, microwave-assisted heating may provide one or several advantages, such as rapid volumetric heating, higher reaction rate, high purity, high selectivity, reduced reaction time, and/or increased yields of products, etc. Benefiting from the defects created in the crystal structures, the as-prepared MoSₓTe_{y}/Gr nanocomposite has been demonstrated to be an active nonprecious metal-based electrocatalyst for HER, resulting in low overpotential, small Tafel slope with a high exchange current density, along with outstanding long-term stability under acidic condition, even in a high temperature range.

Alongside experimental investigation, molecular modeling studies have been performed with periodic plane-wave density functional theory (DFT) to delve into the surface-electrochemistry of hydrogen binding (also known as chemisorption or adsorption). Binding energetics, which are considered major descriptors for catalytic performance but difficult to attain with experimental measurement, have been calculated with DFT. The role of binding energy in catalysis is supported by Sabatier's principle, stating that for ideal catalysis conditions the binding free energy should be near zero. In this computational analysis, the conventional criterion of ΔG_{binding}≈0 has been considered as the measure to establish the most suitable binding sites for HER catalysis. However, a recent study has suggested that for a catalytically active site the binding free energy may not be near zero.

Although molybdenum chalcogenides, with or without graphene support, have been used as hydrogen electrodes, it is believed that heretofore, there has been no study carried out to understand HER activity of metal rich nanocomposite of molybdenum sulfotelluride and graphene as an electrocatalyst. In this computational study, the free energy calculations have been performed with zero applied overpotential (η=0) as per the established norm. Recently, an augmented approach to Sabatier's principle has appeared which states that for very active electrocatalysts, the near zero binding free energy should be determined at an applied overpotential. The most well known graphical depiction of Sabatier's principle is the volcano plot, which in this study exhibits the position of molybdenum sulfotelluride/graphene nanocomposite near the apex of the volcano. The combined experimental and computational studies described herein demonstrate the higher electrocatalytic ability of MoSₓTe_{y}/Gr composite comprised of a higher molybdenum-to-chalcogen ratio for HER, thus showing potential for practical application with prospective commercialization.

A Comprehensive Study on HER Activities of Molybdenum Chalcogenide/Graphene and their Hybrid-Nanocomposites

In this work, the molybdenum dichalcogenides (MoX₂, X═S, Se, Te) and their hybrid nanocomposites (MoSSe, MoSeTe, MoSTe, and Mo(SSeTe)_{0.67}) were constructed on a graphene network through the microwave-assisted heating approach. The as-synthesized materials were employed as working electrodes in a standard three-electrode setup to investigate their electrocatalytic properties for hydrogen evolution reaction (HER). The electrochemical measurements revealed that all the materials are highly active and durable for HER with small overpotentials in the range of 127-217 mV and negligible activity loss for 96 hours of constant potential tests. Among all different molybdenum chalcogenide/graphene-nanocomposites, the materials containing tellurium (Te) exhibited better HER activities, which could be due to the presence of metallic phase of MoTe₂ in the catalyst structures. Most importantly, hybrid nanocomposites, only except Mo(SSeTe)_{0.67} on graphene, exhibited improved performance in comparison to the MoX₂ compounds. It is believed that such improvements reflect the higher intrinsic activity of alloyed catalysts with the hydrogen adsorption free energy closer to thermoneutral.

Transition metal dichalcogenides (TMD) have kindled a tremendous interest since the edges of MoS₂ nanoparticles exhibit a close resemblance to the catalytic center of the hydrogenase enzyme. Especially the two-dimensional (2D) layered TMD compounds with a general formula of MX₂ (M=Mo, W, Cu, Ni, etc., X═S, Se, Te) have been demonstrated to be very promising HER catalysts. Nonetheless, in the bulk form, these materials provide poor performances because of the low density of active sites and scarce electrical conductivity. During the past several years, various techniques such as defect engineering, interface construction, phase engineering, hydrophilicity tuning, or integration with conductive materials (such as graphene, carbon nanotubes etc.) have contributed to overcome the intrinsic shortcomings of bulk MX₂. In addition to structural engineering, the HER activity of TMDs can be tuned through tailoring their chemical compositions. For example, sulfur in MoS₂ can be partially substituted by Se atom. Similarly, any of the chalcogens (S, Se, or Te) can be substituted by any of the other chalcogens (S, Se, or Te), leading to a library of compounds that are promising for HER. Inspired by the promising prospects of TMDs on carbon supports towards HER activities, a direct growth strategy to synthesize MoX₂ compounds (MoS₂, MoSe₂ and MoTe₂) and their hybrid heterostructures (MoSSe, MoSeTe, MoSTe, and Mo(SSeTe)_{0.67}) on graphene supports through a simple microwave-assisted heating approach has been developed. Such nanocomposites can provide synergetic interactions between TMDs and graphene nanosheets in the kinetic process and electronic modulations. Indeed, the as-prepared compounds showed great potential as low-cost electrocatalysts for hydrogen evolution reaction (HER).

### Hybrid and Non-Hybrid Molybdenum Chalcogenides as Electrocatalysts for Cathodic Hydrogen Generation: A Systematic Mapping of First-Principle Based and Experimental Descriptors

In this work electrocatalytic performance of nanocomposites consist of molybdenum dichalcogenides with graphene support have been investigated systematically for both hybrid and non-hybrid chalcogen combinations, specifically for S, Se, and Te elements. An approach to gain insight in some major descriptors to evaluate the catalytic performance, which are not easily accessible through experimental investigation, is the periodic plane-wave based density functional theory (DFT) calculation. In this study, plane wave density functional theory calculations have been performed to probe the hydrogen binding energetics of various adsorption sites on hybrid molybdenum chalcogenides/graphene nanocomposites. The traditional criterion according to the Sabatier's principle for determining catalytically active sites is the near zero value of Gibbs free energy of hydrogen binding (ΔG_{b}≈0). All systems those have been considered in this computational investigation have binding sites within this range, with molybdenum sulfotelluride/graphene nanocomposite showing the most potential as an electrocatalytic material for HER. Results from these theoretical investigations is also in agreement with the experimental results.

Computational Methodology

The theoretical study has been performed utilizing periodic plane-wave density functional theory (DFT) calculations as implemented in the Cambridge Serial Total Energy Packages (CASTEP). The spin polarized generalized gradient approximation (GGA) with Perdew-Burke-Ernzerhof (PBE) functional has been used with Kohn-Sham orbitals with an energy cutoff of 400 eV. The effect of the core electrons has been expressed with the Vanderbilt Ultrasoft Pseudopotentials (USPP) method. To provide hydrogen chemisorption energies and geometries for the MoCh/graphene nanocomposite in line with experimental observations, an improved description of the nonlocal nature of the electron correlation and in particular van der Waals interactions was accounted for using a semi-empirical dispersion energy correction by the method of Tkatchenko and Scheffler (TS). All structures are geometry optimized using two-point steep gradient displacement (TPSD) algorithm. For the dipole correction, self-constant scheme has been applied. Relativistic treatment has been done with Koeling-Harmon Scalar method.

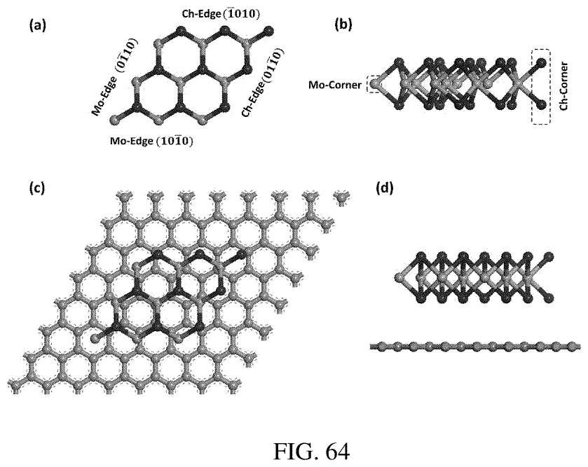

As presented in FIG. 64, the MoTe₂/graphene composite was created by constructing a supercell model of MoCh₂ with 3×3 in plane periodicity supported on a 7×7×1 graphene basal plane. To create Mo₉S₁₈, Mo₉Se₁₈, and Mo₉Te₁₈ nanoparticles are taken out from a previously geometrically optimized respective solid-state hexagonal molybdenum chalcogenide lattice. Mo₉Se₉Te₉ and Mo₉S₉Te₉ nanoparticles are created by randomly replacing nine tellurium atoms from Mo₉Te₁₈ nanoparticle with sulfur and selenium atoms respectively. Mo₉S₉Se₉ created by randomly replacing nine sulfur atoms from Mo₉S₁₈ nanoparticle with selenium atoms. Mo₉S₆Se₆Te₆ nanoparticle is also generated by replacing twelve tellurium atoms from Mo₉Te₁₈ nanoparticle with six sulfur and six selenium atoms.

A larger model of nanoparticles would be preferable since it would be similar to the experimental literature, but due computational costs and combinatorial explosions of possible configurations it is beyond the scope of this work.

For the cleaved Mo₉Ch₁₈ nanoparticle, the 101̅0 plane best represents the exposed Ch edge, and similarly the 011̅0 plane best represents the exposed Mo edge. A vacuum space of 20 Å has been used between vertically repeated composite models. The Brillouin zone has been sampled by a 2×2×1 k-point grid generated using Monkhorst-Pack scheme. The convergence criteria for energy were set to 2×10⁻⁵ eV per atom and for displacement, this tolerance was set to 0.002 Å.

For the computational study, multiple hydrogen adsorption sites on each of the molybdenum chalcogenides/graphene nanocomposites were investigated for binding energetics. For each of these sites, the effective binding electronic energy for a single hydrogen atom on the nanoparticle supported by the graphene has been calculated using equation (6) below:

ΔE_{Binding}=½(E_{2H*+Nanocomposite}−E_{Nanocomposite}−E_{H}_{₂}) (6)

Here E_{2H*+Nanocomposite} is the total electronic energy of the two hydrogen atoms bound to the nanoparticle-graphene composite, E_{Nanocomposite} is the total electronic energy of only nanoparticle-graphene composite, and E_{H}_{₂} is the electronic energy of a hydrogen molecule placed in 17.2 Å×17.2 Å×20 Å vacuum hexagonal unit cell. Binding free energy (ΔG_{Binding}) which is a more appropriate descriptor for the catalytic activity than electronic energy alone, has been calculated using the generalized expression for HER catalysis developed by Nørskov and coworkers shown in equation 7 below:

ΔG_{Binding}=ΔE_{Binding}+0.24 eV (7)

For the computational study, multiple hydrogen adsorption sites on each of the molybdenum dichalcogenide/graphene nanocomposites were investigated for binding energetics. For the Mo₉S₁₈/Gr, Mo₉Se₁₈/Gr, and Mo₉Te₁₈/Gr nanocomposite structures, nine binding sites are considered. For the Mo₉S₉Se₉/Gr, Mo₉S₉Te₉/Gr, Mo₉Se₉Te₉/Gr, and Mo₉S₆Se₆Te₆/Gr structures, adsorption energetics for fourteen binding sites are calculated. The binding sites are vicinal chalcogen edge (site no. 1 and 2), Mo corner (site no. 3), chalcogen top (site no. 4 and 5), Mo and chalcogen edge (site 6 and 7), chalcogen edge and Mo corner (site no. 8), chalcogen corner (site 9), germinal chalcogen edge (site 10 and 11), Mo edge (site no. 12 and 13), and Mo corner-edge (site 14). The five extra sites in these nanocomposites (sites no 2, 5, 7, 11, and 13) are due to the structural asymmetry in the hybrid molybdenum dichalcogenide particles.

The overall binding electronic energy for the entire nanocomposite varies from −3.123 eV to 1.472 eV with standard deviation of 0.961 eV and binding free energy values are within varies from −2.883 eV to 1.712 eV with standard deviation of 0.922 eV. There are twelve binding sites are found within the range of −0.02 eV and 0.02 eV. The three structures that contains the highest standard deviations among it binding energies are Mo₉S₁₈/Gr, Mo₉Se₁₈/Gr and Mo₉S₉Se₉/Gr (0.795 eV, 1.199 eV, and 1.132 eV respectively). Among all the other structures, binding energies have standard deviation approximately 0.5 eV.

TABLE 21
Theoretically calculated binding energies (ΔE_{b} and ΔG_{b}) of hydrogen atoms on a number of
adsorption sites of nonhybrid molybdenum chalcogenide/graphene nanocomposite.

| Binding | | | | | | | |
|---|---|---|---|---|---|---|---|
| Sites | | Ch = S | | Ch = Se | | Ch = Te | |
| Index | Binding Sites | ΔE_{b} (eV) | ΔG_{b} (eV) | ΔE_{b} (eV) | ΔG_{b} (eV) | ΔE_{b} (eV) | ΔG_{b} (eV) |
| 1 | Ch Edge (Vicinal) | −0.902 | −0.662 | −0.126 | 0.113 | 0.583 | 0.823 |
| 2 | Mo Corner | −0.623 | −0.383 | −0.448 | −0.208 | −0.507 | −0.267 |
| 3 | Ch Top | −2.060 | −1.820 | −1.722 | −1.482 | 1.083 | 1.323 |
| 4 | Ch-Mo Edge (Bridge) | 0.429 | 0.669 | −3.123 | −2.883 | −0.286 | −0.046 |
| 5 | Ch Edge-Mo Corner | −0.221 | 0.019 | 0.021 | 0.261 | 0.140 | 0.380 |
| 6 | Ch Corner | −1.770 | −1.530 | −0.310 | −0.070 | 0.818 | 1.058 |
| 7 | Ch Edge (Geminal) | −1.468 | −1.228 | −1.183 | −0.943 | 0.584 | 0.824 |
| 8 | Mo Edge | −0.487 | −0.247 | 0.066 | 0.306 | 0.186 | 0.426 |
| 9 | Mo corner-Mo Edge | −0.469 | −0.229 | −2.655 | −2.415 | 0.034 | 0.274 |

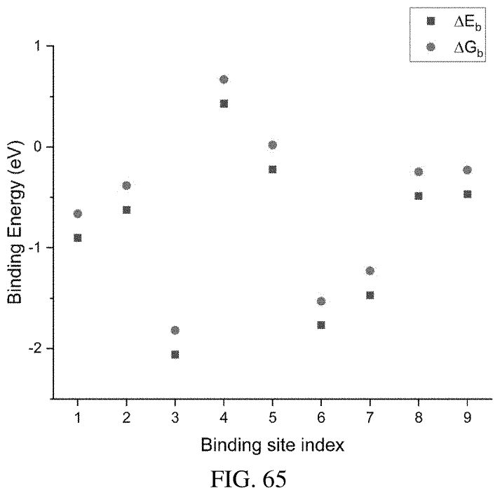

For the Mo₉S₁₈/Gr nanocomposite structure, the binding electronic energy values range from −2.060 eV to 0.429 eV, and the binding free energy values range from the −1.820 eV to 0.669 eV (FIG. 65 and Table 21, respectively). The bridge site between S edge and Mo edge exhibits the most thermoneutral free energy change (−0.018 eV), i.e. the lowest absolute value of binding free energy (|ΔG_{Binding}|). Thus, the Mo corner is the most optimal catalytic active binding site for hydrogen evolution according to the Sabatier Principle for this nanocomposite structure.

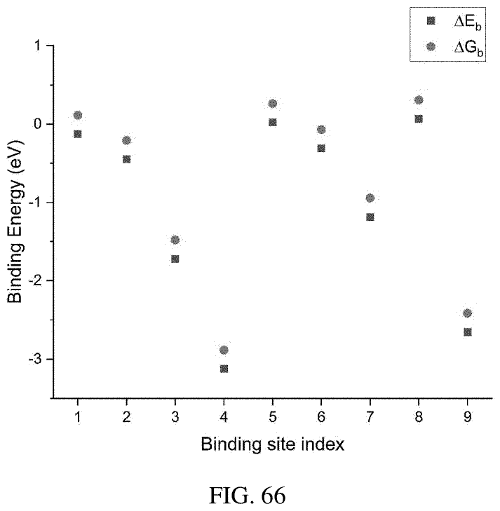

For the nanocomposite Mo₉Se₁₈/Gr, the resultant binding electronic energy values range from −3.123 eV to 0.067 eV, and the range of binding free energy values is from −2.883 eV to 0.307 eV (FIG. 66 and Table 21). For the Mo₉Se₁₈/Gr structure, two adsorption sites are found that have near zero binding free energy values (ΔG_{b}≈0), Se corner site (ΔG_{b}=−0.069 eV) and Se edge (vicinal) site (ΔG_{b}=−0.113 eV).

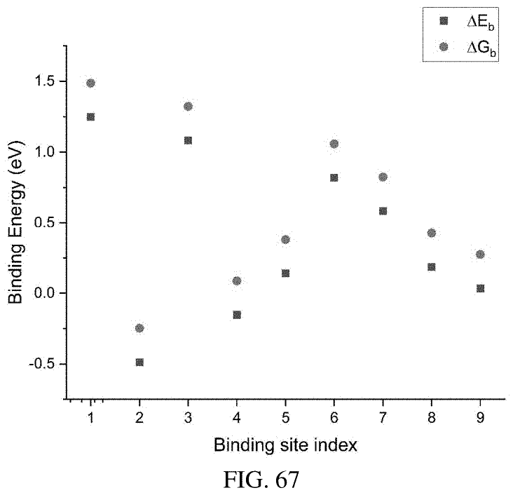

In the case of Mo₉Te₁₈/Gr nanocomposite structures, one site comprised of a Mo edge and Ted edge shows a binding free energy value in close proximity to zero (ΔG_{b}=0.087 eV). The overall electronic binding energy values varies from −0.527 eV to 1.247 eV with free energy range is from −0.287 eV to 1.487 eV (FIG. 67 and Table 21).

TABLE 22
Theoretically calculated binding energies (ΔE_{b} and ΔG_{b}) of hydrogen atoms on a number of adsorption sites of
hybrid molybdenum chalcogenide/graphene nanocomposite.

| Binding | | | | | | | | | |
|---|---|---|---|---|---|---|---|---|---|
| Site | | Mo₉S₉Se₉/Gr | | Mo₉S₉Te₉/Gr | | Mo₉Se₉Te₉/Gr | | Mo₉S₆Se₆Te₆/Gr | |
| Index | Binding Sites | ΔE_{b} (eV) | ΔG_{b} (eV) | ΔE_{b} (eV) | ΔG_{b} (eV) | ΔE_{b} (eV) | ΔG_{b} (eV) | ΔE_{b} (eV) | ΔG_{b} (eV) |
| 1 | Chalcogen Edge | −1.515 | −1.275 | 0.374 | 0.614 | 0.528 | 0.768 | 0.420 | 0.660 |
| | (Vicinal 1) | ( ) | | ( ) | | ( ) | | (Se and Te) | |
| 2 | Chalcogen Edge | −1.845 | −1.605 | 0.367 | 0.607 | 0.394 | 0.634 | 0.430 | 0.670 |
| | (Vicinal 2) | ( ) | | ( ) | | ( ) | | (Te and Se) | |
| 3 | Mo Corner | −0.909 | −0.669 | −0.567 | −0.327 | −0.454 | −0.214 | −0.613 | −0.373 |
| 4 | Chalcogen Top 1 | −0.141 | 0.099 | 0.849 | 1.089 | 0.793 | 1.033 | 0.395 | 0.635 |
| 5 | Chalcogen Top 2 | 0.368 | 0.608 | 0.645 | 0.885 | 1.138 | 1.378 | 0.504 | 0.744 |
| 6 | Ch-Mo Edge | −2.605 | −2.365 | −0.280 | −0.040 | 0.307 | 0.547 | −0.384 | −0.144 |
| | (Bridge 1) | (Ch = S) | | (Ch = S) | | (Ch = Se) | | (Ch = Te) | |
| 7 | Ch-Mo Edge | 1.472 | 1.712 | 0.188 | 0.428 | 0.150 | 0.390 | −0.435 | −0.195 |
| | (Bridge 2) | (Ch = Se) | | (Ch = Te) | | (Ch = Te) | | (Ch = Se) | |
| 8 | Mo Corner-Ch Edge | 0.266 | 0.506 | 0.439 | 0.679 | 0.178 | 0.418 | −0.009 | 0.231 |
| 9 | Chalcogen Corner | −0.835 | 0.595 | 0.179 | 0.419 | 0.188 | 0.428 | −0.070 | 0.170 |
| | | ( ) | | ( ) | | ( ) | | (S and Se) | |
| 10 | Chalcogen Edge | −1.321 | −1.081 | 0.158 | 0.398 | 0.560 | 0.800 | 0.395 | 0.635 |
| | (Geminal 1) | ( ) | | ( ) | | ( ) | | (Te and Se) | |
| 11 | Chalcogen Edge | −1.439 | −1.199 | 0.183 | 0.423 | 0.421 | 0.661 | 0.414 | 0.654 |
| | (Geminal 2) | ( ) | | ( ) | | ( ) | | (Se and S) | |
| 12 | Mo Edge 1 | −1.265 | −1.025 | −0.470 | −0.230 | −0.443 | −0.203 | 0.232 | 0.472 |
| 13 | Mo Edge 2 | −2.548 | −2.308 | −0.084 | 0.156 | −0.395 | −0.155 | −0.414 | −0.174 |
| 14 | Mo Corner and | −0.824 | −0.584 | −0.853 | −0.613 | −0.770 | −0.530 | −0.919 | −0.679 |
| | Edge | | | | | | | | |

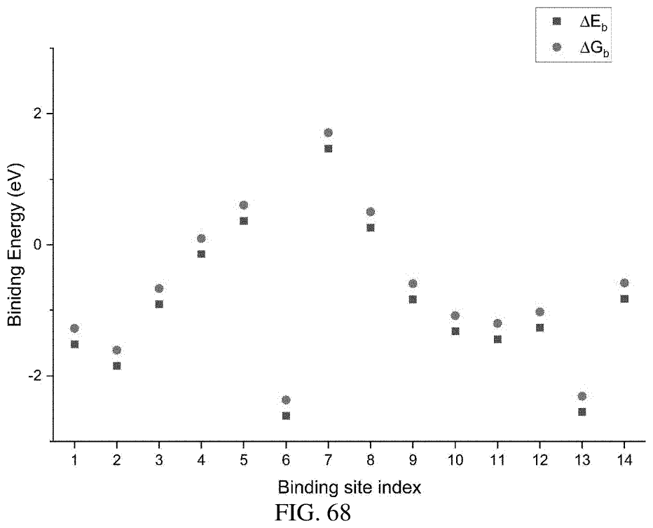

For the hybrid nanocomposite Mo₉S₉Se₉/Gr, binding free energy values varies from −2.365 eV to 1.712 eV, with chalcogen top surface sites comprising of only Se, exhibiting the best value for catalysis (ΔG_{b}=0.099 eV) (FIG. 68 and Table 22).

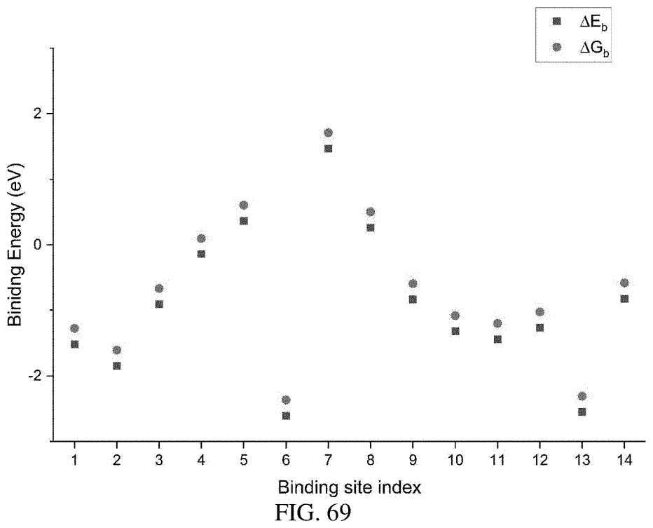

For the nanocomposite Mo₉S₉Te₉/Gr, the resultant binding electronic energy values range from −0.853 eV to 0.849 eV, and the range of binding free energy values is from −0.613 eV to 1.089 eV (FIG. 69 and Table 22). Two adsorption sites are found to have thermoneutral energetics, bridge site between S edge and Mo edge (ΔC_{b}=−0.040 eV) and Mo edge 2 site (ΔG_{b}=0.156).

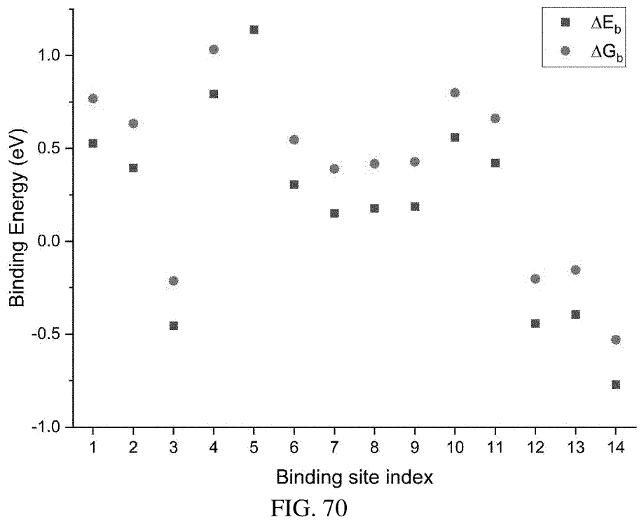

For the hybrid nanocomposite Mo₉Se₉Te₉/Gr, binding free energy values varies from −0.530 eV to 1.378 eV (FIG. 70 and Table 22). Mo edge2 site exhibit the nearest to zero value (ΔG_{b}=−0.155. eV), but no site in this structure is within the range 0f [−0.01 eV, 0.01 eV].

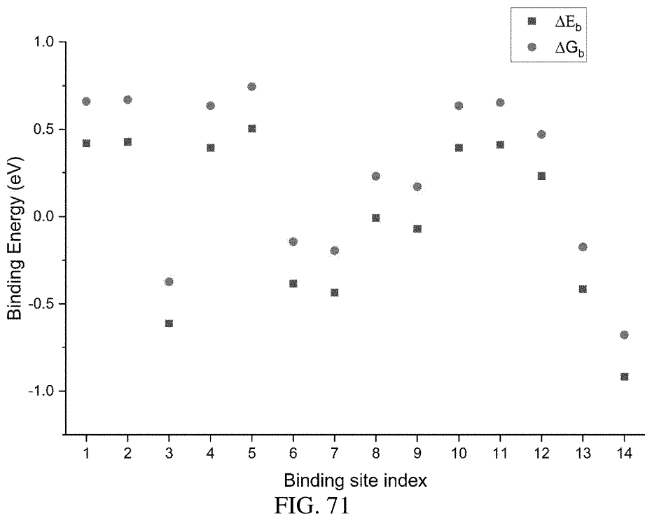

Results for Mo₉S₉Se₉/Gr nanocomposite shows four sites having binding free energy within the range of [−0.02 eV, 0.02 eV] but none within the range of [−0.01 eV, 0.01 eV] (FIG. 71 and Table 22). Binding free energy values varies from −0.679 eV to 0.744 eV. The four sites are, Mo—Te bridge site (ΔG_{b}=−0.144 eV), Mo—Se bridge site (ΔG_{b}=−0.195 eV), S—Se corner site (ΔG_{b}=0.170 eV), and Mo edge 2 site (ΔG_{b}=−0.174 eV).

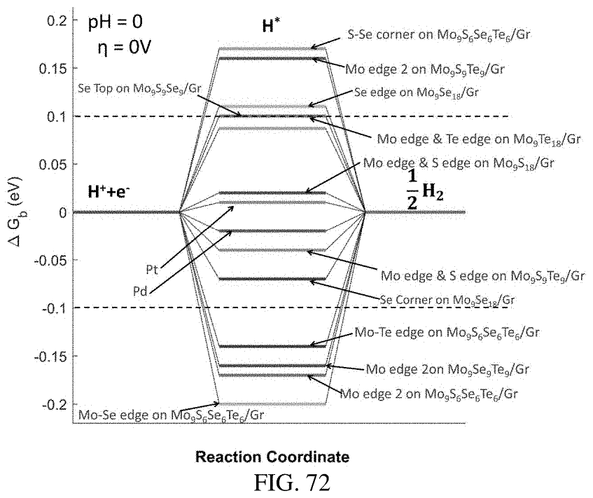

Conventionally, the binding free energies for high performing catalytically active sites are considered within the range of −0.2 eV and 0.2 eV. Each of the composite systems that have been considered in this computational investigation possess binding sites within this range. However, Mo₉Se₉Te₉/Gr and Mo₉S₆Se₆Te₆/Gr nanocomposites does not have any sites within the closer thermo-neutral range of −0.01 eV and 0.01 eV (FIG. 72). Notably, among all the sites those are within the range [−0.02 eV, 0.02 eV], most of the sites are comprised of at least one Mo atom (eight among twelve). The three other sites contains Se atoms only, and the last one is comprised of S and Se. Se and S are also present in the structure. The nanocomposite that exhibits binding energy values in the closest proximity to zero is Mo₉S₉Te₉/Gr. Similar trends have been reported.

The following examples and representative procedures illustrate features in accordance with the present teachings, and are provided solely by way of illustration. They are not intended to limit the scope of the appended claims or their equivalents.

### EXAMPLES

### Examples Relating to Thermoneutral Hydrogen Evolution Reaction Using Noble Metal Free MoTe₂/Graphene Nanocomposites

Materials and Reagents

Molybdenum hexacarbonyl (Mo(CO)₆, 98%) was purchased from Strem Chemicals. Tellurium (Te) powder (˜325 mesh) and poly-vinylidene fluoride (PVDF powder, (—CH₂CF₂—)ₙ) were purchased from Alfa Aesar. Graphene substrate was obtained from Magnolia Ridge Inc. The N, N-dimethylformamide (DMF, HCON(CH₃)₂) was obtained from Macron Fine Chemicals™. Nitric acid (69-70%) and acetone (CH₃COCH₃) were supplied by BDH Chemicals, VWR. Sulfuric acid was purchased from Anachemia. All chemicals purchased were used directly without further treatment or purification. For electrochemical characterizations, platinum (Pt) gauze (100 mesh, 99.9% metal basis) was obtained from Alfa Aesar. The silver/silver chloride (Ag/AgCl, 3 M KCl, E°=+0.197 V vs. RHE) reference electrode was acquired from Hach and glassy carbon electrode (CHI 104, 3 mm in diameter) was purchased from CH Instruments, Inc.

MoTe₂/graphene compound was prepared by reaction of molybdenum hexacarbonyl (Mo(CO)₆) and Te-powder on graphene substrate using microwave-initiated synthesis method. At first, 20 mg of Mo(CO)₆, 40 mg of Te-powder and 20 mg of graphene (weight ratio=1:2:1) were taken in a glass vial and mixed together homogeneously by a speed mixer at 2000 rpm. Next, the uniform blend of Mo(CO)₆, Te-powder, and graphene was subjected to microwave irradiation in a domestic microwave oven (frequency 2.45 GHz, power 1250 W) for 90 seconds. Graphene served as a substrate to absorb the microwave energy and convert it to heat energy. During the process, microwave heating triggered the reduction of Mo(CO)₆ to MoO₂, which then converted to MoTe₂ uniformly dispersed on graphene substrate, releasing other constituents in gaseous forms. Since, tellurium cannot replace oxygen easily because of the large difference in ion radii, there could be the mixture of MoO₂ and MoO₃ (MoOₓ) present in as-produced nanocomposites of MoTe₂/graphene. Therefore, to compare the results from electrochemical characterizations, MoOₓ/graphene compound was also prepared through microwave-initiated heating following the same steps except adding Te-powder. Thus, the synthesis of MoTe₂/graphene and MoOₓ/graphene nanocomposites were taken place by 90 seconds of microwave irradiation.

Material Characterization Techniques

The surface morphology and chemical composition of MoTe₂/graphene-composite was characterized by scanning electron microscope (SEM; Apreo FE) coupled with an energy dispersive X-ray spectrometer (EDS, EDAX Instruments) with an acceleration voltage of 20 kV. The transmission electron microscopy (TEM) and high-resolution TEM (HRTEM) analyses were carried out using a FEI Tecnai F20 TEM, operated at 200 kV and equipped with an EDAX EDS detector and GIF (Gatan Image Filter) Tridiem 863 electron energy loss spectroscopy (EELS) system. To investigate the phase and crystal structures, the powder X-ray diffraction (XRD) patterns were collected on a Philips X'pert MPD diffractometer with Cu Kα radiation (λ=1.54056 Å) at 45 kV and 40 mA. The scan speed of 0.06°/min over a 2θ range of 10-70° were used for all XRD data collection. Micro-Raman spectroscopy was performed on the samples at room temperature by employing back-scattering geometry using the 442 nm line (80 mW) of a dual wavelength He—Cd laser (Kimmon Electric). Photoemission measurements were carried out in a load locked Kratos XSAM 800 surface analysis system and XPS spectra were recorded in the fixed analyzer transmission (FAT) mode with a pass energy of 80 eV.

Electrochemical Measurements

Prior to determining HER activity by each electrochemical experiment, glassy carbon electrode (GCE) was polished with alumina powder (Al₂O₃, 0.05 μm) on a polishing mat to obtain a mirror-finished surface, rinsing with DI water and vacuum drying for 1 hr at 60° C. To prepare the working electrode, MoTe₂/graphene catalyst (2 mg) was mixed with PVDF powder (0.2 mg) and DMF (50 μL) to form a homogeneous black slurry. The catalyst slurry was drop-coated onto the clean surface of GCE (0.07 cm²) with a mass loading of ˜5 mg cm⁻², which was then dried in a vacuum dryer at 60° C. for 1 hr. For comparison, GCEs were also coated with MoOₓ/graphene composite and pure graphene following the same steps with same catalyst loading of ˜5 mg cm⁻². All electrochemical studies were performed using a CH Instrument (CHI 760D) potentiostat using ‘Electrochemical Analyzer’ software (version 15.03) in a standard three-electrode setup consisting of a glassy carbon working electrode, silver/silver chloride (Ag/AgCl, 3 M KCl) as the reference electrode, and platinum (Pt) mesh as a counter electrode in 0.5 M H₂SO₄ electrolyte. To determine the HER activities of samples, the potentials were stated to the reversible hydrogen electrode (RHE) by using the equation: V (vs. RHE)=V (vs. Ag/Ag Cl)+0.197+(0.059×pH). The electrocatalytic activities were examined by polarization curves using linear sweep voltammetry (LSV) at a scan rate of 1 mV s⁻¹ in 0.5 M H₂SO₄ at room temperature. Before each LSV measurement, cyclic voltammetry (CV) was run for 50 cycles at 10 mV s⁻¹ to achieve stable condition. CV was also performed to determine active surface area of catalyst samples within the potential window that shows no faradaic reaction taking place. LSVs were performed at different temperatures (30° C.-90° C.) using the scan rate of 1 mV s⁻¹ to determine the activation energy. Prior to each measurement of LSV and CV, a resistance (R) test was made and the iR compensation was applied using the CHI software. In addition, electrochemical impedance spectroscopic (EIS) measurements were carried out in 0.5 M H₂SO₄ at various overpotentials from 50 mV to 300 mV (vs. RHE) in the frequency range of 10⁻² to 10⁶ Hz with a single modulated AC potential of 5 mV. Afterward, the EIS spectra were fitted by the EC-Lab software. For all the electrochemical tests, the active load of ˜5 mg cm⁻² was used to maintain better consistency of the results.

Computational Methodology

The theoretical study has been performed utilizing periodic plane-wave density functional theory (DFT) calculations as implemented in the Cambridge Serial Total Energy Packages (CASTEP). The spin polarized generalized gradient approximation (GGA) with Perdew-Burke-Ernzerhof (PBE) functional has been used with Kohn-Sham orbitals with an energy cutoff of 400 eV. The effect of the core electrons has been expressed with the Vanderbilt Ultrasoft Pseudopotentials (USPP) method. To provide hydrogen chemisorption energies and geometries for the MoTe₂/graphene composite in line with experimental observations, an improved description of the nonlocal nature of the electron correlation and in particular van der Waals interactions was accounted for using a semi-empirical dispersion energy correction by the method of Tkatchenko and Scheffler (TS). All structures are geometry optimized using two point steep gradient displacement (TPSD) algorithm. For the dipole correction, self-consistent scheme has been applied. Relativistic treatment has been done with Koeling-Harmon Scalar method.

As shown in FIG. 7, the MoTe₂/graphene composite was created by constructing a supercell model of MoTe₂ with 3×3 in plane periodicity supported on a 7×7×1 graphene basal plane. The supported MoTe₂ nanoparticles have the molecular formula of Mo₉Te₁₈, where the Mo and Te atoms assume the most common metal dichalcogenide layered structure. The Mo₉Te₁₈ nanoparticle used in the composite was previously geometry optimized in the solid state hexagonal MoTe₂ lattice. For the cleaved Mo₉Te₁₈ nanoparticle, the (011̅0) plane best represents the exposed Te edge, and similarly the (101̅0) plane best represents the exposed Mo edge. A vacuum space of 20 Å has been used between vertically repeated composite models. The Brillouin zone has been sampled by a 2×2×1 k-point grid generated using Monkhorst-Pack scheme. The convergence criteria for energy were set to 2×10⁻⁵ eV per atom and for displacement, this tolerance was set to 0.002 Å. FIGS. 17 to 23 are comprised of optimized geometries for the various adsorption sites in this study. Similarly, Table 5 contains the adsorption energies for corresponding adsorption sites.

Material Characterizations

The EDS results (FIG. 8a) reveal that the nanosheets are primarily composed of molybdenum (Mo) and tellurium (Te) elements with ˜90 at. % of carbon (C) content due to the presence of a large amount of graphene substrate. Promisingly, the atomic ratio of Mo and Te components is very close to stoichiometry (1:2), which satisfies the formula of Te—Mo—Te, confirming the formation of MoTe₂ in as-produced nanocomposites. Furthermore, EDS mapping (FIGS. 8b-8e) was performed that shows the distribution of Mo and Te elements on graphene surface. From the EDS mapping results, it can be clearly observed that the MoTe₂ nanoparticles (Mo and Te elements) are uniformly distributed on graphene with slight agglomeration. Such uniform distribution of MoTe₂ nanoparticles on graphene is beneficial for improving the electrical and ionic conductivity and enhancing the stability of MoTe₂ nanoparticles during the hydrogen evolution.

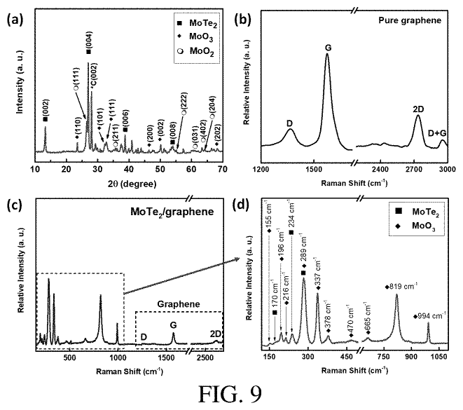

Moreover, the XRD analysis was performed to identify the formation of crystalline MoTe₂ nanosheets in as-produced composite. FIG. 9a displays the diffraction peaks in a range from 10° to 70°. The peaks appeared at 13.28°, 27°, 38.73°, 53.94° are corresponding to (002), (004), (006), (008) planes of MoTe₂, that can be indexed to the standard hexagonal 2H—MoTe₂ structure (JPCDS no. 15-0658). Since graphene possesses almost 90 at. % in MoTe₂/graphene composite, it displays a peak at ˜26° with high intensity as a reflection from carbon layers (002). In addition, the reflection positions in the XRD patterns at the angles of 23.51°, 32.18°, 32.9°, 46.4°, 50.1°, 68.16°, 38.73° appeared, which correspond to (110), (101), (111), (200), (002), and (202) planes of MoO₃. Small diffraction peaks of MoO₂, such as (111), (211), (031), (402), and (204) also emerged at 26.5°, 36.1°, 55.2°, 61.3°, 63.3°, and 64.2°, indicating that after reacting under microwave irradiation Mo-precursor with Te-powder partially reduced to MoTe₂ and there was a slight mixture of MoO₂ and MoO₃ (MoOₓ) present in as-produced nanocomposite. In FIG. 9a, there are a few other insignificant peaks that correspond to the unreacted Te-powder (JPCDS no. 65-3370).

To confirm the presence of MoTe₂ and MoOₓ on graphene substrate Raman analysis was performed. The Raman spectra of pure graphene and MoTe₂/graphene are shown in FIGS. 9b-3d. All the significant characteristic peaks for graphene (D, G and 2D bands) are clearly observed in both pure graphene (FIG. 9b) and MoTe₂/graphene composite (FIG. 9c). The characteristic phonon modes of MoTe₂, A_{1g} at 170 cm⁻¹, E¹_{2g} at 234 cm⁻¹, and B¹_{2g} at 289 cm⁻¹ have been observed in FIG. 9d, which confirms the successful formation of the crystalline 2H—MoTe₂. Other peaks at 155 cm⁻¹, 196 cm⁻¹, 216 cm⁻¹, 337 cm⁻¹, 378 cm⁻¹, and 470 cm⁻¹ represent various modes of O—Mo—O and O═Mo═O bonds, which are in good agreement for MoO₃ crystalline phase. The peak at 665 cm⁻¹, 819 cm⁻¹, and 994 cm⁻¹ can be assigned to the Mo₃—O, Mo₂—O, and terminal oxygen (Mo⁶⁺═O) stretching modes, respectively. Unfortunately, the overlapping of 289 cm⁻¹ peak from both MoTe₂ and MoO₃ made it hard to identify the number of layers of MoTe₂ present in the nanocomposite. Nonetheless, high intensity of this peak could be an indication of the formation of few layers of MoTe₂, while from the TEM images (FIG. 1e) 7-8 layers could easily be observed. Although, XRD patterns show both the peaks of MoO₂ and MoO₃, Raman characterizes only the peaks for MoO₃ since MoO₂ could be easily oxidized to MoO₃ in contact of air. These results suggest the presence of molybdenum oxide (MoOₓ) in MoTe₂/graphene composite, which is because of the larger atomic size of tellurium (Te) struggles to replace smaller oxygen (O) atoms from MoOₓ during the microwave-initiated heating.

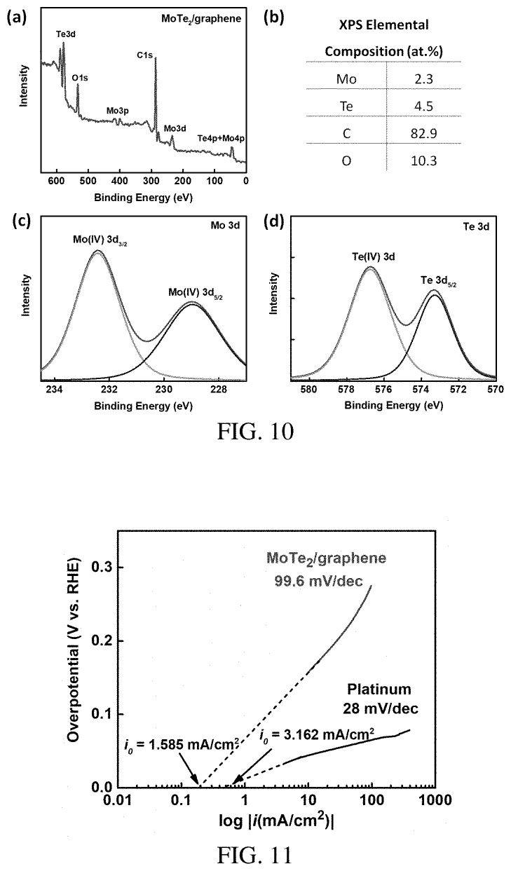

Furthermore, X-ray photoelectron spectroscopy (XPS) was analyzed to further confirm the successful microwave reduction of Mo(VI) in Mo(CO)₆ precursor to Mo(IV) in MoTe₂. The survey spectrum is represented in FIG. 10a for MoTe₂/graphene, and the peaks for carbon (C), molybdenum (Mo), tellurium (Te), and oxygen (O) elements are observed, indicating the presence of MoTe₂, MoOₓ and graphene in the hybrid nanocomposite. FIG. 10b displays the atomic compositions of elements that are similar to the EDS analysis results in addition to displaying the atomic % of 0 that confirms the presence of MoOₓ. The high-resolution XPS spectrum for Mo 3d (FIG. 10c) shows the binding energies of Mo 3d_{5/2} and Mo 3d_{3/2} peaks at 229.4 and 232.7 eV, respectively, which are matched with typical values for Mo (IV) in MoTe₂. For Te 3d spectrum, peaks are observed at 573.1 and 576.9 eV, as shown in FIG. 10d. These can be assigned to Te 3d_{5/2} and Te(IV) 3d, respectively. Another characteristic peak of Te 3d_{3/2} at 583.6 eV is shown in survey spectrum (FIG. 10a), which further signifies the formation of MoTe₂ in as-produced nanocomposite.

### Examples Relating to Microwave-Initiated Synthesis of MoS₂/Graphene-Catalyst for Enhanced Hydrogen Evolution Reaction

Materials and Reagents

Ammonium tetrathiomolybdate ((NH₄)₂MoS₄, 99.95%) was purchased from BeanTown Chemical, Inc. Carbon disulfide (CS₂, liquid, 99.9%), Molybdenum (IV) sulfide (MoS₂˜325 mesh powder, 98%), and Poly (vinylidene fluoride) (PVDF powder, (—CH₂CF₂—)ₙ) were purchased from Alfa Aesar. N, N-Dimethylformamide (DMF, HCON(CH₃)₂) was obtained from Macron Fine Chemicals™. Nitric acid (69-70%), and Acetone (CH₃COCH₃) were supplied by BDH Chemicals, VWR. Sulfuric acid was purchased from Anachemia. All chemicals purchased were used without further treatment or purification. For electrochemical characterizations, platinum (Pt) gauze (100 mesh, 99.9% metal basis) was obtained from Alfa Aesar. Glassy carbon electrode (CHI 104, 3 mm in diameter) was purchased from CH Instruments, Inc. and silver/silver chloride (Ag/AgCl, 3 M KCl, E°=+0.197 V vs. RHE) electrode was acquired from Hach.

Microwave-Initiated Synthesis of MoS₂/Graphene Nanocomposites

MoS₂/graphene compound was prepared by reaction of ammonium tetrathiomolybdate (ATTM) and CS₂ on graphene substrate using microwave-initiated synthesis method. Equal amounts (15 mg each) of ATTM and graphene (weight ratio=1:1) were taken in a glass vial and mixed together homogeneously by a speed mixer at 2000 rpm. After a while, CS₂ solvent (200 μL) was added and mixed well by speed mixer at 2000 rpm. The solvent was evaporated after 10 mins of air drying. Next, the uniform blend of dried ATTM-graphene-CS₂ was subjected to microwave irradiation in a domestic microwave oven (frequency 2.45 GHz, power 1250 W) for 60 seconds. Graphene served as a substrate to absorb the microwave energy and convert it to heat energy. During the process, microwave heating triggered the reduction of ATTM to MoO₂, which then converted to MoS₂ dispersed on graphene substrate, releasing other constituents in gaseous forms. Thus, the synthesis of MoS₂/graphene nanocomposite had taken place within 60 seconds of microwave irradiation.

Material Characterizations

The surface morphologies and chemical compositions of graphene and MoS₂/graphene were characterized by scanning electron microscope (SEM; JEOL 7000 FE), coupled with an energy dispersive X-ray spectrometer (EDS, Oxford Instruments) with an acceleration voltage of 20 kV. The transmission electron microscopy (TEM), high-resolution TEM (HRTEM) and selected area electron diffraction (SAED) experiments were carried out using JEOL JEM-3010 TEM with a LaB6 electron gun operated under 300 kV. Micro-Raman spectroscopy was performed on the samples at room temperature by employing back-scattering geometry using the 442 nm line (80 mW) of a dual wavelength He—Cd laser (Kimmon Electric). The x-ray diffraction (XRD) patterns of MoS₂/graphene was analyzed for MoS₂ crystals by a Bruker D8 Advance x-ray powder diffractometer with Ni filtered CuK α radiation (wavelength, λ=1.5406 Å). Photoemission measurements were performed in a load-locked Kratos XSAM 800 surface analysis system and XPS spectra were recorded in the fixed analyzer transmission (FAT) mode with a pass energy of 80 eV. In addition, nitrogen adsorption isotherms were measured with the aid of Quantachrome's Nova 2200e instrument at 77 K. The Brunauer-Emmett-Teller (BET) method was used to calculate the specific surface area.

Electrochemical Measurements

Before each electrochemical experiment, glassy carbon electrode (GCE) was polished with alumina powder (Al₂O₃, 0.05 μm) on a polishing mat to obtain a mirror-finished surface, followed by immersing in 6 M HNO₃ for 10 mins, rinsing with DI water and vacuum drying. To prepare the working electrode, MoS₂/graphene hybrid catalyst (2 mg) was mixed with PVDF powder (0.2 mg) and DMF (50 μL) to form a homogeneous black slurry. The catalyst slurry was drop-coated onto the clean surface of GCE (0.07 cm²) with a mass loading of ˜5 mg cm⁻², which was then dried in a vacuum dryer at 60° C. for 30 mins. For comparison, GCEs were also coated with pure MoS₂, pure graphene, and a physical mixture of MoS₂ and graphene (MoS₂+graphene) following the same steps. All electrochemical studies were performed using a CH Instrument (CHI 760D) potentiostat using ‘Electrochemical Analyzer’ software (version 15.03) in a standard three-electrode setup consisting of a glassy carbon working electrode, silver chloride electrode (Ag/AgCl, 3 M KCl) as the reference, and platinum (Pt) mesh as a counter electrode in 0.5 M H₂SO₄ electrolyte. To determine the HER activities of samples, the potentials were referred to the reversible hydrogen electrode (RHE) by using the equation: V (vs. RHE)=V (vs. Ag/AgCl)+0.197+(0.059×pH). The electrocatalytic activity of MoS₂/graphene towards HER was examined by polarization curves using linear sweep voltammetry (LSV) at a scan rate of 1 mV s⁻¹ in 0.5 M H₂SO₄ at room temperature. Before each LSV measurement, cyclic voltammetry (CV) was run for 50 cycles to achieve stable condition. CV was also performed to determine active surface area of catalyst samples. Prior to each measurement of LSV and CV, a resistance test was made and the iR compensation was applied using the CHI software. Electrochemical impedance spectroscopic (EIS) measurements were carried out in 0.5 M H₂SO₄ at various overpotentials from 50 mV to 300 mV (vs. RHE) in the frequency range of 10⁻² to 10⁶ Hz with a single modulated AC potential of 5 mV. Afterward, the EIS spectra were fitted by the EC-Lab software.

This work demonstrates the successful synthesis of MoS₂/graphene nanocomposite through an ultrafast, energy-efficient microwave-initiated approach. As produced nanocomposite shows enhanced electrocatalytic behavior for hydrogen evolution reaction, with a low onset potential (100 mV) and a Tafel slope of 43.3 mV per decade. In addition, this MoS₂/graphene-catalyst exhibits a remarkable stability, even at higher operating temperatures (30-120° C.) in acidic medium.

### Examples Relating to Enhancement of Hydrogen Evolution Reaction Activity Using Metal-Rich Molybdenum Sulfotelluride with Graphene Support: A Combined Experimental and Computational Study

Materials and Reagents

Ammonium tetrathiomolybdate ((NH₄)₂MoS₄, 99.95%) precursor was purchased from BeanTown Chemical, Inc. Carbon disulfide (CS₂, liquid, 99.9%), Tellurium (Te) powder (˜325 mesh), and Polyvinylidene fluoride (PVDF) were acquired from Alfa Aesar. N, N-Dimethylformamide (DMF) was purchased from Macron Fine Chemicals™. Graphene was supplied by Magnolia Ridge Inc., and 10 wt. % platinum on carbon (10 wt. % Pt/C) was obtained from Sigma-Aldrich. All chemicals purchased were used as received without further treatment or purification. For electrochemical characterizations, graphite rod (5 mm diameter) was provided by Alfa Aesar. Glassy carbon electrode (CHI 104, 3 mm diameter) was purchased from CH Instruments, Inc. and silver/silver chloride (Ag/AgCl, 3 M KCl, +0.197 V vs. RHE) electrode was acquired from Hach.

Preparation of Catalyst Samples and the Modified GCE

To prepare the MoSₓTe_{y}/Gr hybrid, at first the Mo, S, and Te precursors were mixed homogeneously with graphene in a 20 mL scintillation vial using a speed mixer at 2000 rpm. The effects of different mass ratios of precursors were explored as described in Table 9. Then, the mixture was air dried for 10 mins inside a fume hood. Next, the vial containing uniform mixture was subjected to microwave irradiation at a constant power of 1250 W for 60 seconds for each mixture. During this process, the vial was loosely sealed by a PTFE cap to allow releasing of gaseous residues. A variety of MoSₓTe_{y}/Gr samples were prepared and denoted as MST-1 to MST-4 (Table 9). For comparison, MST-5 and MST-6 samples were prepared by physically mixing the microwave synthesized MoS₂/Gr and MoTe₂/Gr composites. The synthesis procedures of MoS₂/Gr and MoTe₂/Gr are explained in previous studies.

TABLE 9
MoSₓTe_{y}/Gr nanocomposites with different precursor ratios.

| MoSₓTe_{y}/Gr | (NH₄)₂MoS₄ | Te powder | CS₂ | Graphene |
|---|---|---|---|---|
| Samples | (mg) | (mg) | (μL) | (mg) |
| MST-1 | 10 | 20 | 100 | 10 |
| MST-2 | 10 | 10 | 100 | 10 |
| MST-3 | 20 | 10 | 100 | 10 |
| MST-4 | 10 | 5 | 100 | 10 |

| | |
|---|---|
| MST-5 | Physical mixture of MoS₂/Gr and MoTe₂/Gr |
| | (wt. ratio, 1:1) |
| MST-6 | Physical mixture of MoS₂/Gr and MoTe₂/Gr |
| | (wt. ratio, 2:1) |

To prepare the catalyst coating, a mixture of 100 mg composite and 10 mg PVDF powder were suspended in 5 mL DMF solvent, following 20 min of probe sonication. The GCE surface (0.07 cm²) was sequentially polished with 0.3- and 0.05-mm alumina slurries, and then rinsed with DI water and acetone for 1 min. Finally, 20 μL of the suspension was added to the GCE surface and dried in a vacuum dryer for 30 mins at 60° C., which results a mass loading of ˜1 mg cm⁻² for each catalyst sample.

Material Characterizations Techniques

X-ray photoelectron spectroscopy (XPS) was investigated on a Kratos Axis Ultra DLD spectrometer using a monochromatic Al Kα radiation (hv=1486.6 eV) under UHV condition (<8×10⁻¹⁰ Torr), to determine the chemical state and surface composition of various elements in MoSₓTe_{y}/Gr-composite. The morphology and chemical compositions were characterized by scanning electron microscope (SEM; Apreo FE) coupled with an energy dispersive X-ray spectrometer (EDS, EDAX Instruments) using an acceleration voltage of 20 kV. In addition, a FEI Tecnai F20 transmission electron microscope (TEM) was used for structural and chemical analysis of the powder samples, operated at 200 kV and equipped with an EDAX EDS detector and GIF (Gatan Image Filter) Tridiem 863 electron energy loss spectroscopy (EELS) system. Moreover, to investigate the phase and crystal structure of MoSₓTe_{y}/Gr-composite, the powder X-ray diffraction (XRD) patterns were collected on a Philips X'pert MPD diffractometer with Cu Kα radiation (λ=1.54056 Å) at 45 kV and 40 mA.

Electrochemical Measurements Techniques

Electrochemical experiments were performed with CH Instrument (CHI 760D) and Arbin Instrument (version 4.21) in a typical three-electrode system. This setup consists of an active material-coated glassy carbon electrode (GCE) as working electrode with a mass loading of ˜1 mg cm⁻², Ag/AgCl electrode as reference, and graphite rod as a counter electrode in 0.5 M H₂SO₄ electrolyte. In order to compare the HER activities, the potentials were converted to reversible hydrogen electrode (RHE) based on the equation: V (vs. RHE)=V (vs. Ag/AgCl)+0.197+(0.059×pH) at room temperature (˜25° C.). The electrocatalytic activities and corresponding mechanisms were determined by performing linear sweep voltammetry (LSV), cyclic voltammetry (CV), electrochemical impedance spectroscopy (EIS), and constant potential tests. The EIS spectra were further fitted by the EC-Lab software.

Computational Methodology

The computational study has been carried out using periodic plane-wave density functional theory (DFT) with the Cambridge Serial Total Energy Packages (CASTEP). For the level of theory, spin polarized generalized gradient approximation (GGA) with Perdew-Burke-Ernzerhof (PBE) functional has been used with Kohn-Sham orbitals with an energy cutoff of 400 eV. The effect of the core electrons has been represented with the Vanderbilt Ultrasoft Pseudopotentials (USPP) method. To address the nonbonded interactions of the nanocomposites, a semi-empirical dispersion energy correction is utilized by the method of Tkatchenko and Scheffler (TS). In all geometry optimization calculation, two-point steep gradient displacement (TPSD) algorithm is used. For the dipole correction, self-consistent scheme has been applied. Relativistic treatment has been done with Koelling-Harmon Scalar method.

In this computational analysis, multiple types of molybdenum sulfotelluride/graphene nanocomposite systems have been studied, as shown in FIG. 39. Initially, a Mo₉S₈Te₁₀/Gr composite structure was constructed, with stoichiometric ratio between molybdenum and chalcogen atoms in the nanoparticle. The three additional systems have been designed to be comprised of more molybdenum atoms than the stoichiometric ratio. The Mo₉S₈Te₁₀/Gr composite structure was generated by constructing a supercell model of Mo₉S₈Te₁₀ supported on a 7×7×1 graphene basal plane. To create the Mo₉S₈Te₁₀ nanoparticles, initially a Mo₉Te₁₈ nanoparticle was created from the previously optimized geometry in the solid-state hexagonal MoTe₂ lattice. Subsequently, eight Te atoms were replaced with eight S atoms in a random sequence.

For the Mo₉S₈Te₁₀ nanoparticle, the (011̅0) plane best represents the exposed chalcogen edge, and similarly the (101̅0) plane best represents the exposed Mo edge. After the geometry optimization calculation of the Mo₉S₈Te₁₀/Gr structure, a Mo₉S₆Te₇/Gr nanocomposite structure was constructed by systematically removing one Te atom from the bottom layer of the exposed Mo edge (101̅0 plane), one Te atom from the upper layer of the chalcogen edge (011̅0 plane), one S atom from the upper layer of the chalcogen edge (101̅0 plane), and one S and one Te atoms from the chalcogen corner site. To capture the trends in these experimental results (FIGS. 41a and 41b), two types of Mo₉S₄Te₅/Gr model systems were considered with a similar atomic ratio as experiments (1:0.46:0.58≈9:4:5). The nanoparticles Mo₉S₄Te₅ were constructed using the same methodology. Two types of nanoparticles were constructed. In Type-1, all of the Mo atoms were kept on the upper layer with chalcogen atoms adjacent to the graphene. In Type-2, all of the chalcogen atoms were kept on the upper layer with the Mo atoms adjacent to the graphene.

After the geometry optimization, the structure of Type-1 Mo₉S₄Te₅ nanoparticle showed significant curvature with the upward movement of chalcogenide atoms as the Mo atoms favored Mo—Mo bond formation to minimize total energy; as a result, the Type-1 structure showed no distinguishable Mo corners or Mo edges. This geometric distortion of the 2-D shape in the Type-1 structure was not observed in the Type-2 structure, where the graphene support served a more significant role in conserving the 2-D structure of the nanoparticle. A vacuum space of 20 Å has been used between vertically repeated composite models for all the systems. For all constructed nanocomposites in this study, the Brillouin zones have been sampled by a 2×2×1 k-point grid generated using Monkhorst-Pack scheme. The convergence criteria for energy were set to 2×10⁻⁵ eV per atom and for displacement, this tolerance was set to 0.002 Å.

Material Synthesis and Characterization

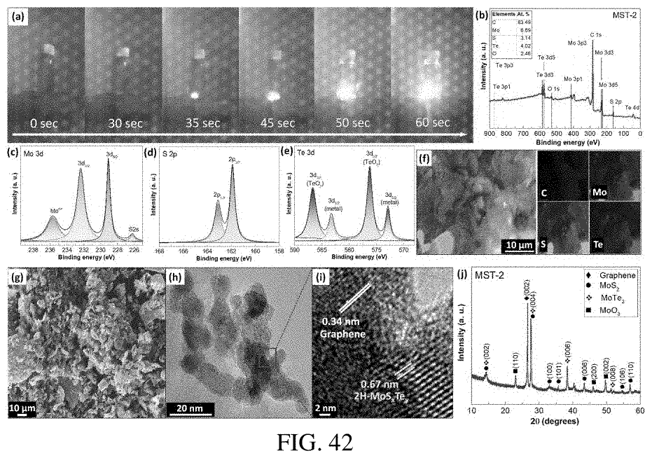

During the synthesis process, within almost 30 seconds of microwave irradiation the mixture of precursors with graphene sparks a fiery glow by forming a splendid plasma. As shown in FIG. 42a, the glowing spark continues to grow with time. After 60 seconds of microwave irradiation, the glass vial was taken out from microwave oven and the as-prepared composites were collected and examined for further characterizations. In some cases, a thin film of material adheres to the surface of vial wall, which is also scratched out using a spatula. During the reaction, the strong interaction between graphene and electromagnetic radiation takes place to achieve fast thermal decomposition of precursors. Then the hybrid composite of MoSₓTe_{y} formed and uniformly dispersed on graphene network. Although the exact nature of the interactions between electromagnetic waves and reaction precursors is somewhat unclear and speculative, the quality of products can be controlled via optimizing several reaction parameters (microwave power, heating time, precursors ratio etc.). Due to the best HER activities displayed by MST-2 sample among all of the prepared hybrid samples, MST-2 has been chosen for material characterizations.

The compositions and binding energies of MST-2 hybrid were examined by XPS. The XPS full spectrum (FIG. 42b) discloses the present of four principal elements of carbon (C), molybdenum (Mo), sulfur (S), and tellurium (Te), and a small peak of oxygen (O), with an atomic ratio of Mo:S:Te 1:0.46:0.58. Therefore, the MST-2 is signified as MoS_{0.46}Te_{0.58}/G composite for further characterizations. The XPS spectrum of Mo 3d (FIG. 42c) is dominated by two peaks corresponding to the 3d_{5/2} (229.1 eV) and 3d_{3/2}, (232.3 eV), implying Mo⁴⁺ characteristics. Additionally, a weak peak at 226.2 eV is ascribed to S 2s orbital of MoS₂. Another peak appears at ˜235 eV, which corresponds to Mo′ (likely MoO₃). From FIG. 42d, one can see that the peaks of S 2p_{3/2}, and S 2p_{1/2} appeared at 161.9 and 163.1 eV, which confirms the presence of S²⁻ with a slight shift of typical binding energies (161.3 and 162.1 eV, respectively) for MoS₂. This indicates the ratio of Mo and S atoms differs from typical 1:2 value. The XPS peaks at 572.9 and 583.3 eV (FIG. 42e) are attributed to Te 3d_{5/2} and Te 3d_{3/2}, respectively. Two additional peaks at 576.2 and 586.6 eV are ascribed to TeO2.

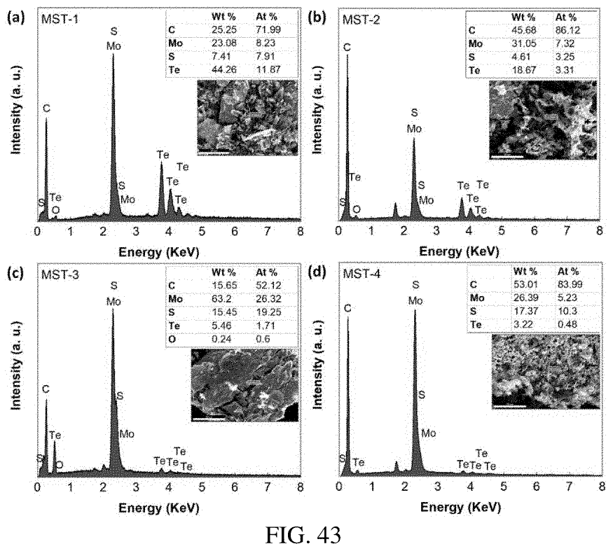

The EDS mapping (FIG. 42f) clearly suggests that C, Mo, S and Te elements coexist in the MoS_{0.46}Te_{0.58}/Gr nanosheet, and these elements distribute homogeneously throughout the whole nanosheet. Moreover, the structural morphology of MoS_{0.46}Te_{0.58}/Gr hybrid was surveyed by SEM. The as-synthesized composite exhibits nanosheet-like architecture with uniform rough surfaces, and those nanosheets were grown on graphene network intertwined with each other (FIG. 42g). Such unique heterostructure would increase the density of active sites and promote the electron/charge transfers. In addition, the TEM images displayed in FIGS. 42h and 42i confirm both MoS_{0.46}Te_{0.58} and graphene have a thin and layered sheet structure, which are in agreement with SEM images. As illustrated in FIG. 42i, the well-resolved lattice fringes reveal that the distinguished lattice spacings are around 0.34 nm and 0.67 nm, which are consistent with the (002) planes of graphene and MoS_{0.46}Te_{0.58}, respectively. Furthermore, the phase information of MoS_{0.46}Te_{0.58}/Gr hybrid was characterized by XRD. As shown in FIG. 42j, the signal from graphene is observed at 26.0°. The diffraction peaks at 20 of 14.4°, 27.5°, 33.1°, 35.7°, 43.4°, 54.6°, and 56.9° are ascribed respectively to the (002), (004), (100), (101), (006), (106) and (110) planes, respectively, corresponding to hexagonal 2H—MoS₂ structure (JPCDS No. 37-1492). The diffraction peaks around 14.4°, 27.5°, 38.4°, and 52.7° correspond to (002), (004), (006), and (008) planes, which can be indexed to the standard hexagonal 2H—MoTe₂ structure (JPCDS no. 15-0658). In addition, the reflection positions in the XRD patterns at the angles of 23.1°, 46.0°, and 49.7° appeared, which correspond to (110), (200), and (002) planes of MoO₃, respectively. These results indicate the presence of MoO₃ in as-synthesized MoS_{0.46}Te_{0.58}/Gr nanohybrid. A few of other insignificant peaks also appeared in the XRD pattern of MST-2 sample, which correspond to the unreacted particles of Mo and Te. Moreover, the EDS results (FIG. 43) reveal the elemental analysis of Mo, S and Te components for MST-1, MST-2, MST-3, and MST-4 samples. Noticeably, the atomic ratio of MST-2 is found as Mo:S:Te 1:0.44:0.45, which is very similar to the findings from XPS investigations.

Investigations of HER Performance

The electrocatalytic HER activities of samples MST-1 to MST-6 were investigated by linear sweep voltammograms (LSVs) in an acidic electrolyte of 0.5 M H₂SO₄. The iR corrected-LSVs are shown in FIG. 41a, where MST-2 displays the best catalytic behavior with the smallest overpotential (η) of 62.2 mV vs. RHE to reach the cathodic current density of 10 mA cm⁻². As displayed in FIG. 41b, the order of HER activity based on η is MST-2>MST-1>MST-5>MST-6>MST-3>MST-4. It clearly indicates, the ratio of molybdenum sulfide to molybdenum telluride is crucial to the catalytic ability and it is found that too much of sulfur does not favor the hydrogen evolution (for MST-3 and MST-6, see Table 9 and FIG. 43). On the other side, the best results are found from the samples containing almost equal ratio of S and Te (MST-2, MST-5) or sample with a little high amount of Te (MST-1). Among these samples, MST-1 may have contained some unreacted Te-powder, and the physical mixture of MST-5 may not have a fully interconnected network in crystal structure, which limit their catalytic performances. In addition, as shown in FIG. 43(d), MST-4 contains a very small amount of active catalyst comparing to the high amount of graphene present in the sample, thus does not show good HER activity. Consequently, MST-2 exhibits the best combination of molybdenum sulfide and molybdenum telluride ratio on graphene network and is further studied for electrocatalytic behaviors, which is renamed as ‘MoS_{0.46}Te_{0.58}/Gr’ based on the XPS elemental results.

The HER activity of MoS_{0.46}Te_{0.58}/Gr nanocomposite was compared with bare GCE, graphene, MoS₂/Gr, MoTe₂/Gr, and 10 wt. % Pt/C catalyst samples based on LSV curves (FIG. 41c). The observed overpotentials (η) for these samples are displayed in FIG. 41d and it clearly indicates that MoS_{0.46}Te_{0.58}/Gr catalyst emerges with a smaller overpotential than those of MoS₂/Gr and MoTe₂/Gr samples. The η of MoS_{0.46}Te_{0.58}/Gr is around only 62.2 mV at 10 mA cm⁻², and the cathodic current density rises promptly with an increase in η. In comparison, both MoS₂/Gr and MoTe₂/Gr exhibit higher overpotential, approximately 197.2 and 167.1 mV, respectively. In contrast, bare GCE and graphene does not show any catalytic activity. Furthermore, the Tafel diagrams were derived from LSVs by fitting the linear sections to the Tafel equation (η=a+b log i), where η is overpotential, a is a constant, b is the Tafel slope and i represents the cathodic current density. Tafel slope can reveal the rate-determining step (RDS) during hydrogen generation.

As a result of applying sufficient potential at specific reaction condition, the HER takes place through an adsorption step (Volmer, H⁺+e⁻→H_{ads}, 120 mV dec⁻¹), following by a reduction step (Heyrovsky, H⁺+H_{ads}+e⁻→H₂, 40 mV dec⁻¹ or Tafel, 2H_{ads}→H₂, 30 mV dec⁻¹). Tafel step is the fastest reaction in HER, therefore it is noticeable that the smaller Tafel slope favors HER activities. From the present results shown in FIG. 41e, MoS_{0.46}Te_{0.58}/Gr exhibits a Tafel slope of 61.1 mV dec⁻¹, which combines both outcomes from MoS₂/Gr (54.2 mV dec⁻¹) and MoTe₂/Gr (99.4 mV dec⁻¹). Moreover, it suggests that the Volmer-Heyrovsky reaction mechanism dominates in the HER process of MoS_{0.46}Te_{0.58}/Gr. In addition, the exchange current densities (i₀) are also measured following the Tafel slope extrapolation method, and all the key parameters of HER performance are displayed in Table 10.

TABLE 10
The major HER parameters of all catalyst samples.

| | Over- | | | | |
|---|---|---|---|---|---|
| | potential | | i₀ (A | | |
| | (mV | Tafel slope | cm⁻²) | Rₛ | R_{ct} |
| Samples | vs. RHE) | (mV dec⁻¹) | × 10⁻³ | (Ohm) | (Ohm) |
| Bare GCE | >400 | — | — | 15.6 | 1124.1 |
| Graphene | >350 | — | — | 15.0 | 1006.3 |
| MoS₂/Gr | 197.2 | 54.2 | 0.075 | 8.5 | 811.5 |
| MoTe₂/Gr | 167.1 | 99.4 | 0.194 | 9.5 | 490.7 |
| MoS_{0.46} | 62.2 | 61.1 | 0.694 | 7.3 | 145.6 |
| Te_{0.58}/Gr | | | | | |
| 10 wt. % | 47.7 | 32.1 | 1.882 | 6.9 | 111.4 |
| Pt/C | | | | | |

The kinetics of hydrogen evolution process were further investigated by electrochemical impedance spectroscopy (EIS) measurements. FIG. 41f represents the Nyquist plots of bare GCE, graphene, MoS₂/Gr, MoTe₂/Gr and MoS_{0.46}Te_{0.58}/Gr at a given overpotential of 150 mV, and corresponding Rₛ and R_{ct} values are displayed in Table 10. Here, a small internal resistance (Rₛ) of 7.3Ω for MoS_{0.46}Te_{0.58}/Gr indicates that the intrinsic resistance of electrode material and ionic resistance of electrolyte is much low for the hybrid MoS_{0.46}Te_{0.58}/Gr system. In the high-frequency zone, it exhibits one capacitive semicircle, indicating that the reaction is kinetically controlled. This semicircle represents the charge transfer process at the interface between the electrolyte and the catalytic electrode, which is composed of the charge transfer resistance (R_{ct}) and the double layer capacitance (C_{dl}). The lower value of R_{ct} represents faster charge transfers in the electrode, resulting rapid reaction in the electrocatalytic kinetics. The low-frequency inclined line signifies the Warburg impedance (Z_{W}) for the diffusion process of H⁺ ions through active materials, which is prominently shown for only MoS_{0.46}Te_{0.58}/Gr hybrid. As shown in FIG. 41f and Table 10, a small R_{ct} of 145.6Ω can be found for MoS_{0.46}Te_{0.58}/Gr, which indicates a higher conductivity and faster electron transfer process, and further explains the higher HER activity of MoS_{0.46}Te_{0.58}/Gr catalyst.

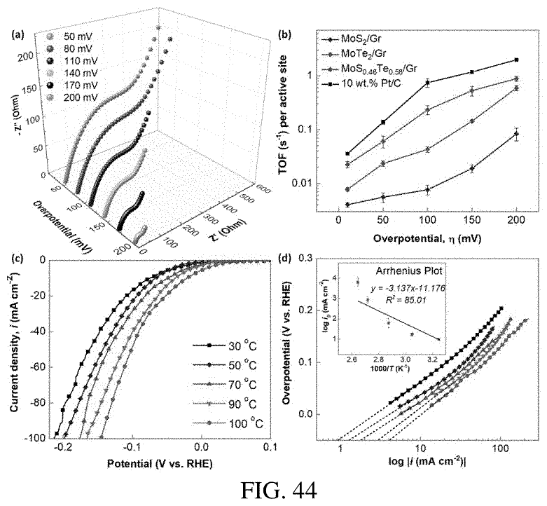

FIG. 44a represents the Nyquist plots of MoS_{0.46}Te_{0.58}/Gr at various overpotentials (50-200 mV). The Rₛ and R_{ct} values are summarized in Table 11 as measured.

TABLE 11
Rₛ and R_{ct} values of MoS_{0.46}Te_{0.58}/Gr at
the potential range of 50-200 mV.

| η (mV) | Rₛ (Ohm) | R_{ct} (Ohm) |
|---|---|---|
| 50 | 10.9 | 713.2 |
| 80 | 10.3 | 448.6 |
| 110 | 10.2 | 310.2 |
| 140 | 10.3 | 169.6 |
| 170 | 9.9 | 71.4 |
| 200 | 9.9 | 15.5 |

As expected, the R_{ct} diminishes markedly with the increasing of η, resulting in the acceleration of the hydrogen evolution process. Next, the turnover frequency (TOF) was analyzed at the η of 10-200 mV. TOF is defined as the number of hydrogen molecules evolved on an active site per 1 second. Assuming the cathodic current is entirely attributed to the HER, the TOF can be calculated from the following equation:

$$TOF = \frac{No . of total hydrogen turn overs / {cm}^{2} geometric area}{No . of active sites / {cm}^{2} geometric area} \qquad ( 5 )$$

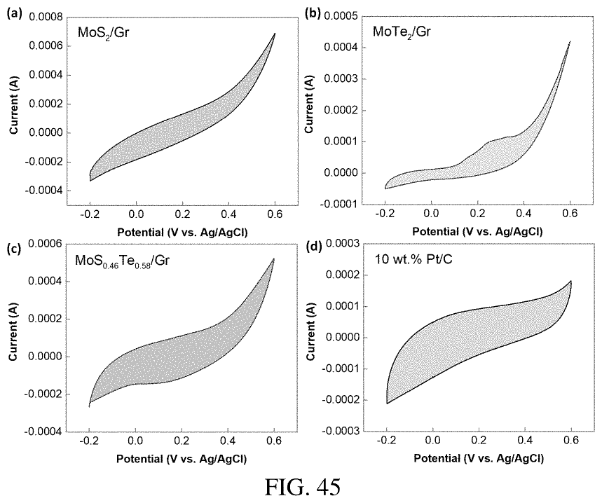

In this study, the number of active sites and TOF of catalyst samples were calculated based on the electrochemical approach through CV measurements in phosphate buffer (pH=7) at a scan rate of 10 mV s⁻¹ (FIG. 45), based on a general method mentioned by Dai et al. (ACS Appl. Mater. Interfaces 2015, 7 (49), 27242-27253). As shown in FIG. 44b and Table 12, at η=150 mV, The TOF of 10 wt. % Pt/C, MoS_{0.46}Te_{0.58}/Gr, MoS₂/Gr, and MoTe₂/Gr catalysts are estimated as 1.17, 0.53, 0.02, and 0.14 s⁻¹, respectively. These results clearly support the higher HER activity of as-produced MoS_{0.46}Te_{0.58}/Gr hybrid comparing to the single components (MoS₂/Gr and MoTe₂/Gr). To demonstrate the stability at high temperatures and to measure the apparent activation energy (Eₐ) of MoS_{0.46}Te_{0.58}/Gr, the LSV tests were performed at a wide range of temperature (FIG. 44c) in 0.5 M H₂SO₄.

TABLE 12
Turn over frequency (TOF, s⁻¹) values at different overpotentials.

| Samples | 10 mV | 50 mV | 100 mV | 150 mV | 200 mV |
|---|---|---|---|---|---|
| 10 wt. % Pt/C | 0.03578 | 0.13760 | 0.74305 | 1.17420 | 1.97597 |
| MoS_{0.46}Te_{0.58}/Gr | 0.02248 | 0.06063 | 0.23238 | 0.52820 | 0.88492 |
| MoS₂/Gr | 0.00404 | 0.00556 | 0.00765 | 0.01898 | 0.08341 |
| MoTe₂/Gr | 0.00777 | 0.02344 | 0.04294 | 0.14337 | 0.59067 |

As summarized in Table 13, the overpotentials gradually decrease from 66.2 mV to 25.3 mV with the increase in operating temperature from 30 to 100° C., enabling faster ion and electron transfer at higher temperatures. In addition, the corresponding exchange current densities (i₀) were measured from the Tafel slopes (FIG. 44d) and Table 13 summarizes the electrochemical parameters (η and i₀) at different temperatures. Based on these results, the Eₐ

$$log {i}_{0} = l o g A - \frac{{E}_{a}}{2.3 RT} ,$$

was measured by Arrhenius equation: which is one of the major key factors to determine the efficiency of HER electrocatalyst for H₂ production. Here, A is the pre-exponential factor, R is the universal gas constant (8.314 J K⁻¹ mol⁻¹) and T is absolute

$$log ( i o ) vs . \frac{1000}{T}$$

temperature (K). The Arrhenius plot of is displayed in inset of FIG. 44d, from which Eₐ was calculated as 59.85±12.33 kJ mol⁻¹. Such an energy barrier may be due to the combination effect of water splitting to H⁺ and OH⁻ ions, H⁺ adsorption and desorption on cathode, and cluster of H₂ bubbles formation.

TABLE 13
Electrochemical measurements of MoS_{0.46}Te_{0.58}/Gr catalyst at different
temperatures.

| | Overpotential, | Exchange current | |
|---|---|---|---|
| Temperature | η (mV) at | density, i₀ (mA | Activation energy, |
| (° C.) | −10 mA cm⁻² | cm⁻²) | Eₐ (kJ mol⁻¹) |
| 30 | 66.2 | 0.9 | 59.85 ± 12.33 |
| 50 | 62.3 | 1.2 | |
| 70 | 49.7 | 1.8 | |
| 90 | 38.2 | 2.9 | |
| 100 | 25.3 | 3.8 | |

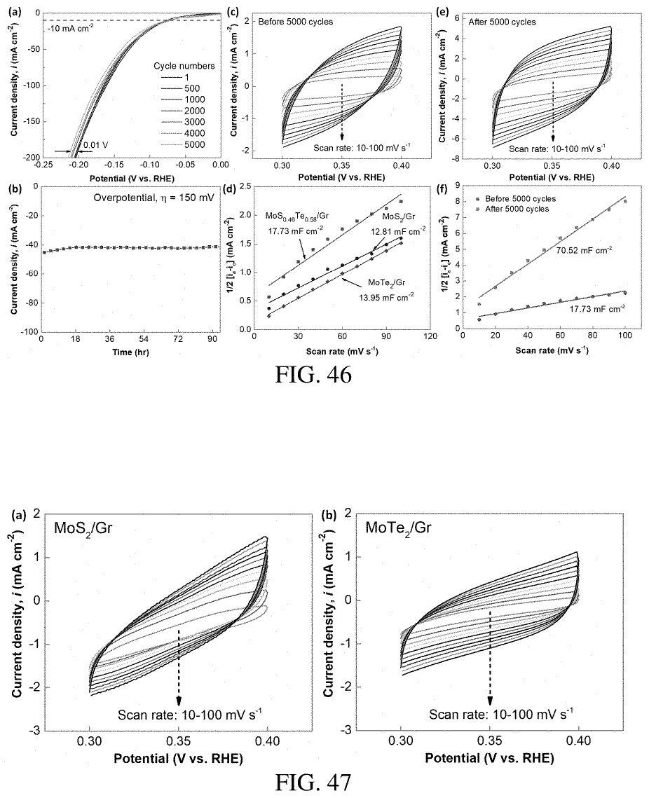

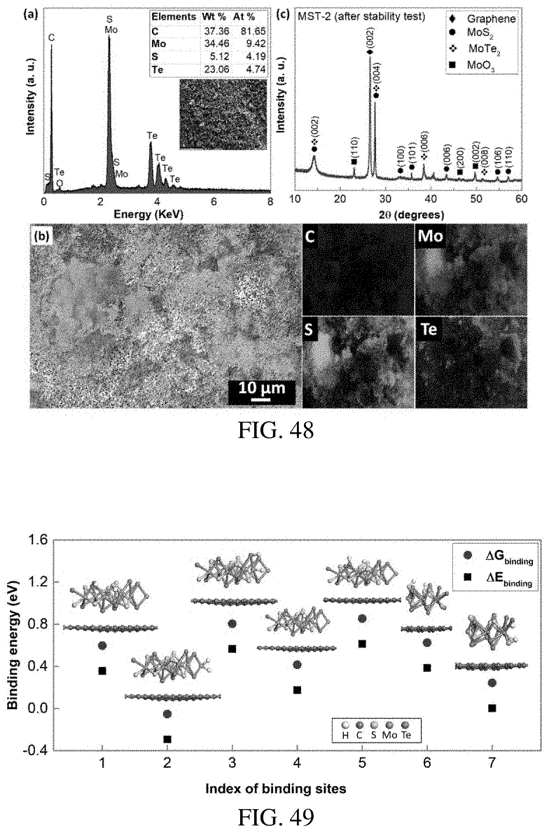

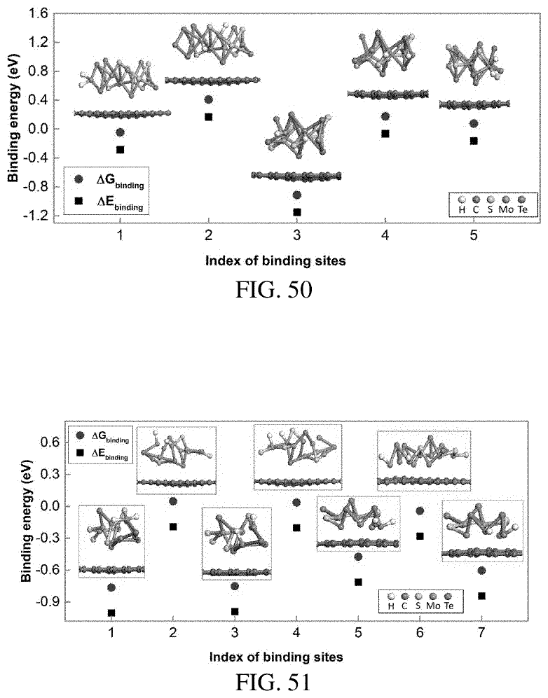

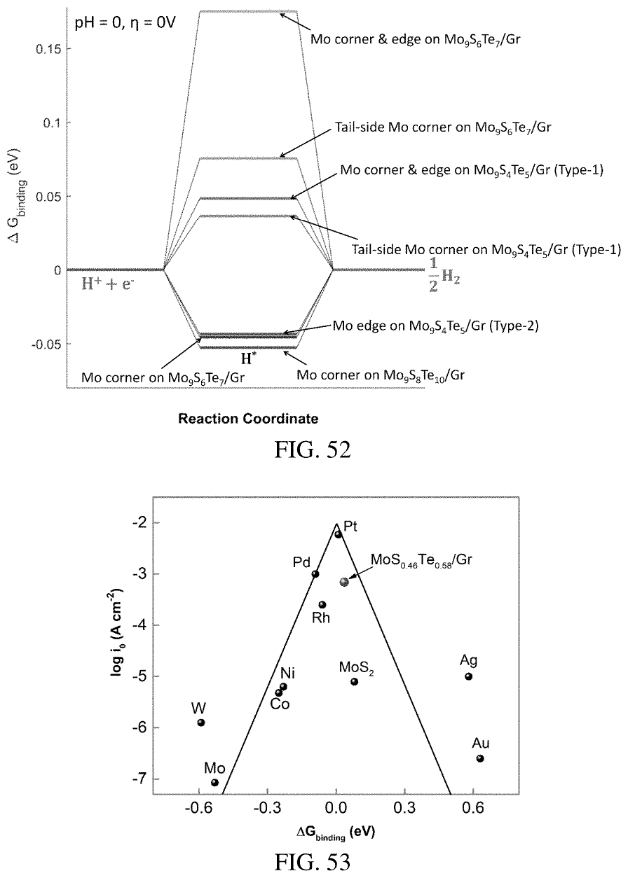

Finally, a continuous cycling test was carried out for 5000 cycles at a scan rate of 50 mV s⁻¹ to determine the long-term durability of MoS_{0.46}Te_{0.58}/Gr catalyst. Their polarization curves are displayed in FIG. 46a within a potential range of 0 to −0.25 V vs. RHE. The polarization curves show slight changes after 5000 cycles, resulting an overpotential (η) shift of only 10 mV at high current density of −200 mA cm². Additionally, a chronoamperometric curve was obtained at the η of 150 mV, which is presented in FIG. 46b. This constant potential test exhibits almost no degradation in the cathodic current density (around −45 mA cm⁻²) for over 90 h of electrolysis. It suggests the remarkable stability of MoS_{0.46}Te_{0.58}/Gr during the HER process, which can well be attributed to compositional and structural stability of MoS_{0.46}Te_{0.58}/Gr heterostructure supported by graphene network. Moreover, the electrochemical double-layer capacitance (Cal) was measured to evaluate the electrochemically active surface area (ECSA) of MoS_{0.46}Te_{0.58}/Gr hybrid. The ECSA value is supposed to be linearly proportional to the value of Cal, which can be derived by CV measurements. FIGS. 46c and 46e exhibit the non-faradaic CV curves for MoS_{0.46}Te_{0.58}/Gr catalyst before and after the cycling stability tests for 5000 cycles, respectively. As shown in FIG. 46d, the variation of average capacitive currents, ½(iₐ−i_{c}) are displayed with respect to the scan rate for MoS₂/Gr, MoTe₂/Gr and MoS_{0.46}Te_{0.58}/Gr catalyst samples. Corresponding CV curves of MoS₂/Gr and MoTe₂/Gr are included in FIG. 47. The value of Cal is estimated from the slope of the plots, where MoS_{0.46}Te_{0.58}/Gr yields the highest Cal of 17.73 mF cm⁻² comparing with those of MoS₂/Gr (12.81 mF cm⁻²) and MoTe₂/Gr (13.95 mF cm⁻²), implying the highest exposure of efficient active sites for the enhanced HER performance. Additionally, as shown in FIG. 46f, Cal of MoS_{0.46}Te_{0.58}/Gr increases almost four times, resulting the value of 70.52 mF cm⁻² after 5000 cycles of HER test. This phenomenon indicates an improvement in active sites of the material due to the H₂ bubbling from catalyst surface, creating more defects in nanosheets. The elemental and structural analyses of MoS_{0.46}Te_{0.58}/Gr were further examined after stability test (FIG. 48), where the results clearly show insignificant degradation of active material after 5000 cycles. The atomic ratio retains almost similar as initial and MoS_{0.46}Te_{0.58} nanosheets remain uniformly embedded in graphene network.

The above results unambiguously reveal that the MoS_{0.46}Te_{0.58}/Gr nanocomposite acquires improved HER activity in comparison to either MoS₂/Gr or MoTe₂/Gr. The superior HER performance can be considered from the combination of molybdenum sulfide and molybdenum telluride presents a synergistic effect on graphene network, assembling the intrinsic properties of the two components. Therefore, more active sites have been exposed due to the surface defects and shorten the electron transfer pathways. Additionally, the stable connection between MoS_{0.46}Te_{0.58}/Gr nanostructure and graphene can further markedly accelerate the electron transfer ability, favoring the much enhanced HER performance and stability for long-term tests. From this study, it has also been demonstrated that Mo-rich nanocomposites with the slight increase in Te fraction (or conversely reduction of S) in the hybrid nanostructure is associated with better catalytic performances. A comparison of previous studies of HER activities on TMC-based ternary compounds with MoS_{0.46}Te_{0.58}/Gr is described in Table 14. In contrast with facile, ultra-fast (e.g., 60 sec) microwave-assisted synthesis performed in this study, other compounds were synthesized by different complex approaches. Moreover, it is clear that the present material exhibits better catalytic performance with lower overpotential and a small Tafel slope.

TABLE 14
Comparison of electrochemical activities of MoS_{0.46}Te_{0.58}/Gr catalyst with
previously reported similar TMC-based hybrid compounds.

| | | | Over | | |
|---|---|---|---|---|---|
| | | | potential | Tafel | |
| | | | at 10 mA | slope | |
| | | | cm-2⁻² | [mV | |
| | Synthesis | | [mV vs. | per | |
| Materials | approach | Electrolyte | RHE] | decade] | Ref. |
| MoSe₂/MoS₂ | Hydrothermal | 0.5M | 162 | 61 | Chem. Eng. J. |
| | | H₂SO₄ | | | 2019, 359 |
| | | | | | (November |
| | | | | | 2018), 1419-1426 |
| MoSe_{0.17}Te_{1.83} | Molecular beam | 0.5M | 45 | 64 | Adv. Energy |
| | epitaxy | H₂SO₄ | | | Mater. 2018, 8 |
| | | | | | (20), 1-8 |
| MoSSe | Solution method | 0.5M | 164 | 48 | ACS Catal. 2015, |
| | | H₂SO₄ | | | 5 (4), 2213-2219 |
| MoS₂ₓSe₂₍₁₋ₓ₎ | Hydrothermal | 0.5M | 136 | 50 | ChemCatChem |
| | | H₂SO₄ | | | 2019, 11(14), |
| | | | | | 3200-3211 |
| SeMoS | CVD | 0.5M | >200 | — | ACS Nano 2017, |
| | | H₂SO₄ | | | 11 (8), 8192-8198 |
| Te-doped WS₂ | CVD | 0.5M | 213 | 94 | J. Catal. 2020, |
| | | H₂SO₄ | | | 382, 204-211 |
| MoSeₓS₂₋ₓ | Electrochemical | 1M KOH | 123 | 123 | Nanoscale 2019, |
| | exfoliation | | | | 11 (35), 16200- |
| | | | | | 16207 |
| Mo(S₁₋ₓSeₓ)₂ | Hydrothermal | 0.5M | 161 | 42.8 | ChemCatChem |
| | | H₂SO₄ | | | 2019, 11 (8), |
| | | | | | 2217-2222 |
| MoS₂/WTe₂ | CVD, | 0.5M | 140 | 40 | Small 2019, 15 |
| | solvothermal | H₂SO₄ | | | (19), 1-11 |
| W(SeₓS₁₋ₓ)₂ | EChem | 0.5M | 45 | 59 | ACS Energy Lett. |
| | anodization, | H₂SO₄ | | | 2017, 2 (6), |
| | CVD | | | | 1315-1320 |
| MoS_{0.46}Te_{0.58}/Gr | Microwave | 0.5M | 62.2 | 61.1 | present work |
| | irradiation | H₂SO₄ | | | |

Computational investigation of binding energetics to evaluate HER activity

For the computational study, multiple hydrogen adsorption sites on each of the molybdenum sulfotelluride/graphene nanocomposites were investigated for binding energetics. For the Mo₉S₈Te₁₀/Gr nanocomposite structure, these binding sites consist of chalcogen and Mo atoms. For the Mo₉S₆Te₇/Gr and Mo₉S₄Te₅/Gr (Type-1 and Type-2) structures, the binding sites are primarily comprised of exposed Mo atoms, since the sites associated with Mo atoms possessed the lowest binding energies for the Mo₉S₈Te₁₀/Gr structure. For each of these sites, the effective binding electronic energy for a single hydrogen atom on the nanoparticle supported by the graphene has been calculated using the equation 6 shown above.

Here E_{2H*+Nanocomposite} is the total electronic energy of the two hydrogen atoms bound to the nanoparticle-graphene composite, E_{Nanocomposite} is the total electronic energy of only nanoparticle-graphene composite, and E_{H}_{₂} is the electronic energy of a hydrogen molecule placed in 17.2 Å×17.2 Å×20 Å vacuum hexagonal unit cell. Binding free energy (ΔG_{Binding}) which is a more appropriate descriptor for the catalytic activity than electronic energy alone, has been calculated using the generalized expression for HER catalysis developed by Nørskov and coworkers shown in equation 7 above.

For the Mo₉S₈Te₁₀/Gr nanocomposite structure, the binding electronic energy values range from −0.292 eV to 0.565 eV, and the binding free energy values range from the −0.052 eV to 0.805 eV (FIG. 6 and Table 15, respectively). The exposed Mo corner site exhibits the most thermoneutral free energy change (−0.052 eV)—that is, the lowest absolute value of binding free energy (|ΔG_{Binding}|). Thus, the Mo corner is the most optimal catalytic active binding site for hydrogen evolution according to the Sabatier Principle for this nanocomposite structure.

TABLE 15
Theoretically calculated binding energies (ΔE_{binding} and ΔG_{binding}) of
hydrogen atoms on a number of
adsorption sites of Mo₉S₈Te₁₀/Gr composite.

| | Binding sites | ΔE_{binding} (eV) | ΔG_{binding} (eV) |
|---|---|---|---|
| 1 | Chalcogen Edge (Vicinal) | 0.357 | 0.597 |
| 2 | Mo Corner | −0.293 | −0.053 |
| 3 | Mo and Chalcogen Edge (Ch = Te) | 0.565 | 0.805 |
| 4 | Mo and Chalcogen Edge (Ch = S) | 0.175 | 0.415 |
| 5 | Chalcogen Top (Ch = Te and S) | 0.614 | 0.854 |
| 6 | Chalcogen Top (Ch = S) | 0.385 | 0.625 |
| 7 | Chalcogen Corner | 0.003 | 0.243 |

Based on the results of the Mo₉S₈Te₁₀/Gr nanocomposite structure, an additional Mo₉S₆Te₇/Gr nanocomposite structure was constructed with more exposed Mo corner sites by systematically removing chalcogen atoms from the Mo₉S₈Te₁₀ nanoparticle. For this nanocomposite, only Mo-based binding sites are considered for the calculation based on learnings from the previous structure of stoichiometric ratio. The resultant binding electronic energy values range from −1.153 eV to 0.169 eV, and the range of binding free energy values is from −0.046 eV to 0.409 eV (FIG. 7 and Table 16, respectively). For the Mo₉S₆Te₇/Gr structure, three adsorption sites are found that have near zero binding free energy values (ΔG_{Binding}≈0): (i) the exposed Mo corner, (ii) the exposed tail-side Mo corner, and (iii) the bridge site between a Mo corner atom and a Mo edge atom.

TABLE 16
Theoretically calculated binding energies (ΔE_{binding} and ΔG_{binding})
of hydrogen atoms on various Mo based
binding sites of Mo₉S₆Te₇/Gr composite.

| | Binding sites | ΔE_{binding} (eV) | ΔG_{binding} (eV) |
|---|---|---|---|
| 1 | Mo Corner | −0.286 | −0.046 |
| 2 | Mo Edge 1 | 0.169 | 0.409 |
| 3 | Mo Edge 2 | −1.153 | −0.913 |
| 4 | Mo Corner and Mo Edge | −0.065 | 0.175 |
| 5 | Mo Corner (tail side) | −0.164 | 0.076 |

In case of the two types of Mo₉S₄Te₅/Gr nanocomposite structures, which were constructed to closely resemble the atomic ratio (Mo:S:Te=1:0.46:0.58≈9:4:5) of the experimentally determined best system (FIGS. 41a and 41b), only Mo-based hydrogen binding sites are considered based on learnings from the previous structure of stoichiometric ratio. In both types of these metal-rich nanocomposites, a number of thermoneutral hydrogen binding energy values have been observed. In the Type-1 Mo₉S₄Te₅/Gr nanocomposite structure, two optimal binding sites are found, and both of these sites are comprised of the Mo corner (FIG. 8). In the Type-2 Mo₉S₄Te₅/Gr nanocomposite structure with all chalcogen atoms on the upper layer, the number of available binding sites with primarily Mo atoms is very limited. Yet, as displayed in FIG. 8, Table 17 and Table 18, one site comprised of a partial Mo corner does show a binding free energy value in close proximity to zero.

TABLE 17
Theoretically calculated binding energies (ΔE_{binding} and ΔG_{binding}) of
hydrogen atoms on various Mo based binding sites of Mo₉S₄Te₅/Gr
(Type-1) composite.

| | Binding sites | ΔE_{binding} (eV) | ΔG_{binding} (eV) |
|---|---|---|---|
| 1 | Mo Corner | −1.005 | −0.765 |
| 2 | Mo Corner and Mo Edge 1 | −0.191 | 0.048 |
| 3 | Mo Corner and Mo Edge 2 | −0.992 | −0.752 |
| 4 | Mo Tail Corner and Mo Edge | −0.203 | 0.036 |

TABLE 18
Theoretically calculated binding energies (ΔE_{binding} and ΔG_{binding}) of
hydrogen atoms on various Mo based binding sites of Mo₉S₄Te₅/Gr
(Type-2; chalcogen atoms on top) composite.

| | Binding sites | ΔE_{binding} (eV) | ΔG_{binding} (eV) |
|---|---|---|---|
| 1 | Mo Corner | −0.715 | −0.475 |
| 2 | Mo Corner and Mo Edge 1 | −0.283 | −0.043 |
| 3 | Mo Corner and Mo Edge 2 | −0.845 | −0.605 |

Conventionally, the binding free energies for high-performing catalytically active sites are within the range of −0.2 eV and 0.2 eV. Each of the composite systems which have been considered in this computational investigation possess binding sites within this range. Notably, the two Mo-rich systems (Mo₉S₆Te₇/Gr and Mo₉S₄Te₅/Gr) have multiple catalytically active binding sites according to the Sabatier's principle (FIG. 9) as compared to the composite system comprised of a nanoparticle of stoichiometric ratio of metal to chalcogen atoms. Moreover, using the experimentally measured current density (i₀) along with the theoretically determined ΔG_{binding} value of the best performing nanocomposite, the relative position of this nanocomposite in the volcano plot (FIG. 10) is found very close to the apex, approaching the high-performing noble metals Pt and Pd.

In summary, the hybrid molybdenum sulfotelluride (MoSₓTe_{y}) nanosheets were prepared intertwined with graphene network via a simple and rapid (60 sec) microwave-assisted heating approach. Applying this strategy, a remarkable reduction of processing time from hour-scale to minute-scale compared to the conventional approaches has been achieved. Various samples with different precursor ratios were explored and their electrocatalytic HER activities were examined in acidic medium. It is evidenced that the HER catalytic activity is noticeably modified with the ratio of Mo, S and Te elements. The best result was found from the MoS_{0.46}Te_{0.58}/Gr nanocomposite consisting slightly more Te than S atom and higher amount of Mo than the stoichiometry, which shows a small overpotential of only 62.2 mV to reach the cathodic current density of 10 mA cm⁻², a small Tafel slope of 61.1 mV dec⁻¹, high TOF of 0.53 s⁻¹ at an overpotential of 150 mV and negligible degradation of activity from long-term stability tests. This excellent electrocatalytic behavior is derived from the coexistence of S and Te atoms which reduces the apparent activation energy by creating more active sites in defect-rich catalyst surface, accelerating both ion and electron transfer and the presence of graphene improves the electrical conductivity. In addition, the computational results clearly provide microscopic insight by way of effective hydrogen binding free energy values into the experimental catalytic performance for HER. Here, it has been deduced that the most active sites for catalysis of the molybdenum sulfotelluride/graphene nanocomposite are primarily comprised of exposed Mo atoms. This combined computational and experimental study shows the very high potential for the metal-rich molybdenum sulfotelluride nano-electrocatalyst with graphene support for hydrogen generation through water electrolysis. Moreover, in basis of the proposed microwave-assisted synthesis method, other hybrid metal chalcogenides can also be prepared in large-scale with low cost, high efficiency, and stability, which will boost the practical applications of metal chalcogenide-based heterostructures as high-performance HER electrocatalysts.

### Examples Relating to a Comprehensive Study on HER Activities of Molybdenum Chalcogenide/Graphene and their Hybrid-Nanocomposites

Materials and Reagents

Ammonium tetrathiomolybdate, (NH₄)₂MoS₄ was purchased from BeanTown Chemical, Inc. Molybdenum hexacarbonyl, Mo(CO)₆ was purchased from Strem Chemicals. Carbon disulfide (CS₂), selenium (Se), tellurium (Te), and polyvinylidene fluoride (PVDF) were acquired from Alfa Aesar. N, N-Dimethylformamide (DMF) was purchased from Macron Fine Chemicals™. Graphene was supplied by Magnolia Ridge Inc., and 10 wt. % platinum on carbon (10 wt. % Pt/C) was obtained from Sigma-Aldrich. All chemicals purchased were used as received without further treatment or purification. For electrochemical characterizations, graphite rod (5 mm diameter) was provided by Alfa Aesar, glassy carbon electrode (3 mm diameter) was purchased from CH Instruments, Inc. and silver/silver chloride (Ag/AgCl, 3 M KCl, E°=+0.197 V vs. RHE) reference electrode was acquired from Hach.

Microwave-Initiated Synthesis of Catalyst Samples

To prepare the molybdenum dichalcogenides and their hybrid catalysts on graphene supports, first, the precursors were mixed homogeneously with graphene in a 20 mL scintillation vial using a speed mixer. The mass of the precursors for each of the nanocomposites are described in Table 19. Next, the vial containing uniform mixture was subjected to microwave irradiation at a constant power of 1250 W for 90 seconds for each of the mixtures. After the vial cooled down at room temperature, the product was collected from the vial and ground into fine powder.

TABLE 19
The mass of different precursors for the microwave-assisted synthesis of
molybdenum dichalcogenides and their hybrids on graphene support.

| | | | | Se | Te | | Microwave |
|---|---|---|---|---|---|---|---|
| Samples | (NH₄)₂MoS₄ | Mo(CO)₆ | CS₂ | powder | powder | Graphene | time |
| MoS₂/Gr | 20 mg | − | 50 μL | − | − | 20 mg | 90 sec |
| MoSe₂/Gr | − | 20 mg | − | 35 mg | − | | |
| MoTe₂/Gr | − | 20 mg | − | − | 55 mg | | |
| MoSSe/Gr | 20 mg | − | 50 μL | 17 mg | − | | |
| MoSeTe/Gr | − | 20 mg | − | 17 mg | 27 mg | | |
| MoSTe/Gr | 20 mg | − | 50 μL | − | 27 mg | | |
| Mo(SSeTe)_{0.67}/Gr | 20 mg | − | 50 μL | 11 mg | 18 mg | | |

Preparation of Working Electrodes

To prepare the catalyst coating, a mixture of 100 mg composite and 10 mg PVDF powder were suspended in 5 mL DMF solvent, following by 20 min of probe sonication. The GCE surface (0.07 cm²) was sequentially polished with 0.3- and 0.05-mm alumina slurries, and then rinsed with DI water and acetone. Finally, 20 μL of the suspension was added to the GCE surface and dried in a vacuum dryer at 60° C., which results a mass loading of ˜1 mg cm⁻² for each catalyst sample.

Material Characterization Techniques

X-ray photoelectron spectroscopy (XPS) was investigated on a Kratos Axis Ultra DLD spectrometer using a monochromatic Al Kα radiation (hv=1486.6 eV) under UHV condition (<8×10⁻¹⁰ Torr), to determine the chemical state and surface composition of various elements in the nanocomposites. Moreover, to investigate the phase and crystal structures of as-synthesized materials, the powder X-ray diffraction (XRD) patterns were collected on a Philips X'pert MPD diffractometer with Cu Kα radiation (λ=1.54056 Å) at 45 kV and 40 mA.

Electrochemical Measurement Techniques

Electrochemical experiments were performed with CH Instrument (CHI 760D) in a standard three-electrode system. This setup consists of an active material-coated glassy carbon electrode (GCE) as working electrode with a mass loading of ˜1 mg cm⁻², Ag/AgCl as reference electrode, and graphite rod as a counter electrode in 0.5 M H₂SO₄ electrolyte. The observed potentials were translated to reversible hydrogen electrode (RHE) based on the equation: V (vs. RHE)=V (vs. Ag/AgCl)+0.197+(0.059×pH) at room temperature (˜25° C.). The electrocatalytic activities and stability performances were determined by performing iR-corrected linear sweep voltammetry (LSV), Tafel analysis, and the constant potential tests.

Materials Characterizations

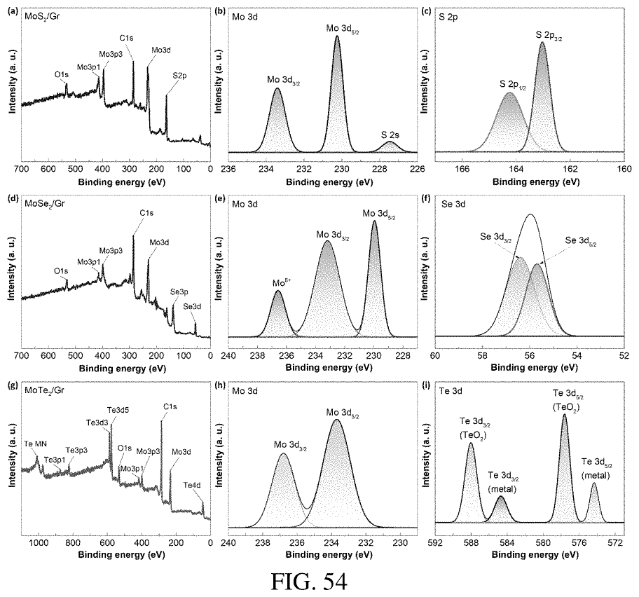

The elemental compositions and binding energies in as-produced samples were examined by XPS analysis. The survey spectra of MoS₂/Gr, MoSe₂/Gr, and MoTe₂/Gr (FIGS. 54a, 54d, and 54g) show the peaks due to Mo, C, and chalcogens (S or Se or Te), and the signal of O 1s due to air exposure. As shown in FIGS. 54b, 54e, and 54h, the XPS spectra of Mo 3d regions are dominated by two peaks corresponding to the Mo 3d_{5/2} (229.1 eV) and Mo 3d_{3/2} (˜232.3 eV), implying Mo⁴⁺ features. Additionally, a weak peak at ˜226.2 eV is ascribed to S 2s orbital of MoS₂ (FIG. 54b). Another peak appears at ˜235 eV in MoSe₂/Gr (FIG. 54e), which corresponds to oxidized Mo⁶⁺ (likely MoO₃). In FIG. 54c, the peaks of S 2p_{3/2} and S 2p_{1/2} appear at ˜162.7 and ˜164.1 eV, which confirms the presence of S²⁻ for MoS₂. The features at ˜55.4 and ˜56.2 eV (FIG. 54f) correspond to Se 3d_{5/2} and Se 3d_{3/2} levels, respectively. Furthermore, the XPS peaks at ˜574.3 and ˜584.6 eV (FIG. 54i) are attributed to Te 3d_{5/2} and Te 3d_{3/2}, respectively. Two additional peaks at ˜577.3 and ˜588.0 eV are ascribed to TeO2, owing to the partial oxidation due to the air exposure. These XPS results clearly reveal that the ratio of Mo and chalcogen atoms (S, Se, and Te) perfectly match with the stoichiometry having a value of 1:2 for Mo:S or Se or Te.

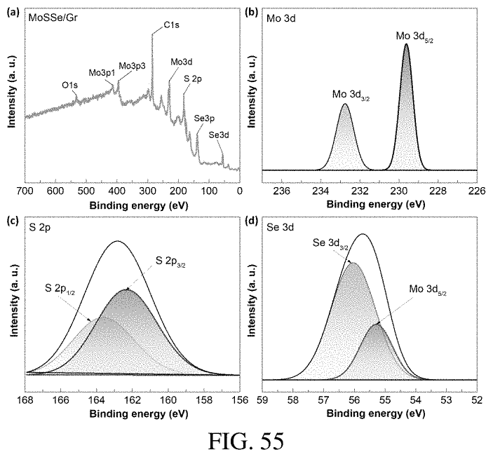

The survey spectrum of MoSSe/Gr sample is displayed in FIG. 55a, which shows the XPS peaks for Mo, S, Se, C, and O. The binding energies of Mo 3d_{5/2} and Mo 3d_{3/2} are ˜229.5 and ˜232.7 eV (FIG. 55b), which appears as a positive shift of about 0.4 eV relative to those of bare MoS₂ and MoSe₂. It suggests an efficient electron transfer in between MoS₂ and MoSe₂ under the unique heterojunction effect. From FIG. 55c, it may be seen that the peaks of S 2p_{3/2} and S 2p_{1/2} appeared at ˜162.3 and ˜163.6 eV, confirming the presence of S²⁻. FIG. 55d shows the Se 3d spectrum, where the Se 3d peak can be resolved into two well-defined peaks at ˜55.1 and ˜56.0 eV. These peaks are associated with the 3d_{5/2} and 3d_{3/2} orbitals of the Se element, indicating the −2 valence of Se. There are slight shifts in S 2p and Se 3d peaks, which also support the charge transfer between MoS₂ and MoSe₂.

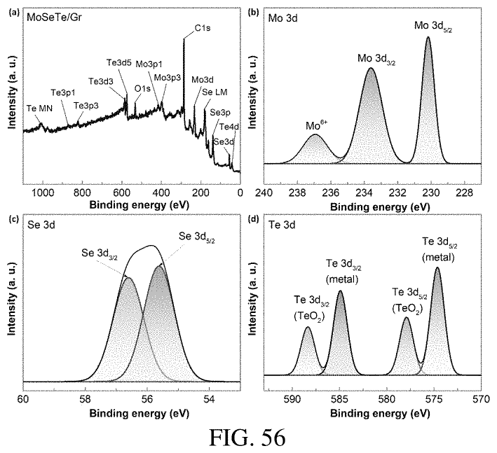

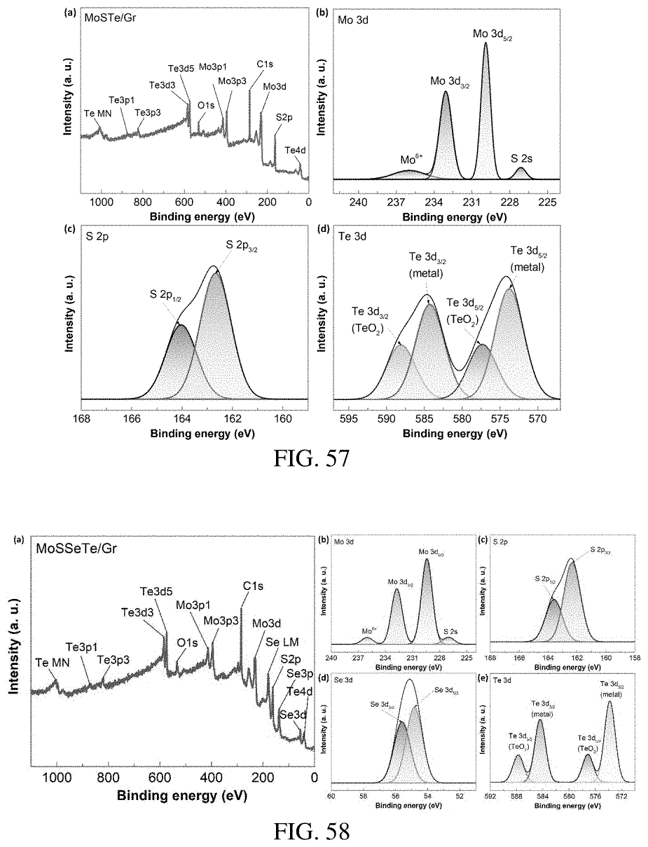

Similarly, the XPS survey and the high-resolution XPS (HRXPS) spectra were obtained for MoSeTe/Gr (FIG. 56) and MoSTe/Gr (FIG. 57) nanocomposites. The elemental compositions are summarized in Table 20, which clearly suggests the successful synthesis of molybdenum dichalcogenides and their nanohybrids with acceptable stoichiometry.

TABLE 20
The weight % and atomic % of all elements (Mo, S, Se, Te, O, and C) in as-produced catalyst samples from the obtained XPS results.

| | Mo | | S | | Se | | Te | | O | | C | |
|---|---|---|---|---|---|---|---|---|---|---|---|---|
| Samples | Wt. % | At. % | Wt. % | At. % | Wt. % | At. % | Wt. % | At. % | Wt. % | At. % | Wt. % | At. % |
| MoS₂/Gr | 49.42 | 16.76 | 30.78 | 31.24 | — | — | — | — | 2.75 | 5.6 | 17.05 | 46.24 |
| MoSe₂/Gr | 28.69 | 10.91 | — | — | 48.52 | 22.42 | — | — | 3.46 | 7.9 | 19.33 | 58.77 |
| MoTe₂/Gr | 23.41 | 10.75 | — | — | — | — | 56.73 | 19.59 | 3.57 | 9.82 | 16.30 | 59.84 |
| MoSSe/Gr | 28.8 | 8.04 | 10.13 | 8.46 | 27.44 | 9.31 | — | — | 1.57 | 2.62 | 32.06 | 71.57 |
| MoSeTe/Gr | 21.17 | 7.34 | — | — | 20.75 | 8.74 | 29.69 | 7.74 | 3.66 | 7.6 | 24.74 | 68.58 |
| MoSTe/Gr | 31.66 | 15.23 | 11.33 | 16.31 | — | — | 42.99 | 15.55 | 1.07 | 3.1 | 12.95 | 49.81 |
| Mo(SSeTe)_{0.67}/Gr | 30.65 | 12.59 | 7.30 | 8.97 | 16.45 | 8.21 | 26.16 | 8.08 | 2.07 | 5.09 | 17.37 | 57.06 |

In the case of hybrid Mo(SSeTe)_{0.67}/Gr, the survey spectrum (FIG. 58a) identifies the characteristic XPS peaks for Mo, S, Se, Te, 0, and C atoms. As shown in FIG. 58b, two peaks corresponding to Mo 3d_{5/2} and Mo 3d_{3/2} levels are located at 229.4 and 232.6 eV, which are assigned to 2H-MoS₂, 2H—MoSe₂, and 2H—MoTe₂, further verifying the formation of 2H-phase. Similar to the previous results, the HRXPS spectra of S 2p, Se 3d, and Te 3d regions show all the characteristic peaks for corresponding elements, thus confirming the successful synthesis of desired heterostructures of molybdenum dichalcogenides on graphene supports.

The phase information of hybrid samples was characterized by XRD analysis.

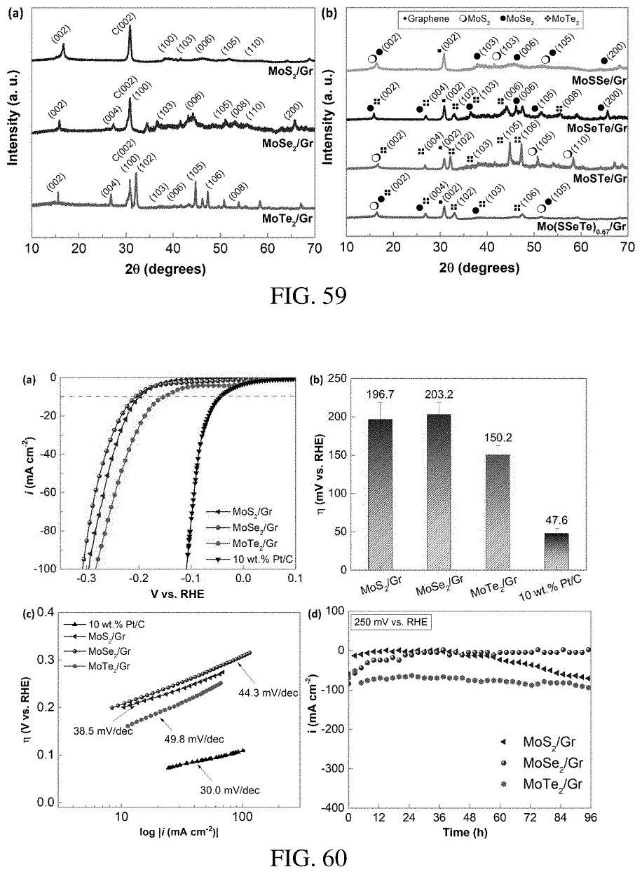

As shown in FIG. 59, the signals from graphene are observed at ˜26.0° in all catalyst samples for the plane of C(002). The other diffraction peaks in FIG. 59a correspond to hexagonal 2H—MoS₂ (JCPDS No. 37-1492), 2H—MoSe₂ (JCPDS No. 29-0914), and 2H—MoTe₂ (JCPDS No. 15-0658) structures. Similarly, the XRD patterns of other hybrid nanocomposites (FIG. 59b) reveal the successful synthesis of desired compounds through microwave-assisted heating.

Moreover, from the atomic % results (Table 20), it is found that the atomic ratio of MoX₂/Gr (X═S, Se, and Te) samples satisfy the stoichiometry of 1:2. Besides, the hybrid nanocomposites of MoXY/Gr (X, Y═S and/or Se and/or Te) follow the stoichiometry of 1:1:1 ratio. Similarly, for the sample of Mo(SSeTe)_{0.67}/Gr the atomic ratio of Mo:S:Se:Te resulted as 1:0.67:0.67:0.67, which also satisfies the stoichiometry (1:2) of the metal dichalcogenides.

Investigations of HER Activities

The electrocatalytic HER activities of as-synthesized catalyst samples were investigated by LSVs in 0.5 M H₂SO₄ electrolyte. The iR corrected-LSVs are displayed in FIG. 60a, where MoTe₂/Gr displays the best catalytic behavior among all the MoX₂/Gr (X═S, Se, and Te) samples with the smallest overpotential (η) of 150.2 mV (FIG. 60b) to reach the cathodic current density of 10 mA cm⁻². The order of HER activity based on 11 is found to be MoTe₂/Gr>MoS₂/Gr>MoSe₂/Gr. It clearly indicates that the higher electrical conductivity of MoTe₂ facilitates the faster electron transfer process. Furthermore, the Tafel diagrams were derived from LSVs by fitting the linear sections to the Tafel equation (11=b log i+a), where 11 is overpotential, b is Tafel slope, i represents the cathodic current density, and a is a constant. In general, the HER takes place through two consecutive steps: an adsorption step (Volmer, H⁺+e⁻→H_{ads}, 120 mV dec⁻¹), following by a reduction step (Heyrovsky, H⁺+H_{ads}+e⁻→H₂, 40 mV dec⁻¹ or Tafel, 2H_{ads}→H₂, 30 mV dec⁻¹). Tafel slope identifies the required overpotential to increase the reaction rate by factor of ten, therefore it is noticeable that the smaller Tafel slope favors HER activities. From FIG. 60c, although MoTe₂/Gr shows the smallest overpotential, it shows higher Tafel slope of 49.8 mV dec⁻¹ in comparison with other samples (38.5 mV dec⁻¹ for MoS₂/Gr and 44.3 mV dec⁻¹ for MoSe₂/Gr), which can be resulted due to the presence of TeO2 in this catalyst sample.

Additionally, a chronoamperometric curve was obtained at the η of 250 mV, which is shown in FIG. 60d. These constant potential tests reveal almost no degradation in the cathodic current density for 96 h of electrolysis. Moreover, MoTe₂/Gr shows the best stability results maintaining the highest current density of around −90 mA cm⁻². These remarkable stability results may be attributed to the compositional and structural stabilities of MoS₂/Gr, MoSe₂/Gr, and MoTe₂/Gr nanosheet structures supported by strong graphene network.

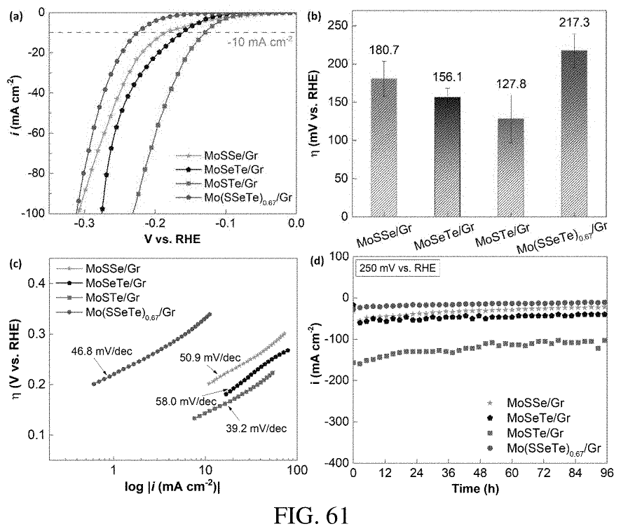

The HER activities of hybrid nanocomposites of MoXY/Gr (X, Y═S and/or Se and/or Te) and Mo(SSeTe)_{0.67}/Gr were further compared, as shown in FIG. 61a. Based on the overpotential values (FIG. 61b), the order of HER performance is revealed as MoSTe/Gr MoSeTe/Gr>MoSSe/Gr>Mo(SSeTe)_{0.67}/Gr, which clearly indicates the presence of Te improves the electron transfer rate due to its higher electrical conductivity. For Mo(SSeTe)_{0.67}/Gr, although it contains all of the chalcogen atoms (S, Se, and Te), the HER performance is poor. Further studies are required to understand the reason behind this poor electrocatalytic performance Based on the LSV curves, the Tafel analysis was performed. As shown in FIG. 61c, MoSTe/Gr exhibited the lowest Tafel slope of 39.2 mV dec⁻¹, which is also very close to the value of commercial Pt/C catalyst (30.0 mV dec⁻¹). Moreover, all these hybrid catalysts revealed very good stability performance for 96 h of constant potential test at an overpotential of 250 mV, as displayed in FIG. 61d. All the hybrid catalysts showed stable behaviors with slight decrease in HER performance by dropping the cathodic current density to lower value, where the MoSTe/Gr catalyst displayed the best performance with a slight decrease in current density from −160 to −100 mA cm⁻².

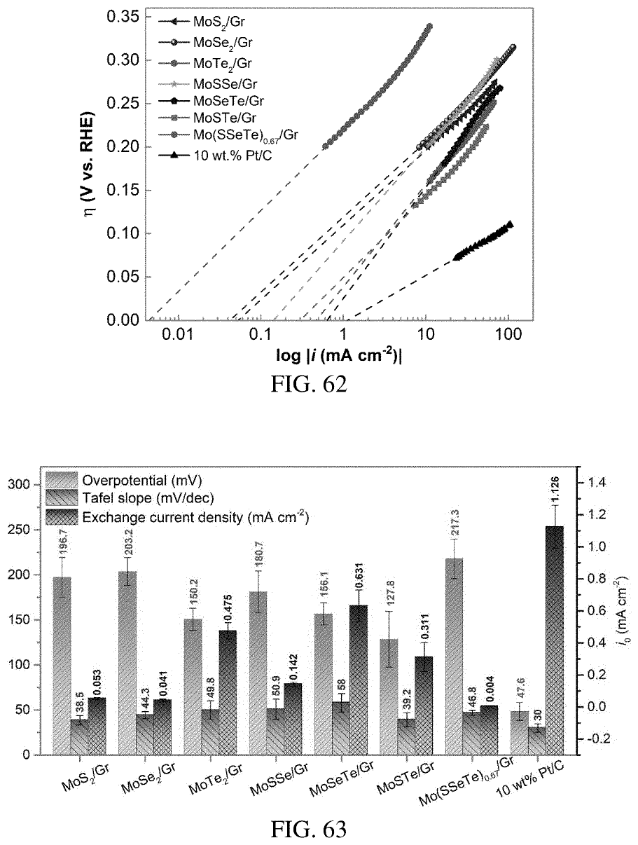

In addition, the exchange current densities (i₀) were measured following the Tafel slope extrapolation method, as displayed in FIG. 62. In comparison with 10 wt. % Pt/C catalyst, three of the molybdenum dichalcogenide/graphene nanocomposites with the highest values are MoSTe/Gr, MoSeTe/Gr, and MoTe₂/Gr. These results clearly indicate the better HER performance of as-synthesized catalyst samples that contain Te atoms.

Furthermore, all the major parameters (overpotential, Tafel slope, and exchange current density) for electrocatalytic performance of as-synthesized nanocomposites are summarized in FIG. 63. Although, the chemical formula appears to be similar for all the molybdenum dichalcogenides but structurally they are slightly different from each other. These structural differences give rise to variations in their electrical transport properties. An important feature of tellurides that distinguishes it from the sulfides and selenides is the large atomic number of Te, which results exceptionality in its crystal structure, electronic configuration, and physicochemical properties. Therefore, the catalyst samples containing Te, only except Mo(SSeTe)_{0.67}/Gr, showed very promising HER activities to generate hydrogen from water splitting.

In this study, the compounds of three classes namely sulfides, selenides and tellurides of transition metal (Mo) were successfully synthesized on graphene supports with compositions of MoS₂/Gr, MoSe₂/Gr, MoTe₂/Gr, MoSSe/Gr, MoSeTe/Gr, MoTe/Gr, and Mo(SSeTe)_{0.67}/Gr through a simple, ultrafast (90 s), and energy-efficient microwave-assisted solid-state technique. The as-produced nanocomposites have high activity and durability for HER electrocatalysis with small overpotentials in the range of 127-217 mV and negligible activity loss for long-term hydrogen generation at constant potential of 250 mV. Among them, MoTe₂/Gr, MoSTe/Gr, and MoSeTe/Gr demonstrate the improved performance in comparison to other nanocomposites. While neither desiring to be bound by any particular theory nor intending to limit in any measure the scope of the appended claims or their equivalents, it is presently believed that these results come from their higher intrinsic activities due to the existence of Te atoms. The influence of different chemical compositions of molybdenum dichalcogenides and their hybrids on HER activities may be explored.

The entire contents of each and every patent and non-patent publication cited herein are hereby incorporated by reference, except that in the event of any inconsistent disclosure or definition from the present specification, the disclosure or definition herein shall be deemed to prevail.

It is to be understood that use of the indefinite articles “a” and “an” in reference to an element (e.g., “a nanosheet,” “a metal chalcogenide,” “a carbonaceous substrate,” “a chalcogen,” etc.) does not exclude the presence, in some embodiments, of a plurality of such elements.

The foregoing detailed description and the accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding claim—whether independent or dependent—and that such new combinations are to be understood as forming a part of the present specification.

Additional features and advantages of the present teachings can be described by the embodiments set forth in any of the following enumerated clauses. It is to be understood that any of the embodiments described herein can be used in connection with any other embodiments described herein to the extent that the embodiments do not contradict one another.

Clause 1: A nanocomposite material for use in catalyzing a hydrogen evolution reaction (HER), the nanocomposite material comprising: a nanosheet comprising a metal chalcogenide having a formula MXₐY_{b}Z_{c} and a carbonaceous substrate supporting the nanosheet; wherein M is a transition metal having (a) an oxidation state ranging from +2 to +4, (b) a body-centered cubic (BCC) crystal structure, a face-centered cubic (FCC) crystal structure, or a hexagonal close packed (HCP) crystal structure, or (c) both an oxidation state ranging from +2 to +4 and a BCC, FCC, or HCP crystal structure; wherein X is a first chalcogen element; wherein Y is an optional second chalcogen element; wherein Z is an optional third chalcogen element; wherein a is an integer or a non-integer greater than 0 and less than or equal to 2; wherein b is an integer or a non-integer ranging from 0 to 2; and wherein c is an integer or a non-integer ranging from 0 to 2.

Clause 2: The nanocomposite material of clause 1 wherein the metal chalcogenide forms a nanosheet on the carbonaceous substrate.

Clause 3: The nanocomposite material of any one of clauses 1 and 2 wherein the carbonaceous substrate comprises a conducting polymer, carbon black, graphene, reduced graphene oxide (r-GO), carbon nanotubes (CNTs), or a combination thereof.

Clause 4: The nanocomposite material of any one of clauses 1-3 wherein the carbonaceous substrate comprises graphene.

Clause 5: The nanocomposite material of any one of clauses 1-3 wherein the carbonaceous substrate comprises reduced graphene oxide (r-GO).

Clause 6: The nanocomposite material of any one of clauses 1-5 wherein the transition metal is selected from the group consisting of tungsten, molybdenum, nickel, cobalt, copper, and iron.

Clause 7: The nanocomposite material of any one of clauses 1-6 wherein the transition metal is tungsten.

Clause 8: The nanocomposite material of any one of clauses 1-6 wherein the transition metal is molybdenum.

Clause 9: The nanocomposite material of any one of clauses 1-8 wherein each of the first chalcogen element, the optional second chalcogen element, and the optional third chalcogen element is independently selected from the group consisting of sulfur, selenium, and tellurium.

Clause 10: The nanocomposite material of any one of clauses 1-9 wherein the metal chalcogenide is a stoichiometric compound.

Clause 11: The nanocomposite material of any one of clauses 1-10 wherein the metal chalcogenide is a stoichiometric compound, wherein b is zero, wherein c is zero, and

wherein a is 2.

Clause 12: The nanocomposite material of any one of clauses 1-10 wherein the metal chalcogenide is a stoichiometric compound, wherein b is zero, wherein c is zero, wherein a is 2, and wherein X is sulfur, selenium, or tellurium.

Clause 13: The nanocomposite material of any one of clauses 1-10 wherein the metal chalcogenide is a stoichiometric compound, wherein b is zero, wherein c is zero, wherein a is 2, and wherein X is selenium or tellurium.

Clause 14: The nanocomposite material of any one of clauses 1-10 wherein the metal chalcogenide is a stoichiometric compound, wherein b is zero, wherein c is zero, wherein a is 2, wherein M is molybdenum, and wherein X is sulfur, selenium, or tellurium.

Clause 15: The nanocomposite material of any one of clauses 1-10 wherein the metal chalcogenide is a stoichiometric compound, wherein b is zero, wherein c is zero, wherein a is 2, wherein M is molybdenum, and wherein X is selenium or tellurium.

Clause 16: The nanocomposite material of any one of clauses 1-10 wherein the metal chalcogenide is a stoichiometric compound, wherein b is zero, wherein c is zero, wherein a is 2, wherein M is molybdenum, wherein X is sulfur, selenium, or tellurium, and wherein the carbonaceous material is graphene or reduced graphene oxide (r-GO).

Clause 17: The nanocomposite material of any one of clauses 1-10 wherein the metal chalcogenide is a stoichiometric compound, wherein b is zero, wherein c is zero, wherein a is 2, wherein M is molybdenum, wherein X is selenium or tellurium, and wherein the carbonaceous material is graphene or reduced graphene oxide (r-GO).

Clause 18: The nanocomposite material of any one of clauses 1-9 wherein the metal chalcogenide is a non-stoichiometric compound.

Clause 19: The nanocomposite material of any one of clauses 1-9 wherein the metal chalcogenide is a non-stoichiometric compound, wherein c is zero, wherein X is sulfur, and wherein Y is selenium.

Clause 20: The nanocomposite material of any one of clauses 1-9 wherein the metal chalcogenide is a non-stoichiometric compound, wherein M is molybdenum, wherein c is zero, wherein X is sulfur, and wherein Y is selenium.

Clause 21: The nanocomposite material of any one of clauses 1-9 wherein the metal chalcogenide is a non-stoichiometric compound, wherein M is molybdenum, wherein c is zero, wherein X is sulfur, wherein Y is selenium, and wherein the carbonaceous material is graphene or reduced graphene oxide (r-GO).

Clause 22: The nanocomposite material of any one of clauses 1-9 wherein the metal chalcogenide is a non-stoichiometric compound, wherein c is zero, wherein X is selenium, and wherein Y is tellurium.

Clause 23: The nanocomposite material of any one of clauses 1-9 wherein the metal chalcogenide is a non-stoichiometric compound, wherein M is molybdenum, wherein c is zero, wherein X is selenium, and wherein Y is tellurium.

Clause 24: The nanocomposite material of any one of clauses 1-9 wherein the metal chalcogenide is a non-stoichiometric compound, wherein M is molybdenum, wherein c is zero, wherein X is selenium, wherein Y is tellurium, and wherein the carbonaceous material is graphene or reduced graphene oxide (r-GO).

Clause 25: The nanocomposite material of any one of clauses 1-9 wherein the metal chalcogenide is a non-stoichiometric compound, wherein M is molybdenum, wherein c is zero, wherein X is selenium, wherein a is 0.46, wherein Y is tellurium, and wherein b is 0.58.

Clause 26: The nanocomposite material of any one of clauses 1-9 wherein the metal chalcogenide is a non-stoichiometric compound, wherein M is molybdenum, wherein X is sulfur, wherein Y is selenium, and wherein Z is tellurium.

Clause 27: The nanocomposite material of any one of clauses 1-9 wherein the metal chalcogenide is a non-stoichiometric compound, wherein M is molybdenum, wherein X is sulfur, wherein Y is selenium, wherein Z is tellurium, and wherein the carbonaceous material is graphene or reduced graphene oxide (r-GO).

Clause 28: The nanocomposite material of any one of clauses 1-9 wherein the metal chalcogenide is a non-stoichiometric compound having a formula Mo(SSeTe)_{0.67}.

Clause 29: The nanocomposite material of any one of clauses 1-28 wherein the nanocomposite material comprises a multi-layer structure comprising a plurality of nanosheets and a plurality of carbonaceous substrates.

Clause 30: A nanocomposite material for use in catalyzing a hydrogen evolution reaction (HER), the nanocomposite material comprising: a nanosheet comprising a metal chalcogenide having a formula MXₐY_{b}Z_{c}; and a carbonaceous substrate supporting the nanosheet; wherein M is a transition metal selected from the group consisting of tungsten, molybdenum, nickel, cobalt, copper, and iron; wherein a is an integer or a non-integer greater than 0 and less than or equal to 2; wherein b is an integer or a non-integer ranging from 0 to 2; wherein c is an integer or a non-integer ranging from 0 to 2; wherein the carbonaceous material is selected from the group consisting of graphene and reduced graphene oxide (r-GO); wherein X and each of Y, and Z, if present, are individually selected from the group consisting of sulfur, selenium, and tellurium.

Clause 31: The nanocomposite material of any one of clauses 1-30 wherein the metal chalcogenide is a stoichiometric compound.

Clause 32: The nanocomposite material of any one of clauses 1-30 wherein the metal chalcogenide is a non-stoichiometric compound.

Clause 33: The nanocomposite material of any one of clauses 1-30 wherein the nanocomposite material comprises a multi-layer structure comprising a plurality of nanosheets and a plurality of carbonaceous substrates.

Clause 34: A method for producing a nanocomposite material for catalyzing a hydrogen evolution reaction (HER), the method comprising: combining a transition metal, a chalcogen, and a carbonaceous substrate to form a reagent mixture; and irradiating the reagent mixture with microwave radiation.

Clause 35: The method of clause 34 further comprising mixing the transition metal, the chalcogen, and the carbonaceous substrate prior to the irradiating.

Clause 36: The method of any of clauses 34 and 35 wherein the mixing comprises high-speed mixing of greater than or equal to about 1000 revolutions per minute (rpm).

Clause 37: The method of any one of clauses 34-36 wherein the mixing comprises high-speed mixing of greater than or equal to about 1500 rpm.

Clause 38: The method of any one of clauses 34-37 wherein the mixing comprises high-speed mixing of greater than or equal to about 2000 rpm.

Clause 39: The method of any one of clauses 34-38 wherein the mixing is performed at ambient temperature and pressure.

Clause 40: The method of any one of clauses 34-39 wherein the irradiating is achieved with a microwave source having a frequency ranging from about 300 MHz to about 35 GHz and a power ranging from about 500 W to about 3,000 W.

Clause 41: The method of any one of clauses 34-40 wherein a duration of the irradiating is between about 30 seconds and about 120 seconds.

Clause 42: The method of any one of clauses 34-41 wherein a duration of the irradiating is between about 45 seconds and about 100 seconds.

Clause 43: The method of any one of clauses 34-42 wherein a duration of the irradiating is between about 55 seconds and about 95 seconds.

Clause 44: The method of any one of clauses 34-43 wherein the transition metal is provided in the form of a transition metal carbonyl compound.

Clause 45: The method of any one of clauses 34-44 wherein the transition metal is molybdenum.

Clause 46: The method of any one of clauses 34-45 wherein the transition metal is molybdenum, and wherein the molybdenum is introduced into the reagent mixture as molybdenum hexacarbonyl.

Clause 47: The method of any one of clauses 34-46 wherein the transition metal is molybdenum, and wherein the molybdenum is introduced into the reagent mixture as ammonium tetrathiomolybdate (ATTM) and/or MoS₂.

Clause 48: The method of any one of clauses 34-47 wherein the chalcogen is introduced into the reagent mixture as an elemental powder.

Clause 49: The method of any one of clauses 34-48 wherein the chalcogen comprises two or more different chalcogen elements.

Clause 50: The method of any one of clauses 34-49 wherein the chalcogen is tellurium, and wherein the tellurium is introduced into the reagent mixture as tellurium powder.

Clause 51: The method of any one of clauses 34-49 wherein the chalcogen is selenium, and wherein the selenium is introduced into the reagent mixture as selenium powder.

Clause 52: The method of any one of clauses 34-49 wherein the chalcogen is sulfur, and wherein the sulfur is introduced into the reagent mixture as carbon disulfide.

Clause 53: The method of any one of clauses 34-49 wherein the chalcogen comprises sulfur and selenium.

Clause 54: The method of any one of clauses 34-49 wherein the chalcogen comprises sulfur and tellurium.

Clause 55: The method of any one of clauses 34-49 wherein the chalcogen comprises selenium and tellurium.

Clause 56: The method of any one of clauses 34-49 wherein the chalcogen comprises sulfur, selenium, and tellurium.

Clause 57: The method of any one of clauses 34-56 wherein the carbonaceous substrate comprises graphene.

Clause 58: A method for producing a nanocomposite material for catalyzing a hydrogen evolution reaction (HER), the method comprising: combining (i) a transition metal, (ii) a chalcogen selected from the group consisting of sulfur, selenium, tellurium, and a combination thereof, and (iii) graphene to form a reagent mixture; mixing the reagent mixture to form a substantially homogeneous reagent mixture; and irradiating the substantially homogeneous reagent mixture with microwave radiation.

Clause 59: A method for catalyzing a hydrogen evolution reaction (HER), the method comprising: using the nanocomposite material of any one of clauses 1-33 to catalyze a portion of a water electrolysis reaction that produces hydrogen gas with an overpotential ranging from about 8 mV to about 300 mV.

Clause 60: The method of clause 59 wherein the overpotential ranges from about 20 mV to about 300 mV.

Clause 61: The method of any one of clauses 59 and 60 wherein the overpotential ranges from about 50 mV to about 300 mV.

Clause 62: The method of any one of clauses 59-61 wherein the overpotential ranges from about 50 mV to about 250 mV.

Clause 63: The method of any one of clauses 59-62 wherein the overpotential ranges from about 100 mV to about 250 mV.

Clause 64: The method of any one of clauses 59-63 wherein the overpotential ranges from about 100 mV to about 225 mV.

Clause 65: The method of any one of clauses 59-64 wherein the portion of the water electrolysis reaction that produces the hydrogen gas takes place at a cathode.

Clause 66: The method of any one of clauses 59-65 further comprising applying the nanocomposite material to a surface of a glassy carbon electrode (GCE) to form a working electrode.

Clause 67: The method of any one of clauses 59-66 further comprising polishing the surface, rinsing the surface with deionized water, and vacuum drying the surface prior to the applying of the nanocomposite material.

Clause 68: The method of any one of clauses 59-67 further comprising mixing the nanocomposite material with poly-vinylidene fluoride (PVDF) powder and N,N-dimethylformamide (DMF) to form a homogeneous slurry, and drop-coating the homogeneous slurry onto a clean surface of the GCE.

1. A nanocomposite material for use in catalyzing a hydrogen evolution reaction (HER), the nanocomposite material comprising:
a nanosheet comprising a metal chalcogenide having a formula MXₐY_{b}Z_{c} and
a carbonaceous substrate supporting the nanosheet;
wherein M is a transition metal having (a) an oxidation state ranging from +2 to +4, (b) a body-centered cubic (BCC) crystal structure, a face-centered cubic (FCC) crystal structure, or a hexagonal close packed (HCP) crystal structure, or (c) both an oxidation state ranging from +2 to +4 and a BCC, FCC, or HCP crystal structure;
wherein X is a first chalcogen element;
wherein Y is an optional second chalcogen element;
wherein Z is an optional third chalcogen element;
wherein a is an integer or a non-integer greater than 0 and less than or equal to 2;
wherein b is an integer or a non-integer ranging from 0 to 2; and
wherein c is an integer or a non-integer ranging from 0 to 2.

2. The nanocomposite material of claim 1 wherein the metal chalcogenide forms a nanosheet on the carbonaceous substrate.

3. The nanocomposite material of claim 1 wherein the carbonaceous substrate comprises a conducting polymer, carbon black, graphene, reduced graphene oxide (r-GO), carbon nanotubes (CNTs), or a combination thereof.

4. The nanocomposite material of claim 1 wherein the carbonaceous substrate comprises graphene.

5. The nanocomposite material of claim 1 wherein the carbonaceous substrate comprises reduced graphene oxide (r-GO).

6. The nanocomposite material of claim 1 wherein the transition metal is selected from the group consisting of tungsten, molybdenum, nickel, cobalt, copper, and iron.

7. The nanocomposite material of claim 1 wherein the transition metal is molybdenum.

8. The nanocomposite material of claim 1 wherein each of the first chalcogen element, the optional second chalcogen element, and the optional third chalcogen element is independently selected from the group consisting of sulfur, selenium, and tellurium.

9. The nanocomposite material of claim 1 wherein the metal chalcogenide is a stoichiometric compound, wherein b is zero, wherein c is zero, wherein a is 2, wherein X is selenium or tellurium, and wherein the carbonaceous material is graphene or reduced graphene oxide (r-GO).

10. The nanocomposite material of claim 1 wherein the metal chalcogenide is a non-stoichiometric compound, wherein c is zero, wherein X is sulfur, and wherein Y is selenium.

11. The nanocomposite material of claim 1 wherein the metal chalcogenide is a non-stoichiometric compound, wherein M is molybdenum, wherein c is zero, wherein X is sulfur, wherein Y is selenium, and wherein the carbonaceous material is graphene or reduced graphene oxide (r-GO).

12. The nanocomposite material of claim 1 wherein the metal chalcogenide is a non-stoichiometric compound, wherein c is zero, wherein X is selenium, and wherein Y is tellurium.

13. The nanocomposite material of claim 1 wherein the metal chalcogenide is a non-stoichiometric compound, wherein M is molybdenum, wherein c is zero, wherein X is selenium, wherein Y is tellurium, and wherein the carbonaceous material is graphene or reduced graphene oxide (r-GO).

14. The nanocomposite material of claim 1 wherein the metal chalcogenide is a non-stoichiometric compound, wherein M is molybdenum, wherein c is zero, wherein X is selenium, wherein a is 0.46, wherein Y is tellurium, and wherein b is 0.58.

15. The nanocomposite material of claim 1 wherein the metal chalcogenide is a non-stoichiometric compound, wherein M is molybdenum, wherein X is sulfur, wherein Y is selenium, wherein Z is tellurium, and wherein the carbonaceous material is graphene or reduced graphene oxide (r-GO).

16. The nanocomposite material of claim 1 wherein the metal chalcogenide is a non-stoichiometric compound having a formula Mo(SSeTe)_{0.67}.

17. The nanocomposite material of claim 1 wherein the nanocomposite material comprises a multi-layer structure comprising a plurality of nanosheets and a plurality of carbonaceous substrates.

18. A nanocomposite material for use in catalyzing a hydrogen evolution reaction (HER), the nanocomposite material comprising:
a nanosheet comprising a metal chalcogenide having a formula MXₐY_{b}Z_{c}; and
a carbonaceous substrate supporting the nanosheet;
wherein M is a transition metal selected from the group consisting of tungsten, molybdenum, nickel, cobalt, copper, and iron;
wherein a is an integer or a non-integer greater than 0 and less than or equal to 2;
wherein b is an integer or a non-integer ranging from 0 to 2;
wherein c is an integer or a non-integer ranging from 0 to 2;
wherein the carbonaceous material is selected from the group consisting of graphene and reduced graphene oxide (r-GO);
wherein X and each of Y, and Z, if present, are individually selected from the group consisting of sulfur, selenium, and tellurium.

19. The nanocomposite material of claim 30 wherein the nanocomposite material comprises a multi-layer structure comprising a plurality of nanosheets and a plurality of carbonaceous substrates.

20. A method for catalyzing a hydrogen evolution reaction (HER), the method comprising:
using the nanocomposite material of claim 1 to catalyze a portion of a water electrolysis reaction that produces hydrogen gas with an overpotential ranging from about 8 mV to about 300 mV.
